(19) United States
(12) Patent Application Publication
(10) Pub. No.: US 2018/0239948 A1
(43) Pub. Date: Aug. 23, 2018

(54) SATELLITE WITH MACHINE VISION FOR DISASTER RELIEF SUPPORT

(71) Applicant: Elwha LLC, Bellevue, WA (US)

(72) Inventors: Phillip Rutschman, Seattle, WA (US); Ehren Brav, Bainbridge Island, WA (US); Russell Hannigan, Sammamish, WA (US); Roderick A. Hyde, Redmond, WA (US); Muriel Y. Ishikawa, Livermore, CA (US); 3ric Johanson, Seattle, WA (US); Jordin T. Kare, San Jose, CA (US); Tony S. Pan, Bellevue, WA (US); Clarence T. Tegreene, Mercer Island, WA (US); Charles Whitmer, North Bend, WA (US); Lowell L. Wood, Bellevue, WA (US); Victoria Y. H. Wood, Livermore, CA (US); Travis P. Dorschel, Issaquah, WA (US)

(73) Assignee: Elwha LLC, Bellevue, WA (US)

(21) Appl. No.: 15/902,983

(22) Filed: Feb. 22, 2018

Related U.S. Application Data
(63) Continuation-in-part of application No. 15/902,400, filed on Feb. 22, 2018.
Application No. 15/902,400 is a continuation-in-part of application No. 15/844,300, filed on Dec. 15, 2017.
Application No. 15/844,300 is a continuation-in-part of application No. 15/844,293, filed on Dec. 15, 2017.
Application No. 15/844,293 is a continuation-in-part of application No. 15/787,075, filed on Oct. 18, 2017.
Application No. 15/787,075 is a continuation-in-part of application No. 15/698,147, filed on Sep. 7, 2017.
Application No. 15/698,147 is a continuation-in-part of application No. 15/697,893, filed on Sep. 7, 2017.
Application No. 15/697,893 is a continuation-in-part of application No. 14/838,114, filed on Aug. 27, 2015.
Application No. 14/838,114 is a continuation-in-part of application No. 14/838,128, filed on Aug. 27, 2015.
Application No. 14/838,128 is a continuation-in-part of application No. 14/791,160, filed on Jul. 2, 2015, now Pat. No. 9,866,765.
Application No. 14/791,160 is a continuation-in-part of application No. 14/791,127, filed on Jul. 2, 2015, now Pat. No. 9,924,109.
Application No. 14/791,127 is a continuation-in-part of application No. 14/714,239, filed on May 15, 2015.
Application No. 14/714,239 is a continuation-in-part of application No. 14/951,348, filed on Nov. 24, 2015, now Pat. No. 9,866,881.
Application No. 14/951,348 is a continuation-in-part of application No. 14/945,342, filed on Nov. 18, 2015, now Pat. No. 9,942,583.
Application No. 14/945,342 is a continuation-in-part of application No. 14/941,181, filed on Nov. 13, 2015, now abandoned.
(60) Provisional application No. 62/180,040, filed on Jun. 15, 2015.
(60) Provisional application No. 62/156,162, filed on May 1, 2015.
(60) Provisional application No. 62/082,002, filed on Nov. 19, 2014.
(60) Provisional application No. 62/082,001, filed on Nov. 19, 2014.
(60) Provisional application No. 62/081,560, filed on Nov. 18, 2014.
(60) Provisional application No. 62/081,559, filed on Nov. 18, 2014.
(60) Provisional application No. 62/522,493, filed on Jun. 20, 2017.
(60) Provisional application No. 62/532,247, filed on Jul. 13, 2017.
(60) Provisional application No. 62/384,685, filed on Sep. 7, 2016.
(60) Provisional application No. 62/429,302, filed on Dec. 2, 2016.
(60) Provisional application No. 62/537,425, filed on Jul. 26, 2017.
(60) Provisional application No. 62/571,948, filed on Oct. 13, 2017.

(51) Int. Cl. G06K 9/00; G06K 9/66; G06T 7/20; G06K 9/46

(52) U.S. Cl. CPC G06K 9/0063; G06K 9/66; G01W 1/00; G06K 9/46; G06T 7/20

(57) ABSTRACT

In one embodiment, a satellite configured to provide machine vision for disaster-relief support includes, but is not limited to, at least one imager; one or more computer readable media bearing one or more program instructions; and at least one computer processor configured by the one or more program instructions to perform operations including at least: obtaining imagery using the at least one imager of the satellite; detecting at least one event by analyzing at least one aspect of the imagery; and executing at least one operation based on the at least one event.

### PRIORITY CLAIM

This application claims priority to and/or the benefit of the following patent applications under 35 U.S.C. 119 or 120, and any and all parent, grandparent, or continuations or continuations-in-part thereof: U.S. Non-Provisional application Ser. No. 14/838,114 filed Aug. 27, 2015 (Docket No. 1114-003-003-000000); U.S. Non-Provisional application Ser. No. 14/838,128 filed Aug. 27, 2015 (Docket No. 1114-003-007-000000); U.S. Non-Provisional application Ser. No. 14/791,160 filed Jul. 2, 2015 (Docket No. 1114-003-006-000000); U.S. Non-Provisional application Ser. No. 14/791,127 filed Jul. 2, 2015 (Docket No. 1114-003-002-000000); U.S. Non-Provisional application Ser. No. 14/714,239 filed May 15, 2015 (Docket No. 1114-003-001-000000); U.S. Non-Provisional application Ser. No. 14/951,348 filed Nov. 24, 2015 (Docket No. 1114-003-008-000000); U.S. Non-Provisional application Ser. No. 14/945,342 filed Nov. 18, 2015 (Docket No. 1114-003-004-000000); U.S. Non-Provisional application Ser. No. 14/941,181 filed Nov. 13, 2015 (Docket No. 1114-003-009-000000); U.S. Non-Provisional application Ser. No. 15/698,147 filed Sep. 7, 2017 (Docket No. 1114-003-010A-000000); U.S. Non-Provisional application Ser. No. 15/697,893 filed Sep. 7, 2017 (Docket No. 1114-003-010B-000000); U.S. Non-Provisional application Ser. No. 15/787,075 filed Oct. 18, 2017 (Docket No. 1114-003-010B-000001); U.S. Non-Provisional application Ser. No. 15/844,293 filed Dec. 15, 2017 (Docket No. 1114-003-014A-000000); U.S. Non-Provisional application Ser. No. 15/844,300 filed Dec. 15, 2017 (Docket No. 1114-003-014B-000000); U.S. Non-Provisional application Ser. No. 15/902,400 filed Feb. 22, 2018 (Docket No. 1114-003-014C-000000); U.S. Provisional Application 62/180,040 filed Jun. 15, 2015 (Docket No. 1114-003-001-PR0006); U.S. Provisional Application 62/156,162 filed May 1, 2015 (Docket No. 1114-003-005-PR0001); U.S. Provisional Application 62/082,002 filed Nov. 19, 2014 (Docket No. 1114-003-004-PR0001); U.S. Provisional Application 62/082,001 filed Nov. 19, 2014 (Docket No. 1114-003-003-PR0001); U.S. Provisional Application 62/081,560 filed Nov. 18, 2014 (Docket No. 1114-003-002-PR0001); U.S. Provisional Application 62/081,559 filed Nov. 18, 2014 (Docket No. 1114-003-001-PR0001); U.S. Provisional Application 62/522,493 filed Jun. 20, 2017 (Docket No. 1114-003-011-PR0001); U.S. Provisional Application 62/532,247 filed Jul. 13, 2017 (Docket No. 1114-003-012-PR0001); U.S. Provisional Application 62/384,685 filed Sep. 7, 2016 (Docket No. 1114-003-010-PR0001); U.S. Provisional Application 62/429,302 filed Dec. 2, 2016 (Docket No. 1114-003-010-PR0002); U.S. Provisional Application 62/537,425 filed Jul. 26, 2017 (Docket No. 1114-003-013-PR0001); U.S. Provisional Application 62/571,948 filed Oct. 13, 2017 (Docket No. 1114-003-014-PR0001).

The foregoing applications are incorporated by reference in their entirety as if fully set forth herein.

### FIELD OF THE INVENTION

Embodiments disclosed herein relate generally to a satellite with machine vision.

### SUMMARY

In one embodiment, a satellite configured to provide machine vision for disaster-relief support, includes, but is not limited to, at least one imager; one or more computer readable media bearing one or more program instructions; and at least one computer processor configured by the one or more program instructions to perform operations including at least: obtaining imagery using the at least one imager of the satellite; detecting at least one event by analyzing at least one aspect of the imagery; and; executing at least one operation based on the at least one event.

In another embodiment, a computer process executed by at least one computer processor of at least one satellite for providing machine vision for disaster-relief support, includes, but is not limited to, obtaining imagery using at least one imager of the at least one satellite; detecting at least one event by analyzing at least one aspect of the imagery; and executing at least one operation based on the at least one event.

In a further embodiment, a satellite configured to provide machine vision for disaster-relief support, includes, but is not limited to, means for obtaining imagery using the at least one imager of the satellite; means for detecting at least one event by analyzing at least one aspect of the imagery; and means for executing at least one operation based on the at least one event.

### BRIEF DESCRIPTION OF THE DRAWINGS

Embodiments are described in detail below with reference to the following drawings:

FIG. 1 is perspective view of a satellite imaging system with edge processing, in accordance with an embodiment;

FIG. 2 is a perspective view of a global imager component of a satellite imaging system with edge processing, in accordance with an embodiment;

FIGS. 3A and 3B are perspective and cross-sectional views of a spot imager component of a satellite imaging system with edge processing, in accordance with an embodiment;

FIG. 4 is a field of view diagram of a satellite imaging system with edge processing, in accordance with an embodiment;

FIGS. 5-15 are component diagrams of a satellite imaging system with edge processing, in accordance with various embodiments;

FIG. 16 is a perspective view of a satellite constellation of an array of satellites that each include a satellite imaging system, in accordance with an embodiment;

FIG. 17 is a diagram of a communications system involving the satellite constellation, in accordance with an embodiment;

FIG. 18 is a component diagram of a satellite constellation of an array of satellites that each include a satellite imaging system, in accordance an embodiment;

FIG. 19 is a sample mass budget of a satellite imaging system, in accordance with an embodiment;

FIG. 20 is a sample mass estimate for a global imaging array, in accordance with an embodiment;

FIG. 21 is a possible power budget of an imaging system, in accordance with an embodiment;

FIG. 22 is a possible Delta-V budget that can be used as part of a launch strategy, in accordance with an embodiment;

FIGS. 23-33 are Earth coverage charts of various satellite configurations (e.g., percentage of time with at least one satellite in view above specified elevation angles relative to the horizon at certain latitudes OR percentage of time a specified number of satellites are above specified elevation angle at certain latitudes), in accordance with various embodiments;

FIGS. 34-41 are component diagrams of a satellite with machine vision, in accordance with various embodiments;

FIG. 42 is a flow diagram of a process executed by a satellite for providing machine vision, in accordance with an embodiment;

FIG. 43 is a component diagram of a satellite with machine vision, in accordance with an embodiment;

FIGS. 44-49 are component diagrams of a satellite with machine vision for disaster relief support, in accordance with various embodiments;

FIG. 50 is a flow diagram of a process executed by a satellite for providing machine vision for disaster relief support, in accordance with an embodiment; and

FIG. 51 is a component diagram of a satellite with machine vision for disaster relief support, in accordance with an embodiment.

### DETAILED DESCRIPTION

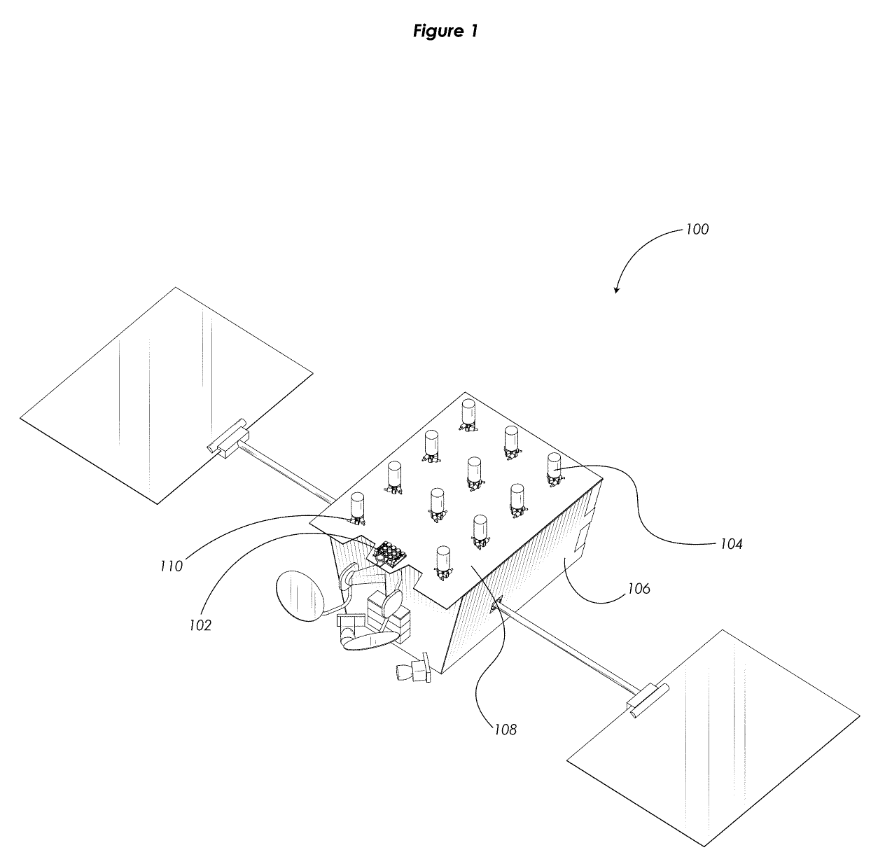

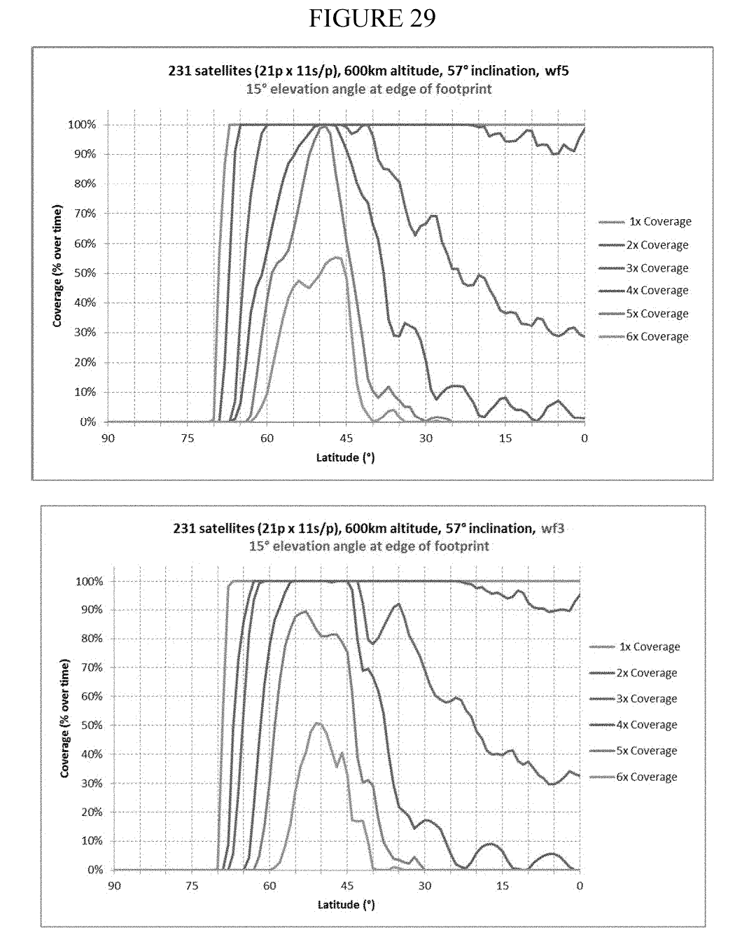

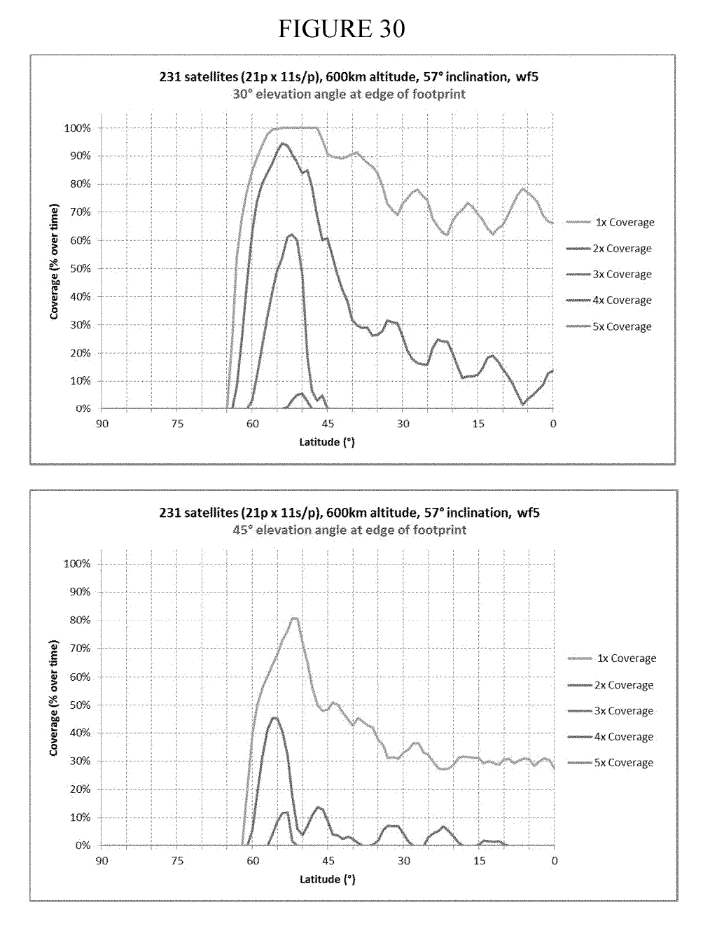

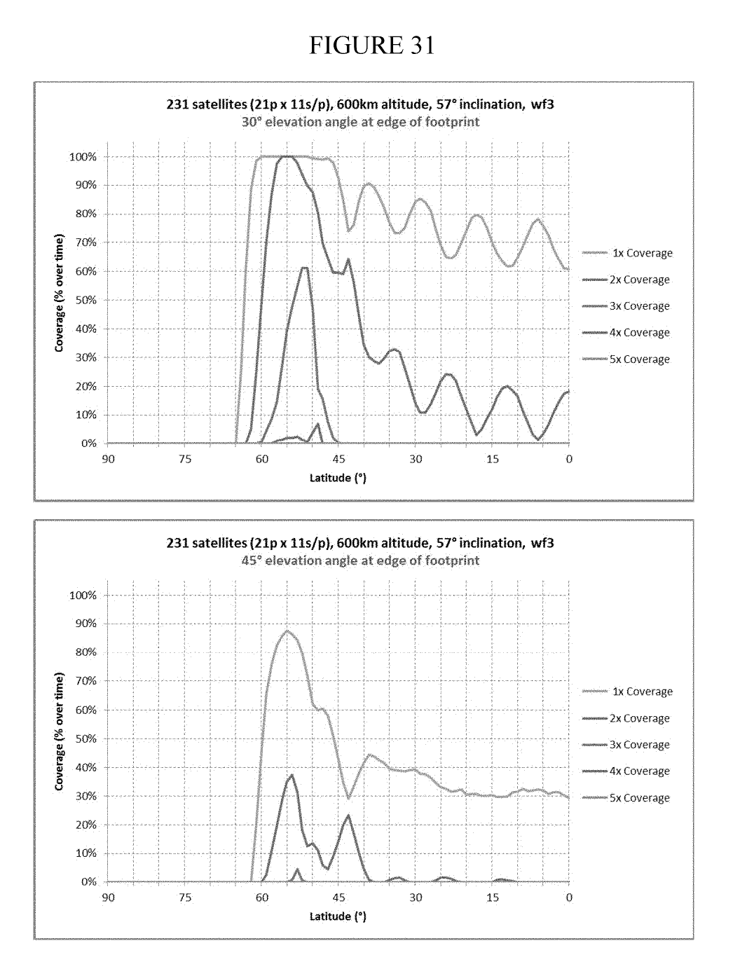

Embodiments disclosed herein relate generally to a satellite imaging system with edge processing, machine vision, and/or machine vision for disaster relief support. Specific details of certain embodiments are set forth in the following description and in FIGS. 1-51 to provide a thorough understanding of such embodiments.

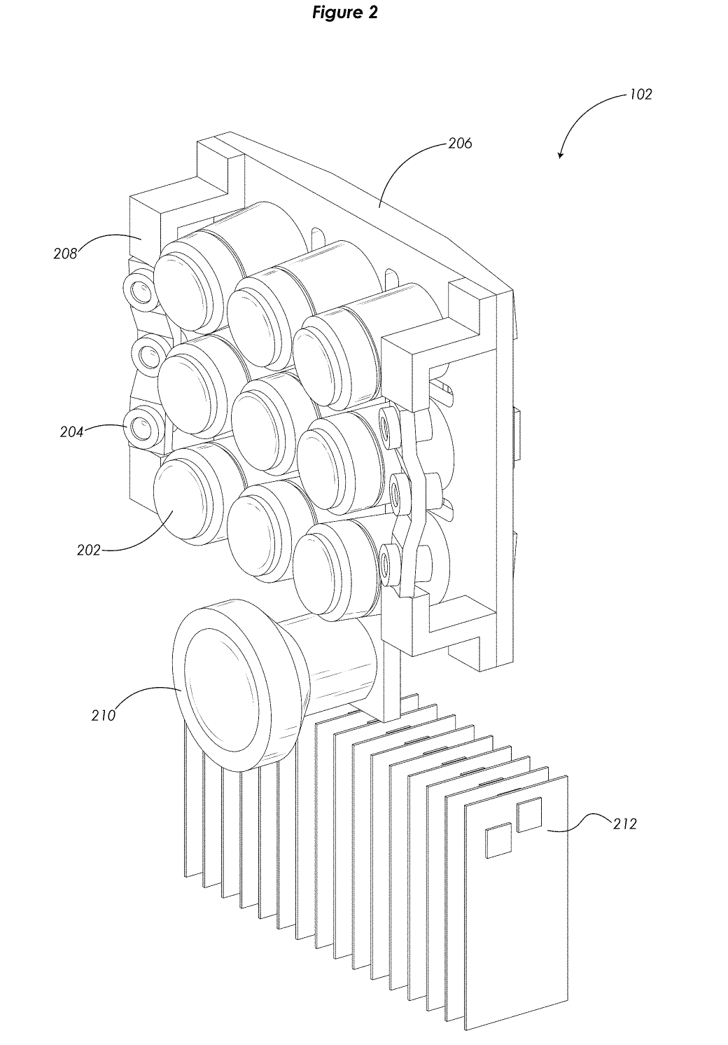

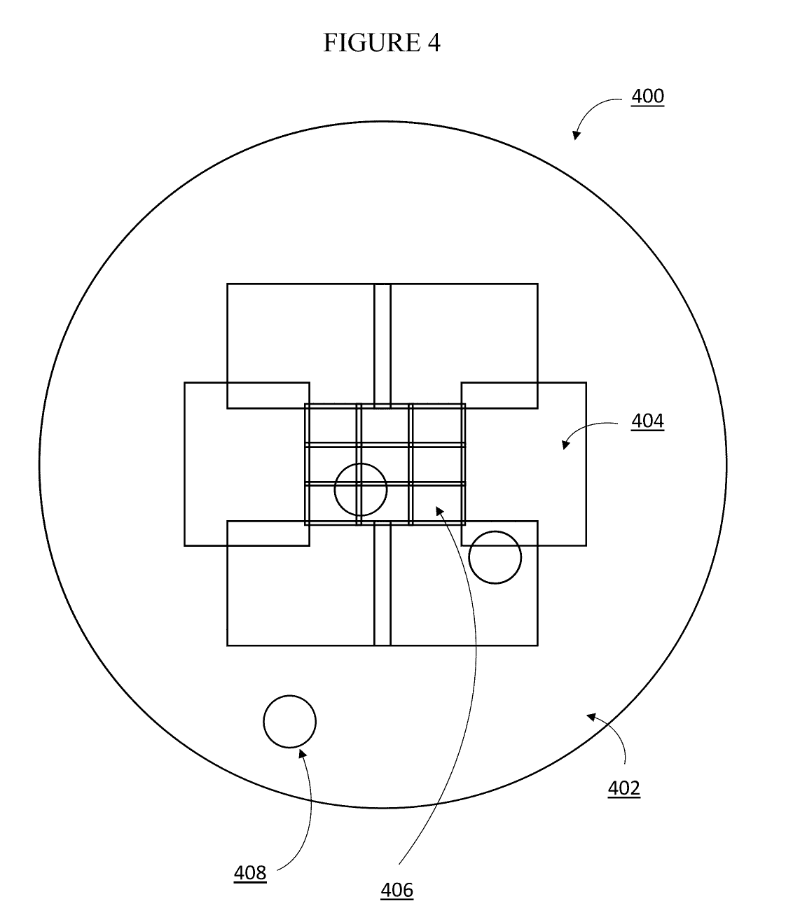

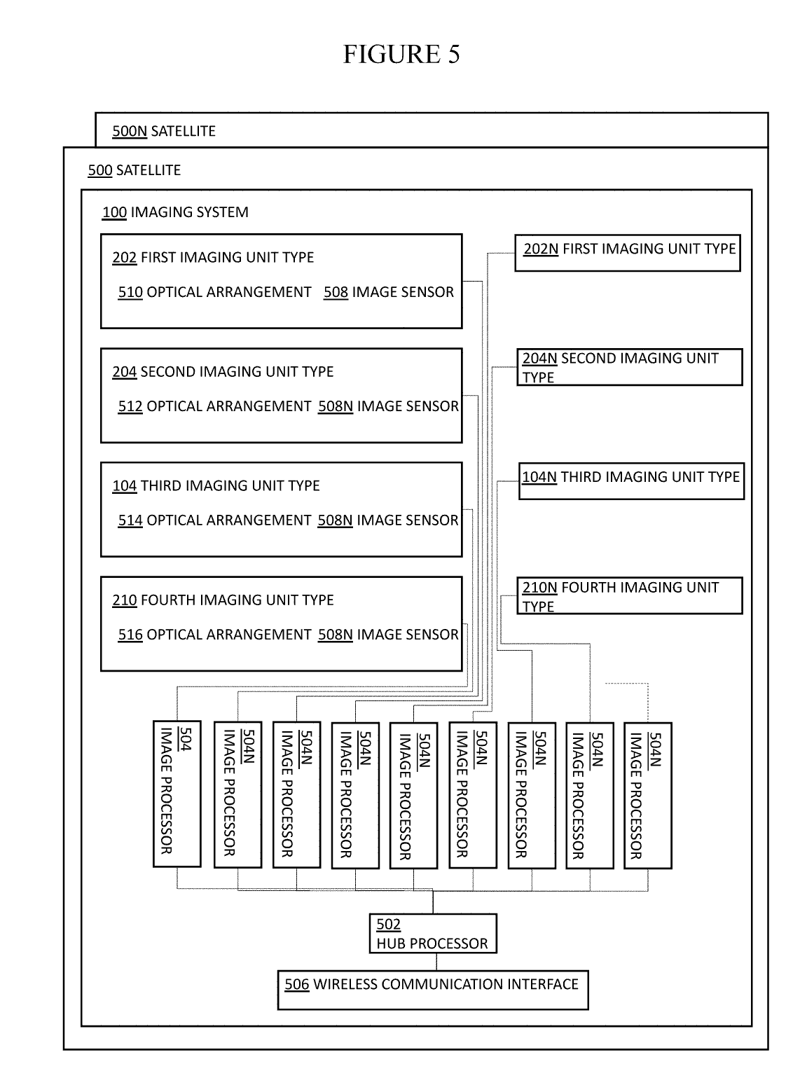

FIG. 1 is perspective view of a satellite imaging system with edge processing, in accordance with an embodiment. In one embodiment, a satellite imaging system 100 with edge processing includes, but is not limited to, (i) a global imaging array 102 including at least one first imaging unit (FIG. 2) configured to capture and process imagery of a first field of view (FIG. 4), at least one second imaging unit (FIG. 2) configured to capture and process imagery of a second field of view (FIG. 4) that is proximate to and larger than a size of the first field of view, and/or at least one fourth imaging unit (FIG. 2) configured to capture and process imagery of a field of view (FIG. 4) that at least includes the first field of view and the second field of view; and/or (ii) at least one third imaging unit 104 configured to capture and process imagery of a movable field of view (FIG. 4) that is smaller than the first field of view. The satellite imaging system 100 includes a hub processing unit (FIG. 5) linked to the at least one first imaging unit, the at least one second imaging unit, the at least one third imaging unit 104, and/or the at least one fourth imaging unit; and at least one wireless communication interface (FIG. 5) linked to the hub processing unit. The satellite imaging system 100 is mounted to at least one satellite bus 106.

In one embodiment, the satellite imaging system 100 includes one global imaging array 102 and nine steerable spot imagers 104. The steerable spot imagers 104 can include two additional backup steerable spot imagers 104 for a total of eleven. The steerable spot imagers 104 and the global imaging array 102 are mounted to a plate 108, with the global imaging array 102 fixed and the steerable spot imagers 104 being pivotable, such as via gimbals 110. The plate 108 is positioned on the satellite bus 106 and can include a shock absorber to absorb vibration. In certain embodiments, there can be included two or more instances of the global imaging array 102. The global imaging array 102 can itself be movable relative to the plate 108, such as via a track or gimbal. Likewise, there can be more or fewer of the steerable spot imagers 104 and any of the steerable spot imagers can be fixed and non-movable.

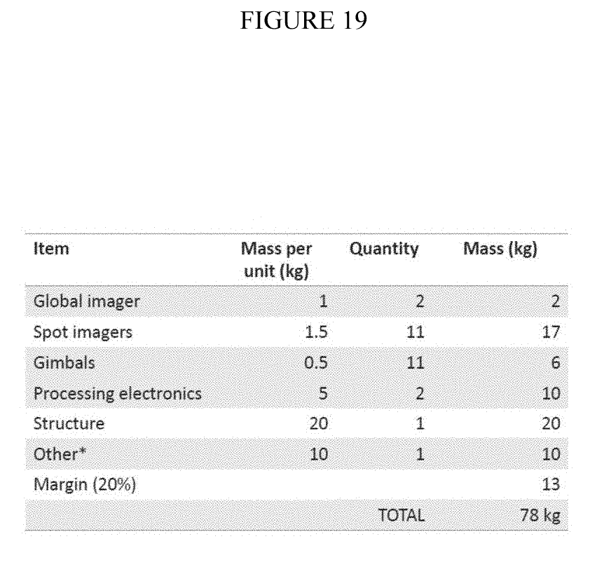

The satellite bus 106 can be a kangaroo-style AIRBUS ONEWEB SATELLITE bus that is deployable from a stowed state, such as by using a one-time hinge, and can be compliant for a SOYUZ/OW dispenser (4 meter class). Shielding can be provided to protect the global imaging array 102 and the steerable spot imagers 104 in the space environment, such as to protect against radiation. A possible mass budget of the satellite imaging system 100 is provided in FIG. 19 with the entire satellite mass being approximately 150 kg in this embodiment.

The global imaging array 102 can include approximately ten to twenty imagers (FIG. 2) to provide horizon-to-horizon imaging coverage in the visible and/or infrared/near-infrared ranges at a resolution of approximately 0.5-40 meters (nadir). The approximately nine to eleven steerable spot imagers 104 can each provide a respective field of view of twenty km in diagonal in the visible and/or infrared/near-infrared ranges at a resolution of approximately 0.5-3 meters (nadir). The steerable spot imagers 104 are independently pointable at specific areas of interest and each provide high to super-high resolution (e.g., one to four meter resolution) RGB and/or near IR video. The global imaging array 102 blankets substantially an entire field of view from horizon-to-horizon with low to medium resolution (e.g., twenty-five to one-hundred meter resolution) RGB and/or near IR video. Combined, the satellite imaging system 100 can include up to seventy or more imagers, with fewer or greater numbers of any particular imaging units.

The satellite imaging system 100 can capture hundreds of gigabytes per second of image data (e.g., using an array of sensors each capturing approximately twenty megapixels of imagery at twenty frames per second). The image data is processed onboard the satellete imaging system 100 through use of up to forty, fifty, sixty, or more processors. The onboard processing reduces the image data to that which is requested or required to reduce bandwidth requirements and overcome the space-to-ground bandwidth bottleneck, thereby enabling use of relatively low transmission bandwidths limited to up to between a few bytes per second to approximately a couple hundred megabytes per second or even a few gigabytes per second.

Applications of the satellite imaging system 100 are numerous and can include, for example, providing real-time high resolution horizon-to-horizon and close-up video of Earth that is user-controlled; providing augmented video/imagery; enabling simultaneous user access; enabling games; hosting local applications for enabling machine vision for interpretation of raw pre- or non-transmitted high resolution image data; providing a constantly updated video Earth model, or other useful purpose.

For example, high-resolution real-time or near-real-time video imagery of approximately one to three to ten or more meter resolution and approximately twenty-frames per second can be provided for any part of Earth in view under user control. This is accomplished in part using techniques such as pixel decimation to retain and transmit image content where resolution is held substantially constant independent of zoom level. That is, pixels are discarded or retained based on a level of zoom requested. Additional bandwidth reduction can be performed to remove imagery outside selected areas, remove previously transmitted static objects, remove previously transmitted imagery, remove overlapping imagery of simultanous request(s), or other pixel reduction operation. Compression on remaining image data can also be used. The overall result of one or more of these techniques is enabling data transfer of select imagery at high resolutions using only a few to a hundred megabits per second of bandwidth. Live deep-zooming of imagery is enabled where image resolution is effectively decoupled from bandwidth and where multiple simultaneous users can access the image data and have full control over the field of view, pan, and zoom within an overall Earth scene.

Augmented video mode enables augmentation of imagery with information that is relevant to or of user interest. For instance, real-time news regarding an area of focus can be added to imagery. The augmentations can be dependent on zoom and/or the viewing window, such as to provide time and scene dependent information of potential interest, such as news, tweets, event information, product information, travel offers, stories, or other information that enhances a media experience.

Multiple simultaneous or near-simultanous users can independently control pan and zoom within a scene of Earth for a customized experience. Further, multiple simultaneous or near-simultaneous user request can be satisfied by transmitting only once overlapping or previously transmitted imagery for reconstitution with non-duplicative or changing imagery at a ground station or server prior to transmission to a user.

Games that use real-time or near-real-time imagery can be augmented or complimented by time-dependent or location-dependent information, such as treasure hunts, POKEMON GO style games, or other games that evolve in-line with events on the ground.

Additionally, satellite-based hosting of applications and the onboard processing of the raw imagery data can enable satellite-level interpretation and analysis, also referred to as machine vision, artificial intelligence, or on-board processing. Applications can be uploaded for hosting, which applications have direct pre-transmission continous local access to full pixel data of an entire captured scene for analysis and interpretation on a real-time, near-real-time, periodic, or non-real-time basis. Hosted applications can be customized for business or user needs and can perform functions such as monitoring, analyzing, interperting, or reporting on certain events or objects or features. Output of the image processing, which can be imagery, textual, or binary data, can be transmitted in real-time or near-real-time, thereby enabling remote client access to output and/or high resolution imagery without uncessary bandwidth burdens. Multiple applications can operate in parallel, using the same or different imagery data for different purposes. For instance, one application can search and monitor for large ships and/or airliners while another application can monitor for large ice shelves calving or animal migration. Specific examples of applications include, but are not limited to (1) constant monitoring of substantially entire planet to detect, anlayze, and report on forest fires to enable early detection and reduce fire-fighting man-power and costs; (2) constant monitoring, analyzing, and reporting of calving and break-up of sea-ice and other Artic and Antartic phenomena for use in global climate change modeling or evaluating shipping lanes; (3) constant monitoring, detecting, analyzing, and reporting on volcano hots spots or eruptions as they occur for use in science, weather, climate, commercial, or air traffic mangement applications; (4) detecting and monitoring events in advance of positioning satellite assets; (5) constant monitoring, analyzing, and reporting on croplands (e.g. 1.22-1.71 billion hectares of Earth), crop growth, maturation, stress, harvesting, such as to determine when and where to irrigate, fertilize, seed crops, use herbicides for increasing yields or reducing costs; (6) tracking objects independent of visual noise or other objects (e.g., vehicles, ships, whale breaches, airplanes); (7) comparing airplane and ship image data to flight plan, ADS-B, and AIS information to identify and/or determine legality of presence or activity; (8) identify specific large animals such as whales using signatures detected through temporal changes from frame-to-frame; (9) monitor animal migration, feeding, or patterns; (10) tracking moving assets in real-time; (11) detecting volicity, heading, and altitude of objects; (12) detecting temporal effects such as a whale spout, lightning strikes, explosions, collisions, eruptions, earthquakes, and/or natural disasters; (13) detect anomolies; (14) 3D reconstruction using multiple 2D images or video streams; (15) geofencing or area security; (16) border control; (17) infrastructure monitoring; (18) resource monitoring; (19) food security monitoring; (20) disaster warning (21) geological change monitoring; (22) urban area change monitoring; (23) urban traffic management; (24) aircraft and ship traffic management; (25) logistics, (26) auto-change detection (e.g., monitoring to detect movement or change in coverage area and notifying a user or performing a task), or the like.

A historical earth video model can be built and regularly updated to enable a historical high-definition archive of Earth video imagery, such as for playing, fast-forwarding, rewinding for (1) viewing events, changes, and/or metadata related to the same; (2) performing post detection identification; (3) performing predictive modeling; (4) asset counting; (5) accident investigation; (6) providing virtual reality content; (7) performing failure, disaster, missing asset investigations; or the like.

The above functionality can be useful in fields or contexts such as, but not limited to, news reporting, mairtime activities, national security or intelligence, border control, tsunami warning, floods, launch vehicle flight tracking, oil/gas spillage, asset transportation, live and interactive learning/teaching, traffic mangement, volcanic activities, forest fires, consumer curiosity, animal migration tracking, media, environmental, socializing, education, exploration, tornado detection, business intelligence, illegal fishing, shipping, mapping, agriculture, weather forecasting, environmental monitoring, disaster support, defense, analytics, finance, social media, interactive learning, games, television, or the like.

FIG. 2 is a perspective view of a global imager component of a satellite imaging system with edge processing, in accordance with an embodiment. In one embodiment, the global imaging array 102 includes, but is not limited to, at least one first imaging unit 202 configured to capture and process imagery of a first field of view (FIG. 4); at least one second imaging unit 204 configured to capture and process imagery of a second field of view (FIG. 4) that is proximate to and larger than a size of the first field of view; and a hub processing unit (FIG. 5) linked to the at least one first imaging unit 202 and the at least one second imaging unit 204. In one particular embodiment, the at least one first imaging unit 202 includes an array of nine first imaging units 202 arranged in a grid and each configured to capture and process imagery of a respective field of view as tiles of at least a portion of a scene. In another particular embodiment, the at least one second imaging unit 204 includes array of six second imaging units 204 arranged on opposing sides of the at least one first imaging unit 202 and each configured to capture and process imagery of a respective field of view as tiles of at least a portion of a scene. In a further particular embodiment, at least one fourth imaging unit 210 is provided and configured to capture and process imagery of a field of view (FIG. 4) that at least includes the first field of view and the second field of view.

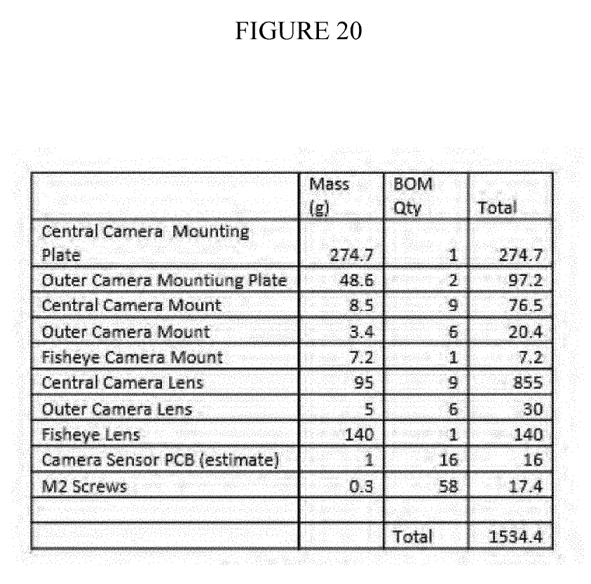

In one embodiment, the global imaging array 102 includes, but is not limited to, a central mounting plate 206; an outer mounting plate 208; mounting hardware for each of the inner imaging units 202, the outer imaging units 204, and fisheye imaging unit 210; and one or more image processors 212. The inner imaging units 202 and the fisheye imaging unit 210 are mounted to the central mounting plate 206 using mounting hardware. The outer imaging units 204 are mounted to the outer mounting plate 208 using mounting hardware, which outer mounting plate 208 is secured to the central mounting plate 206 using fasteners. The central mounting plate 206 and the outer mounting plate 208 can comprise aluminum machined frames. Furthermore, the central mounting plate 206 and the outer mounting plate 208 and/or the mounting hardware can provide for lateral slop to allow accurate setting and pointing of each of the respective the inner imaging units 202, the outer imaging units 204, and the fisheye imaging unit 210. Any of the inner imaging units 202, the outer imaging units 204, and the fisheye imaging unit 210 can be focusable. A sample mass estimate for the global imaging array 102 is provided in FIG. 20.

Many modifications to the global imaging array 102 are possible. For example, fewer or greater numbers of the inner imaging units 202, the outer imaging units 204, and the fisheye imaging unit 210 are possible (e.g., zero to tens to hundreds of respective imaging units). Furthermore, the arrangement of any of the inner imaging units 202, the outer imaging units 204, and the fisheye imaging unit 210 can be different. The arrangement can be linear, circular, spherical, cubical, triangular, or any other regular or irregular pattern. The arrangement can also include the outer imaging units 204 positioned above, below, beside, on some sides, or on all sides of the inner imaging units 202. The fisheye imaging unit 210 can be similarly positioned above, below, or to one or more sides of either the inner imaging units 202 or the outer imaging units 204. Likewise, changes can be made to the central mounting plate 206 and/or the outer mounting plate 208, including a unitary structure that combines the central mounting plate 206 and the outer mounting plate 208. The central mounting plate 206 and/or the outer mounting plate 208 can be square, rectangular, oval, curved, convex, concave, partially or fully spherical, triangular, or another regular or irregular two or three-dimensional shape. Furthermore, the image processors 212 are depicted as coupled to the central mounting plate 206, but the image processors 212 can be moved to one or more different positions as needed or off of the global imaging array 102.

The fisheye imaging unit 210 provides a super wide field of view for an overall scene view. Typically, one or two fisheye imaging unit 210 is provided per global imaging array 102 and includes a lens, image sensor (infrared and/or visible), and an image processor, which may be dedicated or part of a pool of available image processors (FIG. 5). The lens can comprise a ½ Format, C-Mount, 1.4 mm focal length lens from EDMUND OPTICS. This particular lens has the following characteristics: focal length 1.4; maximum sensor format ½″, field of view for ½″ sensor 185×185 degrees; working distance of 100 mm-infinity; aperture f/1.4-f/16; diameter 56.5 mm; length 52.2 mm; weight 140 g; mount C; fixed focal length; and RoHS C. Other lenses of similar characteristics can be substituted for this particular example lens.

The inner imaging unit 202 provides a more narrow field of view for central imaging. Typically, up to approximately nine first imaging units 202 are provided per global imaging array 102 and each includes a lens, image sensor (infrared and/or visible), and an image processor, which may be dedicated or part of a pool of available image processors (FIG. 5). The lens can comprise a 22 mm, F/1.8, high resolution, ⅔″ format, machine vision lens from THORLABS. Characteristics of this lens include a focal length of 25 mm, F-number F/1.8-16; image size 6.6×8.8 mm; diagonal field of view 24.9 degrees, working distance 0.1 m, mount C, front and rear aperture 18.4 mm, temperature range 10 to 50 centigrade, resolution 200p/mm at center and 160p/mm at corner. Other lenses of similar characteristics can be substituted for this particular example lens.

The outer imaging unit 204 provides a slightly or significantly wider field of view for more peripheral imaging. Typically, up to approximately six first imaging units are provided per global imaging array 102 and each includes a lens, image sensor (infrared and/or visible), and an image processor, which may be dedicated or part of a pool of available image processors (FIG. 5). The lens can comprise a 8.0 mm FL, high resolution, infinite conjugate micro video lens. Characteristics of this lens include a field of view on ½″ sensor of 46 degrees; working distance of 400 mm to infinity; maximum resolution full field 20 percent at 160 lp/mm; distortion-diagonal at full view −10 percent; aperture f/2.5; and maximum MTF listed at 1601p/mm. Other lenses of similar characteristics can be substituted for this particular example lens.

The global imaging array 102 is configured, therefore, to provide horizon-to-horizon type tiled imaging in the visible and/or infrared or near-infrared ranges, such as for overall Earth scene context and high degrees of central acuity. Characteristics of the field of view of the imaging array 102 can include super wide horizon-to-horizon field of view; approximately 98 degree H×84 degree V central field of view; spatial resolution of approximately 1-100 meters from 400-700 km; and low volume/low mass platform (e.g., less than approximately 200×200×100 mm in volume and around 1 kg in mass). Changes in lens selection, imaging unit quantities, mounting structure, and the like can change this set of example characteristics.

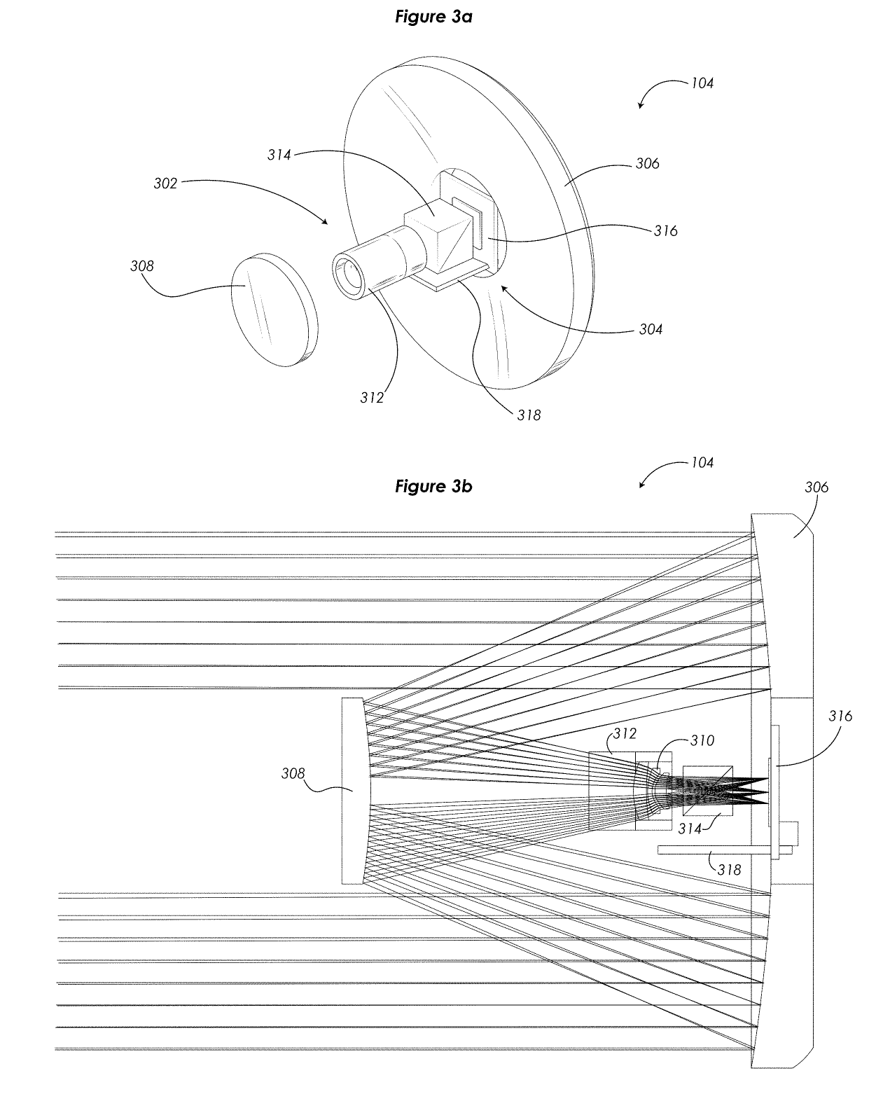

FIGS. 3A and 3B are perspective and cross-sectional views of a spot imager component of a satellite imaging system with edge processing, in accordance with an embodiment. In one embodiment, the satellite imaging system 100 further includes at least one third imaging unit 104 that includes a third optical arrangement 302, a third image sensor 304, and a third image processor (FIG. 5) that is configured to capture and process imagery of a movable field of view (FIG. 4) that is smaller than the first field of view.

In certain embodiments, the steerable spot imager 104 provides a movable spot field of view with ultra high resolution imagery. A catadioptric design can include a aspheric primary reflector 306 of greater than approximately 130 mm diameter, a spherical secondary reflector 308; three meniscus singlets as refractive elements 310 positioned within a lens barrel 312; a beamsplitter cube 314 to split visible and infrared channels; a visible image sensor 316; and an infrared image sensor 318. The primary reflector 306 and the secondary reflector 308 can include mirrors of Zerodur or CCZ; a coating of aluminum having approximately 10A RMS surface roughness; a mirror substrate thickness to diameter ratio of approximately 1:8. The dimensions of the steerable spot imager 104 include an approximately 114 mm tall optic that is approximately 134 mm in diameter across the primary reflector 306 and approximately 45 mm in diameter across the secondary reflector 308. Characteristics of the steerable spot imager 104 include temperature stability; low mass (e.g., approximately 1 kg of mass); little to no moving parts; and positioning of image sensors within the optics.

Baffling in and around the steerable spot imager 104 (e.g., a housing) can be provided to reduce stray light, such as light that misses the primary reflector 306 and strikes the secondary reflector 308 or the refractive elements 310. Further, the primary reflector 306 and the secondary reflector 308 are configured and arranged to reduce scatter contributions that can potentially reduce image contrast. The lens barrel 312 can further act as a shield to reduce stray light.

In operation, light is reflected and focused by the primary reflector 306 onto the secondary reflector 308. The secondary reflector 308 reflects and focuses the light into the lens barrel 312 and through the refractive elements 310. The refractive elements 310 focus light through the beam splitter 314, where visible light passes to the visible sensor 316 and infrared light is split to the infrared sensor 318.

The steerable spot imager 104 can be mounted to the plate 108 of the satellite imaging system 100 using a gimbal 110 (FIG. 1), such as that available from TETHERS UNLIMITED (e.g., COBRA-C or COBRA-C+). The gimbal 110 can be a three degree of freedom gimbal that provides a substantially full hemispherical workspace; precision pointing; precision motion control; open/closed loop operation; 1G operation tolerance; continuous motion; and high slew rates (e.g., greater than approximately 30 degrees per second) with no cable wraps or slip rings. An extension can be used to provide additional degrees of freedom. The gimbal 110 characteristics can include approximately 487 g mass; approximately 118 mm diameter; approximately 40 mm stack height; approximately 85.45 mm deployed height; resolution of approximately less than 3 arcsec; accuracy of approximately <237 arcsec; and max power consumption of approximately 3.3 W. The gimbal 110 can be arranged with and pivot close to or at the center of gravity of the steerable spot imager 104 to reduce negative effects of slewing. Additionally, movement of one steerable spot imager 104 can be offset by movement of another steerable spot imager 104 to minimize effects of slewing and cancel out movement.

The satellite imaging system 100 can include approximately nine to twelve steerable spot imagers 104 that are independently configured to focus, dwell, and/or scan for select targets. Each spot imager 104 can pivot approximately +/−seventy degrees and can include proximity sensing to avoid lens crashing. The steerable spot imagers 104 can provide an approximately 20 km diagonal field of view of approximately 4:3 aspect ratio. Resolution can be approximately one to three meters (nadir) in the visible and infrared or near-infrared range obtained using image sensors 316 and 318 of approximately 8 million pixels per square degree. Resolution can be increased to super-resolution when the spot imagers 104 dwell on a particular target to collect multiple image frames, which multiple image frames are combined to increase the resolution of a still image.

Many other steerable spot imager 104 configurations are possible, including a number of all-refractive type lens arrangements. For instance, one possible spot imager 104 achieving less than approximately a 3 m resolution at 500 km orbit includes an approximately 209.2 mm focal length, approximately 97 mm opening lens height; approximately 242 mm lens track; less than approximately F/2.16; spherical and aspherical lenses of approximately 1.3 kg; and a beam splitter for a 450 nm-650 nm visible channel and an 800 nm to 900 nm infrared channel.

Another steerable spot imager 104 configuration includes a 165 mm focal length; F/1.7; 2.64 degree diagonal object space; 7.61 mm diagonal image; 450-650 nm waveband; fixed focus; limited diffraction anomalous-dispersion glasses; 1.12 um pixel pitch; and a sensor with 5408×4112 pixels. Potential optical designs include a 9-element all-spherical design with a 230 mm track and a 100 mm lens opening height; a 9-element all-spherical design with 1 triplet and a 201 mm track with a 100 mm lens opening height; and an 8-element design with 1 asphere and a 201 mm track with a 100 mm lens opening height. Other steerable spot imager 104 configurations can include any of the following lens or lens equivalents having focal lengths of approximately 135 mm to 200 mm: OLYMPUS ZUIKO; SONY SONNAR T*; CANON EF; ZEISS SONNAR T*; ZEISS MILVUS; NIKON DC-NIKKOR; NIKON AF-S NIKKOR; SIGMA HSM DG ART LENS; ROKINON 135M-N; ROKINON 135M-P, or the like.

FIG. 4 is a field of view diagram of a satellite imaging system with edge processing, in accordance with an embodiment. In one embodiment, the satellite imaging system 100 is configured to capture imagery of a field of view 400. Field of view 400 comprises a fisheye field of view 402; outer cone 404; inner cone 406; and one or more spot cones 408. The fisheye field of view 402 is captured using the fisheye imaging unit 210. The outer cone 404 is captured using the outer imaging units 204 (e.g., 6×8 mm focal length EDMUNDS OPTICS 69255). The inner cone 406 is captured using the inner imaging units 202 (e.g., 9×25 mm focal length THORLABS MVL25TM23). The spot cones 408 (three depicted as circles) are captured using the steerable spot imagers 104 (e.g., catadioptric design FIG. 3). The field of view 400 can include visible and/or infrared or near-infrared imagery in whole or in part.

The inner cone 406 comprises nine sub fields of view, which can at least partially overlap as depicted. The inner cone 406 can span approximately 40 degrees (e.g., 460 9×10.5 degree×13.8 degree subfields) and be associated with imagery of approximately m resolution (nadir). The outer cone 404 comprises six sub fields of view, which can at least partially overlap as depicted and can form a perimeter around the inner cone 406. The outer cone 404 can span approximately 90 degrees (6×42.2 degree×32.1 degree subfields) and be associated with imagery of approximately 95 m resolution (nadir). The fisheye field of view can comprise a single field of view and span approximately 180 degrees. The spot cones 408 comprises approximately 10-12 cones, which are independently movable across any portion of the fisheye field of view 402, the outer cone 404, or the inner cone 406. The spot cones 408 provide a narrow field of view of limited degree that is approximately 20 km in diameter across the Earth surface from approximately 400-700 km altitude. The inner cone 406 and the outer cone 404 and the subfields of view within each form tiles of a central portion of the overall field of view 400. Note that overlap in the adjacent fields and subfields of view associated with the outer cone 404 and the inner cone 406 may not be uniform across the entire field depending upon lens arrangement and configuration and any distortion.

The field of view 400 therefore includes the inner core 406, outer core 404, and fisheye field of view 402 to provide overall context with low to high resolution imagery from the periphery to the center. Each of the subfields of the inner core 406, the subfields of the outer core 404, and the fisheye field of view are associated with separate imaging units and separate image processors, to enable capture of low to high resolution imagery and parallel image processing. Overlap of the subfields of the inner core 406, the subfields of the outer core 404, and the fisheye field of view enable stitching of adjacent imagery obtained by different image processors. Likewise, the spot cones 408 are each associated with separate imaging units and separate image processors to enable capture of super-high resolution imagery and parallel image processing.

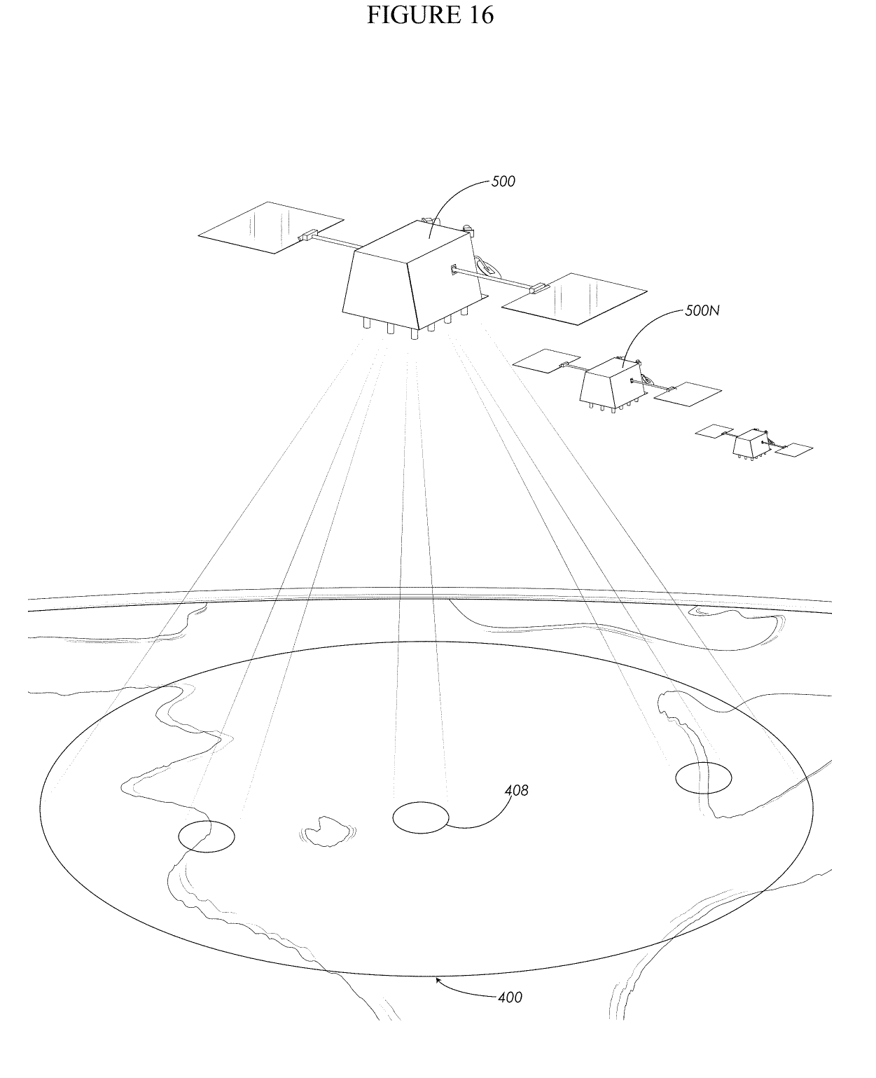

The field of view 400 captures imagery associated with an Earth scene below the satellite imaging system 100 (e.g., nadir). Because the satellite imaging system orbits and moves relative to Earth, the content of the field of view 400 changes over time. In a constellation of satellite imaging systems 100 (FIG. 16), an array of fields of view 400 capture video or static imagery simultaneously to provide substantially complete coverage of Earth from space.

The field of view 400 is provided as an example and many changes are possible. For example, the sizes of the fisheye field of view 402, the outer core 404, the inner core 406, or the spot cones 408 can be increased or decreased or omitted as desired for a particular application. Additional cores, such as a mid-core between the inner core 406 and the outer core 404, or a core outer to the outer core 404 can be included. Likewise, the subfields of the outer core 404 or the inner core 406 can be increased or decreased in size or quantity. For example, the inner core 406 can comprise a single subfield and the outer core 404 can comprise a single subfield. Alternatively, the inner core 406 can comprise tens or hundreds of subfields and the outer core 404 can comprise tens or hundreds of subfields. The fisheye field of view 402 can include two, three, four, or more redundant or at least partially overlapping subfields of view. The spot cones 408 can be one to dozens or hundreds in quantity and can range in size from approximately 1 km diagonal to tens or hundreds of km diagonal. Furthermore, any given satellite imaging system 100 can include more than one field of view 400, such as a front field of view 400 and a back field of view 400 (e.g., one pointed at Earth and another directed to outer space). Alternatively, an additional field of view 400 can be directed ahead, behind, or to a side of an orbital path of a satellite. The fields of view 400 in this context can be different or identical.

FIG. 5 is a component diagram of a satellite imaging system with edge processing, in accordance with an embodiment. In one embodiment, a satellite 500 with image edge processing, includes, but is not limited to, an imaging system 100 including at least an array of first imaging unit types 202 and 202N arranged in a grid and each configured to capture and process imagery of a respective first field of view; an array of second imaging unit types 204 and 204N each configured to capture and process imagery of a respective second field of view that is proximate to and larger than the first field of view; an array of independently movable third imaging unit types 104 and 104N each configured to capture and process imagery of a third field of view that is smaller than the first field of view and that is directable at least within the first field of view and the second field of view; and at least one fourth imaging unit type 210/210N configured to capture and process imagery of a fourth field of view that at least includes the first field of view and the second field of view; an array of image processors 504 and 504N linked to respective ones of the array of first imaging unit types 202 and 202N, the array of second imaging unit types 204 and 204N, the array of independently movable third imaging unit types 104 and 104N, and the at least one fourth imaging unit type 210/210N; a hub processing unit 502 linked to each of array of image processors 504 and 504N; and a wireless communication interface 506 linked to the hub processor 502.

The optical arrangement 510 of the array of first imaging unit types 202 and 202N can include any of those discussed herein or equivalents thereof. For example, an optical arrangement 510 can comprise a 22 mm, F/1.8, high resolution ⅔″ format machine vision lens from THORLABS. Characteristics of this optical arrangement include a focal length of 25 mm; F-number F/1.8-16; image size 6.6×8.8 mm; diagonal field of view 24.9 degrees; working distance 0.1 m; mount C; front and rear effective aperture 18.4 mm; temperature range 10 to 50 centigrade, resolution 200p/mm at center and 160p/mm at corner. Other optical arrangements of similar characteristics can be substituted for this particular example.

The optical arrangement 512 of the array of second imaging unit types 204 and 204N can include any of those discussed herein or equivalents thereof. For example, an optical arrangement 512 can comprise a 8.0 mm focal length, high resolution, infinite conjugate micro video lens. Characteristics of this optical arrangement include a field of view on ½″ sensor of 46 degrees; working distance 400 mm to infinity; maximum resolution full field 20 percent at 160 lp/mm; distortion-diagonal at full view −10 percent; aperture f/2.5; and maximum MTF listed at 1601p/mm. Other optical arrangements of similar characteristics can be substituted for this particular example.

The optical arrangement 514 of the an array of independently movable third imaging unit types 104 and 104N can include any of those discussed herein or equivalents thereof. For example, a catadioptric design 514 can include a aspheric primary reflector 306 of greater than approximately 130 mm diameter, a spherical secondary reflector 308; three meniscus singlets as refractive elements 310 positioned within a lens barrel 312; and a beamsplitter cube 314 to split visible and infrared channels. The primary reflector 306 and the secondary reflector 308 can include mirrors of Zerodur or CCZ; a coating of aluminum having approximately 10A RMS surface roughness; a mirror substrate thickness to diameter ratio of approximately 1:8. The dimensions can include an approximately 114 mm tall optic that is approximately 134 mm in diameter across the primary reflector 306 and approximately 45 mm in diameter across the secondary reflector 308. Further characteristics can include temperature stability; low mass (e.g., approximately 1 kg of mass); few to no moving parts; and positioning of image sensors within the optics.

Many other optical arrangements are possible, including a number of all-refractive type lens arrangements. For instance, one optical arrangement achieving less than approximately a 3 m resolution at 500 km orbit includes an approximately 209.2 mm focal length; approximately 97 mm opening lens height; approximately 242 mm lens track; less than approximately F/2.16; spherical and aspherical optics of approximately 1.3 kg; and a beam splitter for a 450 nm-650 nm visible channel and an 800 nm to 900 nm infrared channel.

Another optical arrangement includes a 165 mm focal length; F/1.7; 2.64 degree diagonal object space; 7.61 mm diagonal image; 450-650 nm waveband; fixed focus; limited diffraction; and anomalous-dispersion lenses. Potential designs include a 9-element all-spherical design with a 230 mm track and a 100 mm lens opening height; a 9-element all-spherical design with 1 triplet and a 201 mm track with a 100 mm lens opening height; and an 8-element design with 1 asphere and a 201 mm track with a 100 mm lens opening height. Other configurations can include any of the following optics or equivalents having focal lengths of approximately 135 mm to 200 mm: OLYMPUS ZUIKO; SONY SONNAR T*; CANON EF; ZEISS SONNAR T*; ZEISS MILVUS; NIKON DC-NIKKOR; NIKON AF-S NIKKOR; SIGMA HSM DG ART LENS; ROKINON 135M-N; ROKINON 135M-P, or the like.

The optical arrangement 516 of the at least one fourth imaging unit type 210/210N can include any of those discussed herein or equivalents thereof. For example, the optical arrangement 516 can comprise a ½ Format, C-Mount, Fisheye Lens with a 1.4 mm focal length from EDMUND OPTICS. This particular arrangement has the following characteristics: focal length 1.4; maximum sensor format ½″, field of view for ½″ sensor 185×185 degrees; working distance of 100 mm-infinity; aperture f/1.4-f/16; maximum diameter 56.5 mm; length 52.2 mm; weight 140 g; mount C; fixed focal length; and RoHS C. Other optics of similar characteristics can be substituted for this particular example.

The image sensor 508 and 508N of the array of first imaging unit types 202 and 202N, the array of second imaging unit types 204 and 204N, the array of independently movable third imaging unit types 104 and 104N, and the at least one fourth imaging unit type 210/210N can each comprise an IMX 230 21 MegaPixel image sensor or similar alternative. The IMX 230 includes characteristics of 1×2.4 inch panel; 5408 H×4112 V pixels; and 5 Watts of power usage. Alternative image sensors include those comprising approximately 9 megapixel capable of approximately 17 Gigabytes per second of image data and having at least approximately 10,000 pixels per square degree. Image sensors can include even higher MegaPixel sensors as available (e.g., 250 megapixel plus image sensors). The image sensors 508 and 508N can be the same or different for each of the array of first imaging unit types 202 and 202N, the array of second imaging unit types 204 and 204N, the array of independently movable third imaging unit types 104 and 104N, and the at least one fourth imaging unit type 210/210N.

The image processors 504 and 504N and/or the hub processor 502 can each comprise a LEOPARD/INTRINSYC ADAPTOR coupled with a SNAPDRAGON 820 SOM. Incorporated in the SNAPDRAGON 820 SOM are one or more additional technologies such as SPECTRA ISP; HEXAGON 680 DSP; ADRENO 530; KYRO CPU; and ADRENO VPU. SPECTRA ISP is a 14-bit dual-ISP that supports up to 25 megapixels at 30 frames per second with zero shutter lag. HEXAGON 680 DSP with HEXAGON VECTOR EXTENSIONS supports advanced instructions optimized for image and video processing; KYRO 280 CPU includes dual quad core CPUs optimized for power efficient processing. The vision platform hardware pipeline of the image processors 504 and 504N can include ISP to convert camera bit depth, exposure, and white balance; DSP for image pyramid generation, background subtraction, and object segmentation; GPU for optical flow, object tracking, neural net processing, super-resolution, and tiling; CPU for 3D reconstruction, model extraction, and custom applications; and VPT for compression and streaming. Software frameworks utilized by the image processors 504 can include any of OPENGL, OPEN CL, FASTCV, OPENCV, OPENVX, and/or TENSORFLOW. The image processors 504 and 504N can be tightly coupled and/or in close proximity to the respective image sensors 508N and/or the hub processor 502 for high speed data communication connections (e.g., conductive wiring or copper traces).

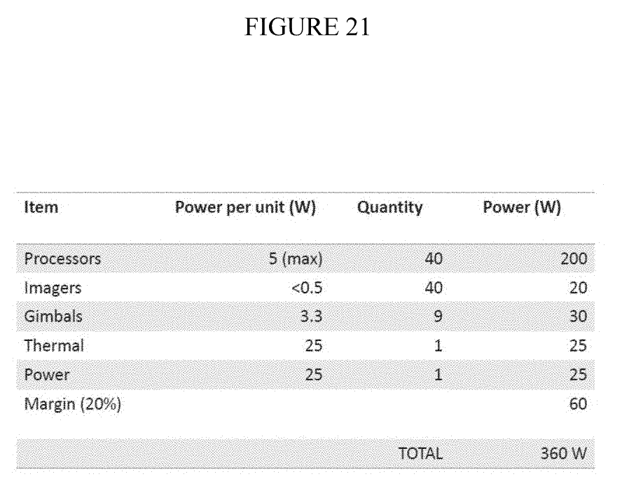

The image processors 504 and 504N can be dedicated to respective ones of the array of first imaging unit types 202 and 202N, the array of second imaging unit types 204 and 204N, the array of independently movable third imaging unit types 104 and 104N, and the at least one fourth imaging unit type 210/210N. Alternatively, the image processors 504 and 504N can be part of a processor bank that is fluidly assignable to any of the array of first imaging unit types 202 and 202N, the array of second imaging unit types 204 and 204N, the array of independently movable third imaging unit types 104 and 104N, and the at least one fourth imaging unit type 210/210N, on an as needed basis. For example, high levels of redundancy can be provided whereby any image sensor 508 and 508N of any of the the array of first imaging unit types 202 and 202N, the array of second imaging unit types 204 and 204N, the array of independently movable third imaging unit types 104 and 104N, and the at least one fourth imaging unit type 210/210N, on an as needed basis, can communicate with any of the image processors 504 and 504N. For example, a supervisor CPU can monitor each of the image processors 504 and 504N and any of the links between those image processors 504 and 504N and any of the image sensors 508 and 508N of any of the the array of first imaging unit types 202 and 202N, the array of second imaging unit types 204 and 204N, the array of independently movable third imaging unit types 104 and 104N, and the at least one fourth imaging unit type 210/210N. In an event a failure or exception is detected a crosspoint switch can reassign one of the functional image processors 504 and 504N (e.g., a backup or standby image processor) to continue image processing operations with respect to the particular image sensor 508 or 508N. A possible power budget of imaging system 100 of satellite 500 is provided in FIG. 21.

The hub processor 502 manage, triage, delegate, coordinate, and/or satisfy incoming or programmed image requests using appropriate ones of the image processors 504 and 504N. For instance, hub processor 502 can coordinate with any of the image processors 504 to perform initial image reduction, image selection, image processing, pixel identification, resolution reduction, cropping, object identification, pixel extraction, pixel decimation, or perform other actions with respect to imagery. These and other operations performed by the hub processor 502 and the image processors 504 and 504N enable local/on-board/edge/satellite-level processing of ultra-high resolution imagery in real-time, whereby the amount of image data captured outstrips the bandwidth capabilities of the wireless communication interface 506 (e.g., Gigabytes vs. Megabytes). For instance, full resolution imagery can be processed at the satellite to identify and send select portions of the raw image data at relatively high resolutions for a particular receiving device (e.g., APPLE IPHONE, PC, MACBOOK, or tablet). Alternatively, satellite-hosted applications can process raw high resolution imagery to identify objects and communicate text or binary data requiring only a few bytes per second. These types of operations and others, which are discussed herein, enable many simultaneous users and application processes at even a single satellite 500.

The wireless communication interface 506 can be coupled to the hub processor 502 via a high speed data communication connection (e.g., conductive wiring or copper trace). The wireless communication interface 506 can include a satellite radio communication link (e.g., Ka-band, Ku-band, or Q/V-band) with communication speeds of approximately one to two-hundred megabytes per second.

In any event, the combination of multiple imaging units and image processors enables parallel capture, recording, and processing of tens or even hundreds of video streams simultaneously with full access to ultra high resolution video and/or static imagery. The image processors 504 and 504N can collect and process up to approximately gigabytes per second or more of image data per satellite 500 and as much as 30 terabytes per second of image data per constellation of satellites 500N (e.g. based on a capture rate of approximately 20 megapixels at 20 frames per second for each image sensor 508 and 508N). The image processors 504 and 504N can include approximately 20 teraflops or more of processing power per satellite 500 and as much as 2 petaflops of processing power per constellation of satellites 500N.

Many functions and/or operations can be performed by the image processors 504 and 504N and the hub processor 502 including, but not limited to, (1) real-time or near-real-time processing and transmission from space to ground only imagery wanted or needed or required to reduce bandwidth requirements and overcome the space-to-ground bandwidth bottleneck; (2) hosting local applications for analyzing and reporting on pre or non-transmitted high resolution imagery; (3) building a substantially full earth video database; (4) scaling video so that resolution remains substantially constant regardless of zoom level (e.g., by discarding pixels captured at a variable amount that is inversely proportionate to a zoom level); (5) extracting key information from a scene such as text to reduce bandwidth requirements to only a few bytes per second; (6) cropping and pixel decimation based on field of view (e.g., throwing away up to 99 percent of captured pixels); (7) obtaining parallel streams (e.g., 10-17 streams) and cutting up image data into a pyramid of resolutions before sectioning and compressing the data; (8) obtaining, stitching, and compressing imagery from different fields of view; (9) distributing image processing load to image processors having access to desired imagery without requiring all imagery to be obtained and processed by a hub processor; (10) obtaining a request, identifying which image processors correspond to a portion of the request, and transmitting sub request to the appropriate image processors; (11) obtain image data in pieces and stitch the image data to form a composite image; (12) coordinate requests between users and the array of image processors; (13) host applications or APIs for accessing and processing image data; (14) perform image resolution reduction or compression; (15) perform character or object recognition; (16) provide a client websocket to obtain a resolution and field of view request, obtain image data to satisfy the request, and return image data, timing data, and any metadata to the client (e.g., browser); (17) perform multiple levels of pixel reduction; (18) attach metadata to image data prior to transmission; (19) performing background subtraction; (20) perform resolution reduction or selection reduction to at least partially reduce pixel data; (21) coding; (22) perform feature recognition; (23) extract or determine text or binary data for transmission with or without image data; (24) perform physical or geographical area monitoring; (25) process high resolution raw image data prior to transmission; (26) enable APIs for custom configurations and applications; (27) enable live, deep-zoom video by multiple simultaneous clients; (28) enable independent focus, zoom, and steering by multiple simultaneous clients; (29) enable pan and zoom in real-time; (30) enable access to imagery via smartphone, tablet, computer, or wearable device; and/or (31) identify and track important objects or events.

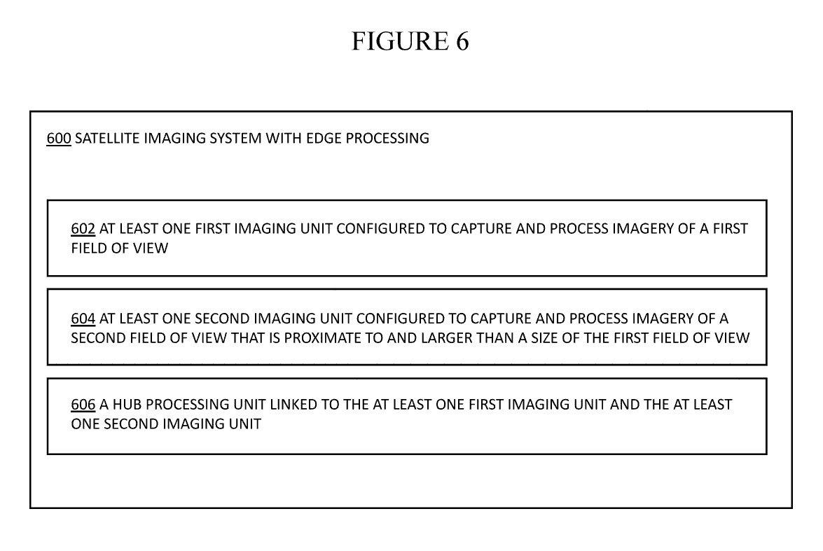

FIG. 6 is a component diagram of a satellite imaging system with edge processing, in accordance with an embodiment. In one embodiment, a satellite imaging system 600 with edge processing includes, but is not limited to, at least one first imaging unit configured to capture and process imagery of a first field of view at 602; at least one second imaging unit configured to capture and process imagery of a second field of view that is proximate to and larger than a size of the first field of view at 604; and a hub processing unit linked to the at least one first imaging unit and the at least one second imaging unit at 606.

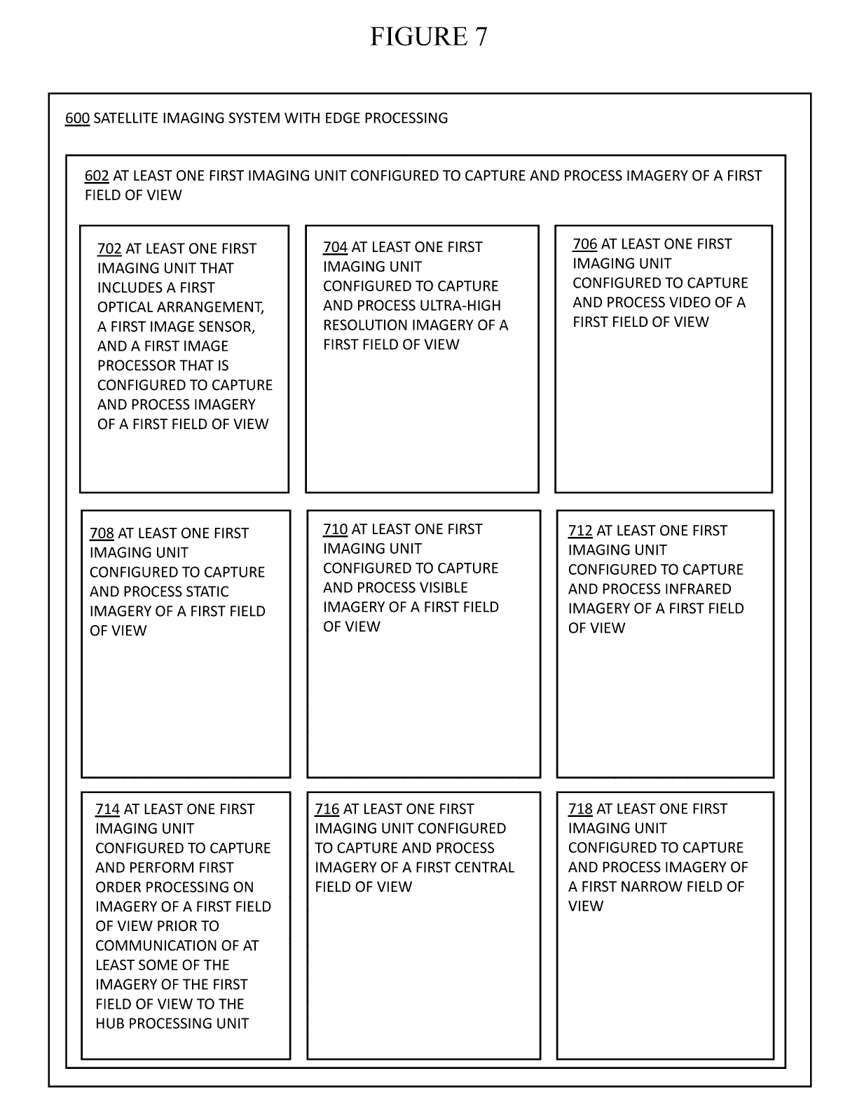

FIG. 7 is a component diagram of a satellite imaging system 600 with edge processing, in accordance with an embodiment.

In one embodiment, the at least one first imaging unit configured to capture and process imagery of a first field of view includes, but is not limited to, at least one first imaging unit that includes a first optical arrangement, a first image sensor, and a first image processor that is configured to capture and process imagery of a first field of view at 702. For example, the at least one first imaging unit 202 includes a first optical arrangement 510, a first image sensor 508, and a first image processor 504 that is configured to capture and process imagery of a first field 406. The first imaging unit 202 and its constituent components can be physically integrated and tightly coupled, such as within a same physical housing or within mm or centimeters of proximity. Alternatively, the first imaging unit 202 and its constituent components can be physical separated, within a particular satellite 500. In one particular example, the optical arrangement 510 and the image sensor 508 are integrated and the image processor 504 is located within a processor bank and coupled via a high-speed communication link to the image sensor 508 (e.g., USBx.x or equivalent). The image processor 504 can be dedicated to the image sensor 508 or alternatively, the image processor 504 can be assigned on an as-needed basis to one or more other image sensors 508 (e.g., to other of the first imaging units 202, second imaging units 204, third imaging units 104, or fourth imaging units 210). On one particular satellite 500, there can be anywhere from one to hundreds of the first imaging units 202, such as nine of the first imaging units 202.

In one embodiment, the at least one first imaging unit configured to capture and process imagery of a first field of view includes, but is not limited to, at least one first imaging unit configured to capture and process ultra-high resolution imagery of a first field of view at 704. For example, the at least one first imaging unit 202 is configured to capture and process ultra-high resolution imagery of a first field of view 406. Ultra-high resolution imagery can include imagery of one to hundreds of megapixels, such as for example twenty megapixels. The imagery can be captured as a single still image or as video at a rate of tens of frames per second (e.g., twenty frames per second). The combination of multiple imaging units 202/202N, 204/204N, 104/104N, and 210/210N and image processors 508/508N enables parallel capture, recording, and processing of tens or even hundreds of ultra-high resolution video streams of different fields of view simultaneously. The amount of image data collected can be approximately 400 gigabytes per second or more per satellite 500 and as much as approximately 30 terabytes or more per second per constellation of satellites 500N. The total amount of ultra-high resolution imagery is therefore more than a satellite to ground bandwidth capability, such as orders of magnitude more.

In certain embodiments, the ultra-high resolution imagery provides acuity of approximately 1-40 meters spatial resolution from approximately 400-700 km altitude, depending upon the particular optical arrangement. Thus, a ship, car, animals, people, structures, weather, natural disasters, and other surface or atmospheric objects, events, or activities can be discerned from the image data collected.

In one embodiment, the at least one first imaging unit configured to capture and process imagery of a first field of view includes, but is not limited to, at least one first imaging unit configured to capture and process video of a first field of view at 706. For example, the at least one first imaging unit 202 is configured to capture and process video of a first field of view 406. In one example, the video can be captured at approximately one or more megapixels at approximately tens of frames per second (e.g., around twenty megapixels at approximately twenty frames per second). The first imaging unit 202 is fixed relative to the satellite 500, in certain embodiments, and the satellite 500 is in orbit with respect to Earth. Therefore, the video of the field of view 406 has constantly changing coverage of Earth as the satellite 500 moves in its orbital path. Thus, the video image data can include subject matter or content of oceans, seas, lakes, streams, flat land, mountainous terrain, glaciers, cities, people, vehicles, aircraft, boats, weather systems, natural disasters, and the like. In some embodiments, the first imaging unit 202 is fixed and aligned substantially perpendicular to Earth (nadir). However, oblique alignments are possible and the first imaging unit 202 may be movable or steerable.

In one embodiment, the at least one first imaging unit configured to capture and process imagery of a first field of view includes, but is not limited to, at least one first imaging unit configured to capture and process static imagery of a first field of view at 708. For example, the at least one first imaging unit 202 is configured to capture and process static imagery of a first field of view 406. The static imagery can be captured at approximately one or more megapixel pixel resolution (e.g., approximately twenty megapixels). While the at least one first imaging unit 202 is fixed, in certain embodiments, the satellite 500 to which the at least one first imaging unit 202 is coupled is orbiting Earth. Accordingly, the field of view 406 of the at least one first imaging unit 202 covers changing portions of Earth throughout the orbital path of the satellite 500. Thus, the static imagery can be of people, animals, archaeological events, weather, cities and towns, roads, crops and agriculture, structures, military activities, aircraft, boats, water, or the like. In certain embodiments, the static imagery is captured in response to a particular event detected (e.g., a fisheye fourth imaging unit 210 detects a hurricane and triggers the first imaging unit 202 to capture an image of the hurricane with higher spatial resolution).

In one embodiment, the at least one first imaging unit configured to capture and process imagery of a first field of view includes, but is not limited to, at least one first imaging unit configured to capture and process visible imagery of a first field of view at 710. For example, the at least one first imaging unit 202 is configured to capture and process visible imagery of a first field of view 406. Visible imagery is that light reflected off of Earth, weather, or that emitted from objects or events on Earth, for example, that is within the visible spectrum of approximately 390 nm to 700 nm. Visible imagery of the first field of view 406 can include content such as video and/or static imagery obtained from the first imaging unit 202 as the satellite 500 progresses through its orbital path. Thus, the visible imagery can include a video of the outskirts of Bellevue, Wash. to Bremerton, Wash. via Mercer Island, Lake Washington, Seattle, and Puget Sound, following the path of the satellite 500. The terrain, traffic, cityscape, people, aircraft, boats, and weather can be captured at spatial resolutions of approximately one to forty meters.

In one embodiment, the at least one first imaging unit configured to capture and process imagery of a first field of view includes, but is not limited to, at least one first imaging unit configured to capture and process infrared imagery of a first field of view at 712. For example, the at least one first imaging unit 202 is configured to capture and process infrared imagery of a first field of view 406. Infrared imagery is light having a wavelength of approximately 700 nm to 1 mm. Near-infrared imagery is light having a wavelength of approximately 0.75-1.4 micrometers. The infrared imagery can be used for night vision, thermal imaging, hyperspectral imaging, object or device tracking, meteorology, climatology, astronomy, and other similar functions. For example, infrared imagery of the first imaging unit 202 can include scenes of the Earth experiencing nighttime (e.g., when the satellite 500 is on a side of the Earth opposite the Sun). Alternatively, infrared imagery of the first imaging unit 202 can include scenes of the Earth experiencing cloud coverage. In certain embodiments, the infrared imagery and visible imagery are captured simultaneously by the first imaging unit 202 using a beam splitter. As discussed with respect to visible imagery, the infrared imagery of the first field of view 406 covers changing portions of the Earth based on the orbital progression of the satellite 500 to which the first imaging unit 202 is included.

In one embodiment, the at least one first imaging unit configured to capture and process imagery of a first field of view includes, but is not limited to, at least one first imaging unit configured to capture and perform first order processing on imagery of a first field of view prior to communication of at least some of the imagery of the first field of view to the hub processing unit at 714. For example, the at least one first imaging unit 202 is configured to capture and perform first order processing on imagery of a first field of view 406 using the image processor 504 prior to communication of at least some of the imagery of the first field of view 406 to the hub processing unit 502. The first imaging unit 202 captures ultra high resolution imagery of a small subfield of the field of view 406 (FIG. 4). The ultra-high resolution imagery can be on the order of 20 megapixels per frame and 20 frames per second, or more. However, not all of the ultra-high resolution imagery of the subfield of field 406 may be needed or required. Accordingly, the image processor 504 of the first imaging unit 202 can perform first order reduction operations on the imagery prior to communication to the hub processor 502. Reduction operations can include those such as pixel decimation, cropping, static or background object removal, un-selected area removal, unchanged area removal, previously transmitted area removal, or the like. For example, in an instance where a low-zoom distant wide area view is requested involving imagery captured of subfield of view 406, pixel decimation can be performed by the image processor 504 to remove a portion of the pixels unneeded (e.g., due to a requesting device of an IPHONE having a limit to screen resolution of 1136×640 many of the captured pixels are not useful). The pixel decimation can be uniform (e.g., every other or every second or every specified pixel can be removed). Alternatively, the pixel decimation can be non-uniform (e.g., variable pixel decimation involving uninteresting and interesting objects such as background vs. foreground or moving vs. non-moving objects). Pixel decimation can be avoided or minimized in certain circumstances within portions of the subfields of the field of view 406 that overlap, to enable stitching of adjacent subfields by the hub processor 502. Object and area removal can be performed by the image processor 504, involving removal of pixels that are not requested or that correspond to pixel data previously transmitted and/or that is unchanged since a previous transmission. For example, a close-up image of a shipping vessel against an ocean background can involve the image processor 504 of the first imaging unit 202 removing pixel data associated with the ocean that was previously communicated in an earlier frame, is unchanged, and that does not contain the shipping vessel. In certain embodiments, the image processor 504 performs machine vision or artificial intelligence operations on the image data of the field of view 406. For instance, the image processor can perform image, object, feature, or pattern recognition with respect to the image data of the field of view 406. Upon detecting a particular aspect, the image processor 504 can output binary data, text data, program executables, or a parameter. An example of this in operation includes the image processor 504 detecting a presence of an aircraft within the field of view 406 that is unrecognized against flight plan data or ADS-B transponder data. Output of the image processor 504 may include GPS coordinates and a flag, such as “unknown aircraft”, which can be used by law enforcement, aviation authorities, or national security personnel to monitor the aircraft without necessarily requiring image data.

In one embodiment, the at least one first imaging unit configured to capture and process imagery of a first field of view includes, but is not limited to, at least one first imaging unit configured to capture and process imagery of a first central field of view at 716. For example, the at least one first imaging unit 202 is configured to capture and process imagery of a first central field of view 406. The central field of view 406 can be comprised of a plurality of subfields, such as nine subfields that at least partially overlap as depicted in FIG. 4. The first central field of view 406 can be square, rectangular, triangular, oval, or other regular or irregular shape. Surrounding the first central field of view 406 can be one or more other fields of view that may at least partially overlap, such as outer field of view 404, fisheye field of view 402, or spot field of view 408. The first central field of view 406 can be adjustable, movable, or fixed. In one particular example, the at least one first imaging unit 202 is associated with a single subfield of the field of view 406, such as the lower left, middle bottom, upper right, etc., as depicted in FIG. 4.

In one embodiment, the at least one first imaging unit configured to capture and process imagery of a first field of view includes, but is not limited to, at least one first imaging unit configured to capture and process imagery of a first narrow field of view at 718. For example, the at least one first imaging unit 202 is configured to capture and process imagery of a first narrow field of view 406. Narrow is relative to an outer field of view 404 or fisheye field of view 402, which have larger or wider fields of view. The narrow field of view 406 may be composed of a plurality of subfields as depicted in FIG. 4. The narrow size of the field of view 406 permits high acuity and high spatial resolution imagery to be captured over a relatively small area.

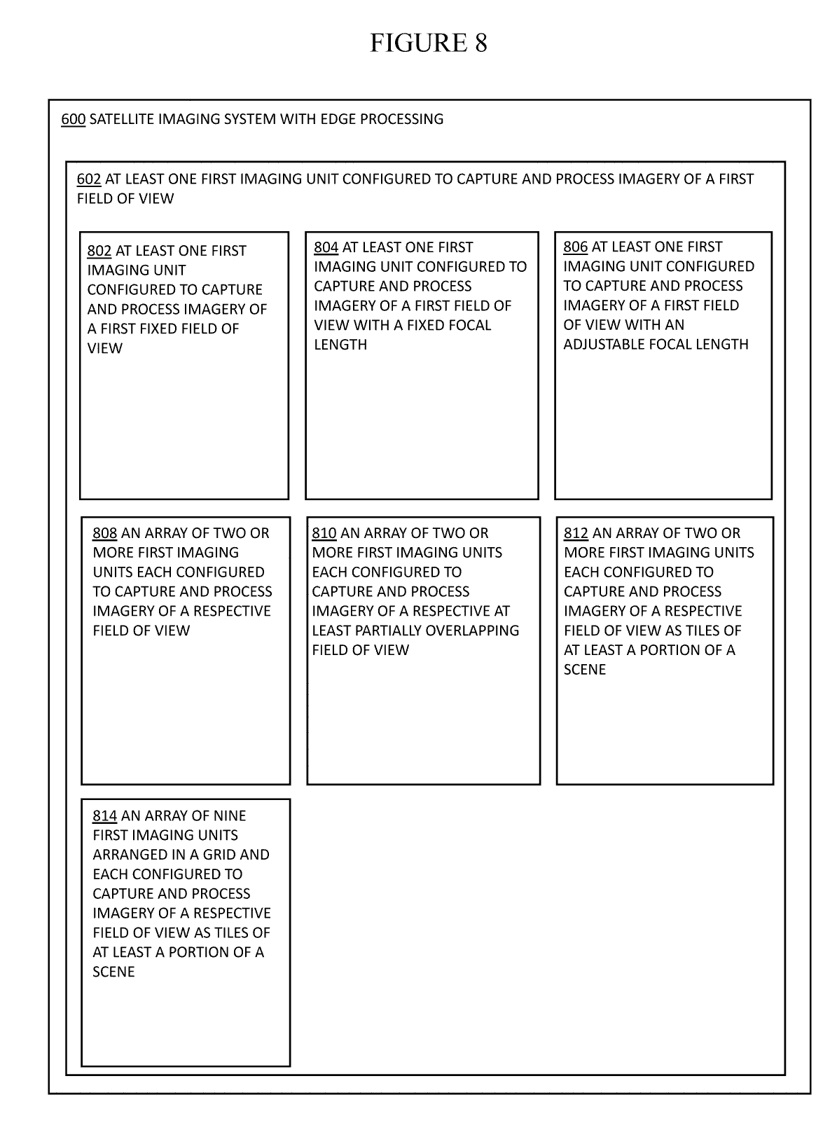

FIG. 8 is a component diagram of a satellite imaging system 600 with edge processing, in accordance with an embodiment.

In one embodiment, the at least one first imaging unit configured to capture and process imagery of a first field of view includes, but is not limited to, at least one first imaging unit configured to capture and process imagery of a first fixed field of view at 802. For example, the at least one first imaging unit 202 is configured to capture and process imagery of a first fixed field of view 406. The optical arrangement 510 can be fixedly mounted on the central mounting plate 206 as depicted in FIG. 2. In instances of nine subfields of the field of view 406, nine optical arrangements of the first imaging units 202 an 202N can be oriented as follows: bottom lens on opposing sides each oriented to capture opposing side top subfields of field of view 406; middle lens on opposing sides each oriented to capture opposing middle side subfields of field of view 406; top lens on opposing sides each oriented to capture opposing bottom side subfields of field of view 406, middle bottom lens oriented to capture top middle subfield of field of view 406; middle center lens oriented to capture middle center subfield of field of view 406, and middle top lens oriented to capture bottom middle subfield of field of view 406. In each of these cases, the respective side lens to subfield is cross-aligned such that left lenses are associated with right subfields and vice versa. The respective bottom lens to subfield is also cross-aligned such that bottom lenses are associated with top subfields and vice versa. Other embodiments of the optical arrangements 510 of the imaging units 202 and 202N are possible, including positioning of the lenses radially, in a cone, convexly, concavely, facing oppositely, or cubically, for example. Additionally, the second imaging unit 202 and 202N can be repositionable or movable to change a position of a corresponding subfield of the field of view 206. While the field of view 406 may be fixed, zoom and pan operations can be performed digitally by the image processor 504. For instance, the optical arrangement 510 can have a fixed field of view 406 to capture image data that is X mm wide and Y mm in height using the image sensor 508. The image processor 504 can manipulate the retained pixel data to digitally recreate zoom and pan effects within the X by Y envelope. Additionally, the optical arrangement 510 can be configured for adjustable focal length and/or configured to physically pivot, slide, or rotate for panning. Moreover, movement can be accomplished within the optical arrangement 510 or by movement of the plate 108.

In one embodiment, the at least one first imaging unit configured to capture and process imagery of a first field of view includes, but is not limited to, at least one first imaging unit configured to capture and process imagery of a first field of view with a fixed focal length at 804. For example, the at least one first imaging unit 202 is configured to capture and process imagery of a first field of view 406 with a fixed focal length. The optical arrangement 510 can comprise a 22 mm F/1.8 high resolution ⅔″ format machine vision lens from THORLABS. Characteristics of this lens include a focal length of 25 mm, F-number F/1.8-16; image size 6.6×8.8 mm; diagonal field of view 24.9 degrees, working distance 0.1 m, mount C, front and rear effective aperture 18.4 mm, temperature range 10 to 50 centigrade, resolution 200p/mm at center and 160p/mm at corner. Other lenses of similar characteristics can be substituted for this particular example lens.

In one embodiment, the at least one first imaging unit configured to capture and process imagery of a first field of view includes, but is not limited to, at least one first imaging unit configured to capture and process imagery of a first field of view with an adjustable focal length at 806. For example, the at least one first imaging unit 202 is configured to capture and process imagery of a first field of view 406 with an adjustable focal length. The adjustable focal length can be enabled, for example, by mechanical threads that adjust a distance of one or more of the lenses of the optical arrangement 510 relative to the image sensor 508. In instances of mechanically adjustable focal lengths, the image processor 504 can further digitally recreate additional zoom and/or pan operations within the envelope of image data captured by the image sensor 508.

In one embodiment, the at least one first imaging unit configured to capture and process imagery of a first field of view includes, but is not limited to, an array of two or more first imaging units each configured to capture and process imagery of a respective field of view at 808. For example, the array of two or more first imaging units 202 and 202N are each configured to capture and process imagery of a respective subfield of the field of view 406. Optical arrangement 510 of the first imaging unit 202 can be posited adjacent, opposing, opposite, diagonally, or otherwise in proximity to an optical arrangement of another of the first imaging units 202N. Each of the optical arrangements of the first imaging units 202 and 202N are associated with a different subfield of the field of view 406 (e.g., the top left and top center subfields of the field of view 406). The size of the fields of view can be modified or varied and can range; however, in one particular example each subfield is approximately 10×14 degrees for a total of approximately 10 degrees by 24 degrees in combination for two side by side subfields. More than two subfields of the field of view 406 are possible, such as tens or hundreds of subfields. FIG. 4 depicts a particular example embodiment where nine subfields are arranged in a grid of 3×3 to constitute the field of view 406. Each of the subfields are approximately 10.5×13.8 degrees for a total field of view 406 of approximately 30×45 degrees. Thus, the image sensor 508 of the first imaging unit 202 captures image data of a first subfield of field of view 406 and the image sensor of the first imaging unit 202N captures image data of a second subfield of field of view 406. Additional first imaging units 202N can capture additional image data for additional subfields of field of view 406. The image processors 504 and 504N associated with the respective image sensors therefore have access to different image content for processing, which image content corresponds to the subfields of the field of view 406.

In one embodiment, the at least one first imaging unit configured to capture and process imagery of a first field of view includes, but is not limited to, an array of two or more first imaging units each configured to capture and process imagery of a respective at least partially overlapping field of view at 810. In one embodiment, the array of two or more first imaging units 202 and 202N each are configured to capture and process imagery of a respective at least partially overlapping subfield of the field of view 406. The optical arrangement 510 of the first imaging unit 202 and the optical arrangement of the first imaging unit 202N can be physically aligned such that their respective subfields of the field of view 406 are at least partially overlapping. The overlap of the subfields of the field of view 406 can be on a left, right, bottom, top, or corner. Depicted in FIG. 4 are nine subfields of the field of view 406 with adjacent ones of the subfields overlapping by a relatively small amount (e.g., around one to twenty percent or around five percent). The overlap of subfields of the field of view 406 permit image processors 504 and 504N, associated with adjacent subfields of the field of view 406, to have access to at least some of the same imagery to enable the hub processor 502 to stitch together image content. For example, the image processor 504 can obtain image content from the top left subfield of the field of view 406, which includes part of an object of interest such as a road ferrying military machinery. Image processor 504N can likewise obtain image content from a top center subfield of the field of view 406, including an extension of the road ferrying military machinery. Image processor 504 and 504N each have different image content of the road with some percentage of overlap. Following any reduction or first order processing performed by the respective image processors 504 and 504N, the residual image content can be communicated to the hub processor 502. The hub processor 502 can stitch the image content from the image processors 504 and 504N to create a composite image of the road ferrying military machinery, using the overlapping portions for alignment.

In one embodiment, the at least one first imaging unit configured to capture and process imagery of a first field of view includes, but is not limited to, an array of two or more first imaging units each configured to capture and process imagery of a respective field of view as tiles of at least a portion of a scene 812. For example, an array of two or more first imaging units 202 and 202N are each configured to capture and process imagery of a respective subfield of the field of view 406 as tiles of at least a portion of a scene 400. Tiling of the scene 400 combined with parallel processing by an array of image processors 504 and 504N enables higher speed image processing with access to more raw image data. With respect to image data, the raw image data is substantially increased for the overall scene 400 by partitioning the scene 400 into tiles, such as subfields of the field of view 406. Each of the tiles is associated with an optical arrangement 510 and an image sensor 508 that captures megapixels of image data per frame with multiples of frames per second. A single image sensor may capture approximately 20 megapixels of image data at a rate of approximately 20 frames per second. This amount of image data is multiplied for each additional tile to generate significant amounts of image data, such as approximately gigabytes per second per satellite 500 and as much as 30 terabytes per second or more of image data per constellation of satellites 500N. Thus, the combination of multiple tiles and multiple image sensors results in significantly more image data than would be possible with a single lens and sensor arrangement covering the scene 400 in its entirety. Processing of the significant raw image data is enabled by parallel image processors 504 and 504N, which each perform operations for a specified tile (or group of tiles) of the plurality of tiles. The image processing operations can be performed by the image processors 504 and 504N simultaneously with respect to different tiled portions of the scene 400.

In one embodiment, the at least one first imaging unit configured to capture and process imagery of a first field of view includes, but is not limited to, an array of nine first imaging units arranged in a grid and each configured to capture and process imagery of a respective field of view as tiles of at least a portion of a scene at 814. For example, satellite 500, includes an array of nine first imaging units 202 and 202N arranged in a three-by-three grid that are each configured to capture and process imagery of a respective subfield of the field of view 406 as tiles of at least a portion of a scene 400.

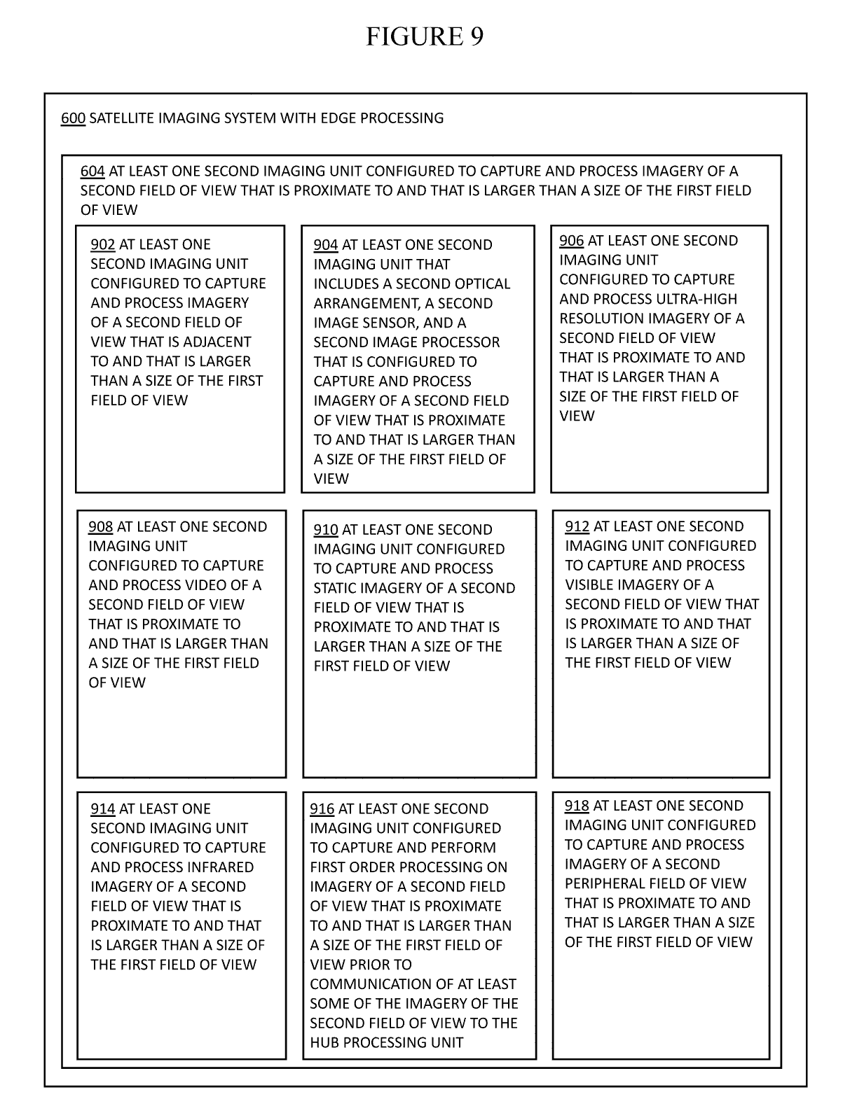

FIG. 9 is a component diagram of a satellite imaging system 600 with edge processing, in accordance with an embodiment.

In one embodiment, the at least one second imaging unit configured to capture and process imagery of a second field of view that is proximate to and that is larger than a size of the first field of view includes, but is not limited to, at least one second imaging unit configured to capture and process imagery of a second field of view that is adjacent to and that is larger than a size of the first field of view at 902. For example, the at least one second imaging unit 204 is configured to capture and process imagery of a second field of view 404 that is adjacent to and that is larger than a size of the first field of view 406. The second imaging unit 204 includes the optical arrangement 512 that is directed at the field of view 404, which is larger and adjacent to the field of view 406. For example, the field of view 404 maybe approximately five to seventy-five degrees, twenty to fifty degrees, or thirty to forty-five degrees. In one particular embodiment, the field of view 404 is approximately 42.2 by 32.1 degrees. The field of view 404 may be adjacent to the field of view 406 in a sense of being next to, above, below, opposing, opposite, or diagonal to the field of view 406.

In one embodiment, the at least one second imaging unit configured to capture and process imagery of a second field of view that is proximate to and that is larger than a size of the first field of view includes, but is not limited to, at least one second imaging unit that includes a second optical arrangement, a second image sensor, and a second image processor that is configured to capture and process imagery of a second field of view that is proximate to and that is larger than a size of the first field of view at 904. For example, the at least one second imaging unit 204 includes the optical arrangement 512, an image sensor 508N, and an image processor 504N that is configured to capture and process imagery of a second field of view 404 that is proximate to and that is larger than a size of the first field of view 406. In certain embodiments, a plurality of second imaging units 204 and 204N are included, each having the optical arrangement 512 and an image sensor 508N. Each of the plurality of second imaging units 204 and 204N have image processors 504N dedicated at least temporarily to processing image data of respective image sensors 508N of the plurality of second imaging units 204 and 204N. The optical arrangements 512 of each of the plurality of second imaging units 204 and 204N are directed toward subfields of the field of view 404, which subfields are arranged at least partially around the periphery of the field of view 406, in one embodiment. Thus, the image sensors 508N of the second imaging units 204 and 204N capture image data of each of the subfields of the field of view 404 for processing by the respective image processors 504N.

As a particular example, the field of view 404 provides lower spatial resolution imagery of portions of Earth ahead of, below, above, and behind that of the field of view 406 in relation to the orbital path of the satellite 500. Imagery associated with field of view 404 can be output to satisfy requests for image data or can be used for machine vision such as to identify or recognize areas, objects, activities, events, or features of potential interest. In certain embodiments, one or more areas, objects, features, events, activities, or the like within the field of view 404 can be used to trigger one or more computer processes, such as to configure image processor 504 associated with the first imaging unit 202 to begin monitoring for a particular area, object, feature, event, or activity. For instance, image data indicative of smoke within field of view 404 can configure processor 504 associated with the first imaging unit and field of view 406 to begin monitoring for fire or volcanic activity, even prior to such activity being within the field of view 406.

In one embodiment, the at least one second imaging unit configured to capture and process imagery of a second field of view that is proximate to and that is larger than a size of the first field of view includes, but is not limited to, at least one second imaging unit configured to capture and process ultra-high resolution imagery of a second field of view that is proximate to and that is larger than a size of the first field of view at 906. For example, the at least one second imaging unit 204 is configured to capture and process ultra-high resolution imagery of a second field of view 404 that is proximate to and that is larger than a size of the first field of view 406. While the second field of view 404 is relatively larger than the first field of view 406, the optical arrangement 512 and the image sensor 508N of the second imaging unit 204 can capture significant amounts of high resolution image data. For instance, the optical arrangement 512 may yield an approximately 42.2 by 32.1 degree subfield of the field of view 404 and the image sensor 508N can be approximately a twenty megapixel sensor. At approximately twenty frames per second, the second imaging unit 204 can capture ultra-high resolution imagery over a greater area, providing a spatial resolution of approximately one to forty meters from altitudes ranging from 400 to 700 km above Earth.

In one embodiment, the at least one second imaging unit configured to capture and process imagery of a second field of view that is proximate to and that is larger than a size of the first field of view includes, but is not limited to, at least one second imaging unit configured to capture and process video of a second field of view that is proximate to and that is larger than a size of the first field of view at 908. For example, the at least one second imaging unit 204 is configured to capture and process video of a second field of view 404 that is proximate to and that is larger than a size of the first field of view 406. Video of the second field of view 404 can be captured at range of frames per second, such as a few to tens of frames per second. Twenty-frames per second provides substantially smooth animation to the human visual system and is one possible setting. The portions of Earth covered by the field of view 404 changes due to the orbital path of the satellite 500 to which the second imaging unit 204 is included. Thus, raw video content of the field of view 404 may transition from Washington to Oregon to Idaho to Wyoming due to the orbital path of the satellite 500. Likewise, objects or features present within video content associated with field of view 404 can transition and become present within video content associated with field of view 406 or vice versa, depending upon the arrangement of the field of view 404 relative to the field of view 406 and/or the orbital path of the satellite 500. In embodiments with multiple subfields of the field of view 404 circumscribing the field of view 406, an object may transition into one subfield on one side of the field of view 404 and then into the field of view 406 and then back into another subfield of the field of view 404 on an opposing side. In certain embodiments, image content within one subfield of the field of view 404 can trigger actions, such as movement of a steerable spot imaging unit 104 to track the content through different subfields.

In one embodiment, the at least one second imaging unit configured to capture and process imagery of a second field of view that is proximate to and that is larger than a size of the first field of view includes, but is not limited to, at least one second imaging unit configured to capture and process static imagery of a second field of view that is proximate to and that is larger than a size of the first field of view at 910. For example, the at least one second imaging unit 204 is configured to capture and process static imagery of a second field of view 404 that is proximate to and that is larger than a size of the first field 406. The second imaging unit 204 can be dedicated to collection of static imagery, can be configured to extract static imagery from video content, or can be configured to capture static imagery in addition to video at alternating or staggered time periods. For example, the at least one second imaging unit 204 can extract a static image of a particular feature within field of view 404 and pass the static image to the hub processor 502. The hub processor 502 can signal one or more other image processors 504N to monitor for the particular feature in anticipation of the particular feature moving into another field of view such as field of view 406 or fisheye field of view 402. Alternatively, the particular feature can be used as the basis for pixel decimation in one or more image processors 504N, such as programming the one or more image processors 504N to decimate pixels other than that of the particular feature.

In one embodiment, the at least one second imaging unit configured to capture and process imagery of a second field of view that is proximate to and that is larger than a size of the first field of view includes, but is not limited to, at least one second imaging unit configured to capture and process visible imagery of a second field of view that is proximate to and that is larger than a size of the first field of view at 912. For example, the at least one second imaging unit 204 is configured to capture and process visible imagery of a second field of view 404 that is proximate to and that is larger than a size of the first field of view 406. Visible imagery is that associated with the visible spectrum of approximately 390 nm to 700 nm. Thus, the image sensor 508N of the second imaging unit 204 can be sensitive to wavelengths of light within the visible spectrum. Certain ones of the second imaging unit 204 and 204N can be dedicated to visible image capture or can be configured for combination infrared and visible image capture. In some embodiments, the image processor 504N is configured to trigger collection of visible image data from the image sensor 508N, versus infrared image capture, based on detection of high light levels, an orbital path position indicative of sunlight, or detection of visual ground contact unobscured by clouds.

In one embodiment, the at least one second imaging unit configured to capture and process imagery of a second field of view that is proximate to and that is larger than a size of the first field of view includes, but is not limited to, at least one second imaging unit configured to capture and process infrared imagery of a second field of view that is proximate to and that is larger than a size of the first field of view at 914. For example, at least one second imaging unit 204 is configured to capture and process infrared imagery of a second field of view 404 that is proximate to and that is larger than a size of the first field of view 406. Infrared imagery is light having a wavelength of approximately nm to 1 mm. Near-infrared imagery is light having a wavelength of approximately 0.75-1.4 micrometers. The infrared imagery can be used for night vision, thermal imaging, hyperspectral imaging, object or device tracking, meteorology, climatology, astronomy, and other similar functions. The image sensor 508N of the second imaging unit 204 can be dedicated to infrared image collection as static imagery or as video imagery. Alternatively, the image sensor 508N of the second imaging unit 204 can be configured for simultaneous capture of infrared and visible imagery through use of a beam splitter within the optical arrangement 512. Additionally, the at least one second imaging unit 204 can be configured for infrared image capture automatically upon detection of low light levels or upon detection of cloud obscuration of Earth. Thus, an object detected within the field of view 404 through use of visual image data can be continued to be tracked as the object moves below a cloud obscuration or into a nighttime area of Earth. In certain embodiments, infrared image data captured is used for object tracking and to determine a position of an object within a background scene. For instance, a user request to view video of a migration of animals may be satisfied using old non-obscured or daylight visual imagery of the animals that are moved in line with real-time or near-real time position data of the animals detected through infrared imagery.

In one embodiment, the at least one second imaging unit configured to capture and process imagery of a second field of view that is proximate to and that is larger than a size of the first field of view includes, but is not limited to, at least one second imaging unit configured to capture and perform first order processing on imagery of a second field of view that is proximate to and that is larger than a size of the first field of view prior to communication of at least some of the imagery of the second field of view to the hub processing unit at 916. For example, the at least one second imaging unit 204 is configured to capture and perform first order processing on imagery of a second field of view 404 that is proximate to and that is larger than a size of the first field of view 406 prior to communication of at least some of the imagery of the second field of view 404 to the hub processing unit 502. The image sensor 508N of the second imaging unit 204 captures significant amounts of image data through use of high resolution sensors and high frame rates, for example. However, some or most of the image data collected by the image sensor 508N may not be needed, such as because it fails to contain any feature, device, object, activity, object, event, vehicle, terrain, weather, etc. of interest or because the image data has previously been communicated and is unchanged or because the image data is simply not requested. Thus, the image processor 504N associated with the image sensor 508N can perform first order processing on the image data prior to transmission of the image data to the hub processor 502. Such first order processing can include operations such as pixel decimation (e.g., dispose up to 99.9 percent of pixel data captured), resolution reduction (e.g., remove a percentage of pixels based on a digital zoom level requested), static object or unchanged object removal (e.g., remove pixel data that has previously been transmitted and hasn't changed more than a specified percentage amount), or parallel request removal (e.g., transmit image data that overlaps with another request only once to the hub processor 502). Other first order processing operations can include color changes, compression, shading additions, or other image processing functions. Further first order processing can include machine vision or artificial intelligence operations, such as outputting binary, alphanumeric text, parameters, or executable instructions based on content present within the field of view 404. For example, the image processor 504N can obtain image data captured by the image sensor 508N. Multiple parallel operations can be performed with respect to the content within the image data, such as one application may monitor for ships and aircraft, another may detect forest fire flames or heat, and another may monitor for low pressure and weather systems. Upon detection of one or more of these items, the processor 504N can communicate pixels associated with each, GPS coordinates, and an alphanumeric description of the subject matter detected, for example. Hub processor 502 can program other image processors 504N to monitor or detect similar items in anticipation of those items being present within one or more other fields of view 402, 404, 406, or 408.

In one embodiment, the at least one second imaging unit configured to capture and process imagery of a second field of view that is proximate to and that is larger than a size of the first field of view includes, but is not limited to, at least one second imaging unit configured to capture and process imagery of a second peripheral field of view that is proximate to and that is larger than a size of the first field of view at 918. For example, the at least one second imaging unit 204 is configured to capture and process imagery of a second peripheral field of view 404 that is proximate to and that is larger than a size of the first field of view 406. Field of view 404 can be peripheral to field of view 406 in the sense that it is outside and adjacent to the field of view 406. In circumstances where field of view 404 is composed of a plurality of subfields, such as between two and tens of subfields or around six subfields, the plurality of subfields can form a perimeter around the field of view 406 with a center punch-out portion for the field of view 404 (e.g., larger in this context may mean wider but including less area due to a center void). For instance, two subfields of the field of view 404 can be arranged above the field of view 406, two subfields of the field of view 404 can be arranged below the field of view 406, and two subfields of the field of view 404 can be arranged on opposing sides of the field of view 406. Overlap between adjacent subfields can be approximately one to tens of percentage amounts or approximately five percent. Furthermore, overlap between subfields of the field of view 404 may overlap with the field of view 406, such as by one to tens of percentage amounts or approximately five percent.

In one particular embodiment, the image processor 504N associated with the field of view 404 is configured to detect motion, which may be the result of human, environmental, or geological activities, for example. Detected motion by the image processor 504N is used to trigger detection functions within the field of view 406 or movement of the steerable spot imaging units 104. In another example, a user request for an object within the field of view 404 may be satisfied by the image processor 504N using the image content of the image sensor 508N of the second imaging unit 204, until a limit is reached for zoom level. At such time, the steerable spot imaging unit 104 may be called upon to the field of view 406 to align with the object to enable additional zoom capabilities and increased spatial resolution.

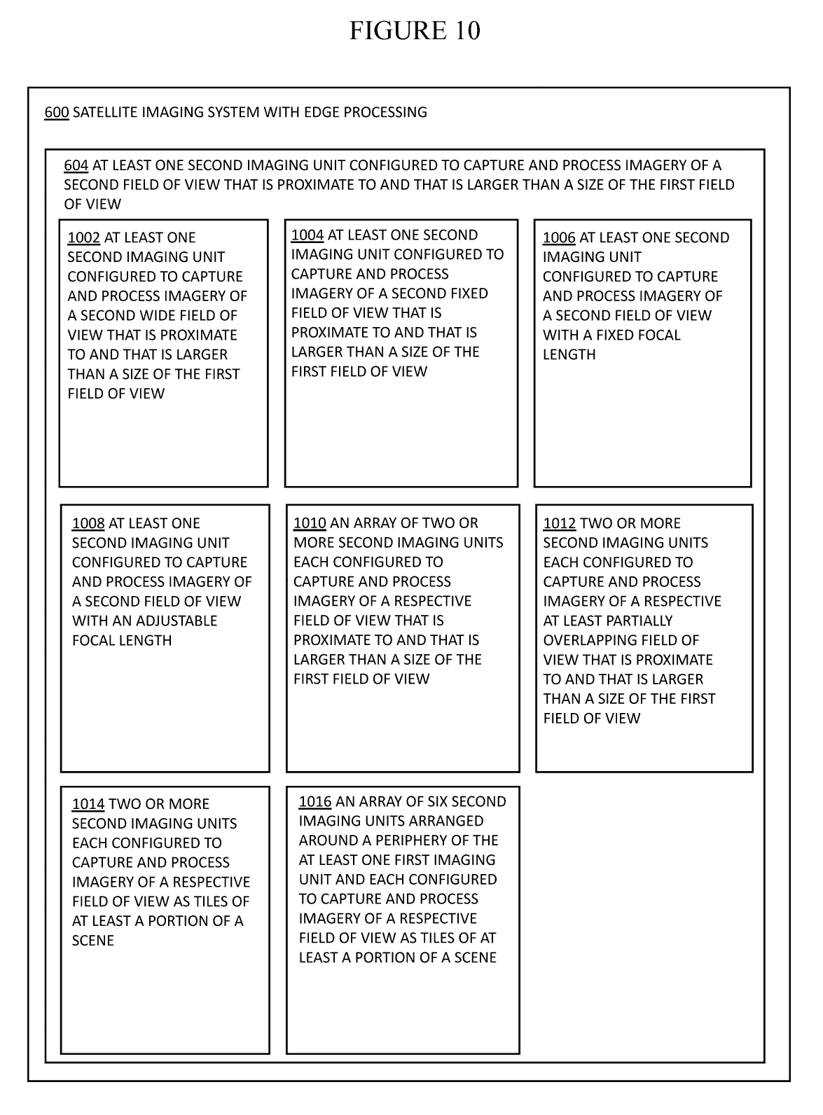

FIG. 10 is a component diagram of a satellite imaging system with edge processing, in accordance with an embodiment.

In one embodiment, the at least one second imaging unit configured to capture and process imagery of a second field of view that is proximate to and that is larger than a size of the first field of view includes, but is not limited to, at least one second imaging unit configured to capture and process imagery of a second wide field of view that is proximate to and that is larger than a size of the first field of view 1002. For example, the at least one second imaging unit 204 is configured to capture and process imagery of a second wide field of view 404 that is proximate to and that is larger than a size of the first field of view 406. The second wide field of view 404 can therefore be larger in a width or height dimension as compared to the field of view 406. For example, the second wide field of view 404 can be between approximately five to a few hundred percent larger than the field of view 406 or approximately fifty or one hundred percent of the dimensions of the field of view 406. In one particular embodiment, the field of view 404 includes dimensions of approximately ninety degrees by ninety degrees with a center portion carve out of approximately thirty by forty degrees for the field of view 406 (which can result in an overall area of field of view 404 being less than that of the field of view 406). The field of view 404 can be composed of subfields, such as approximately six subfields of view of approximately 42×32 degrees each. The field of view 406 by comparison can be composed of subfields that are narrower, such as approximately nine subfields of view of approximately 10.5×14 degrees each. In certain embodiments, field of view 404 at least partially or entirely overlaps field of view 406 (e.g., field of view 406 can be covered by field of view 404).

In one embodiment, the at least one second imaging unit configured to capture and process imagery of a second field of view that is proximate to and that is larger than a size of the first field of view includes, but is not limited to, at least one second imaging unit configured to capture and process imagery of a second fixed field of view that is proximate to and that is larger than a size of the first field of view at 1004. For example, the at least one second imaging unit 204 is configured to capture and process imagery of a second fixed field of view 404 that is proximate to and that is larger than a size of the first field 406. The optical arrangement 512 can be fixedly mounted on the outer mounting plate 208 as depicted in FIG. 2. In instances of six subfields of the field of view 404, six optical arrangements of the second imaging units 204 and 204N can be oriented as follows: bottom lens on opposing sides each oriented to capture top two subfields of field of view 404; middle lens on opposing sides each oriented to capture side subfields of field of view 404; and top lens on opposing sides each oriented to capture bottom two subfields of field of view 404. In each of these cases, the respective lens to subfield is cross-aligned such that left lens are associated with right subfields and vice versa. Other embodiments of the optical arrangements of the imaging units 204 and 204N are possible, including positioning of the lenses above, on a side, on a corner, opposing, oppositely facing, or intermixed with optical arrangements of the first imaging unit 202. While the field of view may be mechanically fixed, zoom and pan operations can be performed digitally by the image processor 504N. For instance, the optical arrangement 512 can be fixed to capture a field of view that is X wide and Y in height using the image sensor 508N. The image processor 504N can manipulate the captured image data within the X by Y envelop to digitally recreate zoom and pan effects. Additionally, the second imaging unit 204 and 204N can be repositionable or movable to change a position of a corresponding subfield of the field of view 404. Additionally, the optical arrangement 512 can be configured with an adjustable focal length and configured to pivot, slide, or rotate for panning. Movement can be accomplished by moving the optical arrangement 512 or by moving the plate 108.

In one embodiment, the at least one second imaging unit configured to capture and process imagery of a second field of view that is proximate to and that is larger than a size of the first field of view includes, but is not limited to, at least one second imaging unit configured to capture and process imagery of a second field of view with a fixed focal length at 1006. For example, the at least one second imaging unit 204 is configured to capture and process imagery of a second field of view 404 with a fixed focal length. The optical arrangement 512 can comprise a 8.0 mm focal length, high resolution infinite conjugate micro video lens. Characteristics of this lens include a field of view on ½″ sensor of 46 degrees; working distance of 400 mm to infinity; maximum resolution full field 20 percent at 160 lp/mm; distortion-diagonal at full view −10 percent; aperture f/2.5; maximum MTF listed at 160 lp/mm. Other lenses of similar characteristics can be substituted for this particular example lens.

In one embodiment, the at least one second imaging unit configured to capture and process imagery of a second field of view that is proximate to and that is larger than a size of the first field of view includes, but is not limited to, at least one second imaging unit configured to capture and process imagery of a second field of view with an adjustable focal length at 1008. In one embodiment, at least one second imaging unit 204 is configured to capture and process imagery of a second field of view 404 with an adjustable focal length. The adjustable focal length can be performed, for example, by mechanical threads that adjust a distance of one or more of the lenses of the optical arrangement 512 relative to the image sensor 508N. In instances of mechanically adjustable focal lengths, the image processor 504N can further digitally recreate additional zoom and/or pan operations within the envelope of image data captured by the image sensor 508N.

In one embodiment, the at least one second imaging unit configured to capture and process imagery of a second field of view that is proximate to and that is larger than a size of the first field of view includes, but is not limited to, an array of two or more second imaging units each configured to capture and process imagery of a respective field of view that is proximate to and that is larger than a size of the first field of view at 1010. For example, an array of two or more second imaging units 204 and 204N are each configured to capture and process imagery of a respective subfield of the field of view 404 that is proximate to and that is larger than a size of the first field of view 406. The array of two or more second imaging units 204 and 204N can include approximately two to tens or hundreds of imaging units. Optical arrangements 512 of the two or more second imaging units 204 and 204N can be oriented to form subfields of the field of view 404 that are aligned in a circle, grid, rectangle, square, triangle, line, concave, convex, cube, pyramid, sphere, oval, or other regular or irregular pattern. Further, subfields of the field of view can be layered, such as to form circles of increasing radiuses about a center. In one particular embodiment, the subfields of the field of view 404 comprise six in number and are arranged around a circumference of the field of view 406.

In one embodiment, the at least one second imaging unit configured to capture and process imagery of a second field of view that is proximate to and that is larger than a size of the first field of view includes, but is not limited to, two or more second imaging units each configured to capture and process imagery of a respective at least partially overlapping field of view that is proximate to and that is larger than a size of the first field of view at 1012. For example, the two or more second imaging units 204 and 204N are each configured to capture and process imagery of a respective at least partially overlapping subfield of the field of view 404 that is proximate to and that is larger than a size of the first field of view 406. The subfields of the field of view 404 can overlap with one another as well as with the field of view 406, spot fields of view 408, and/or fisheye field of view 402. Overlap degrees can range from approximately one to a hundred percent. In one particular example, subfields of the field of view 404 overlap by approximately 5 percent with adjacent subfields of the field of view 404. Additionally, the subfields of the field of view 404 overlap with adjacent subfields of the field of view 406 by approximately percent. Spot fields 408 can movably overlap with any of the subfields of the field of view 404 and fisheye field of view 402 can overlap subfields of the field of view 406. Overlap of subfields of the field of view 404 permit image processors 504N, associated with adjacent subfields of the field of view 404, to have access to at least some of the same imagery to enable the hub processor 502 to stitch together image content. For example, the image processor 504N can obtain image content from the bottom left subfield of the field of view 404, which includes part of an object of interest such as a hurricane cloud formation. Another image processor 504N can likewise obtain image content from a bottom right subfield of the field of view 404, including an extension of the hurricane cloud formation. Image processor 504N and the other image processor 504N each have different image content of the hurricane cloud formation with some percentage of overlap. Following any pixel reduction performed by the respective image processor 504N and the other image processor 504N, the residual image content can be communicated to the hub processor 502. The hub processor 502 can stitch the image content from the image processor 504N and the other image processor 504N to create a composite image of the hurricane cloud formation, using the overlapping portions for alignment.

In one embodiment, the at least one second imaging unit configured to capture and process imagery of a second field of view that is proximate to and that is larger than a size of the first field of view includes, but is not limited to, two or more second imaging units each configured to capture and process imagery of a respective field of view as tiles of at least a portion of a scene at 1014. Tiling of the scene 400 combined with parallel processing by an array of image processors 504 and 504N enables higher speed image processing with access to more raw image pixels. With respect to image data, the raw image data is substantially increased for the overall scene 400 by partitioning the scene 400 into tiles, such as subfields of the field of view 404. Each of the tiles is associated with an optical arrangement 512 and an image sensor 508N that captures megapixels of image data per frame with multiples of frames per second. A single image sensor can capture approximately 20 megapixels of image data at a rate of approximately 20 frames per second. This amount of image data is multiplied for each additional tile to generate significant amounts of image data, such as approximately 400 gigabytes per second per satellite 500 and approximately 30 terabytes per second or more of image data per constellation of satellites 500N. Thus, the combination of multiple tiles and multiple image sensors results in significantly more image data than would be possible with a single lens and sensor arrangement covering an entirety of the scene 400. Processing of the significant raw image data is enabled by parallel image processors 504N, which each perform operations for a specified tile of the plurality of tiles. These operations can include those referenced herein, such as image reduction, resolution reduction, object and pixel removal, previously transmitted or overlapping pixel removal, etc. and can be performed at the same time with respect to each of the tiled portions of the scene 400.

In one embodiment, the at least one second imaging unit configured to capture and process imagery of a second field of view that is proximate to and that is larger than a size of the first field of view includes, but is not limited to, an array of six second imaging units arranged around a periphery of the at least one first imaging unit and each configured to capture and process imagery of a respective field of view as tiles of at least a portion of a scene at 1016. For example, satellite 500 includes an array of six second imaging units 204 and 204N arranged around a periphery of the at least one first imaging unit 202 that are each configured to capture and process imagery of a respective subfield of the field of view 404 as six tiles of at least a portion of a scene 400 using a plurality of parallel image processors 504N.

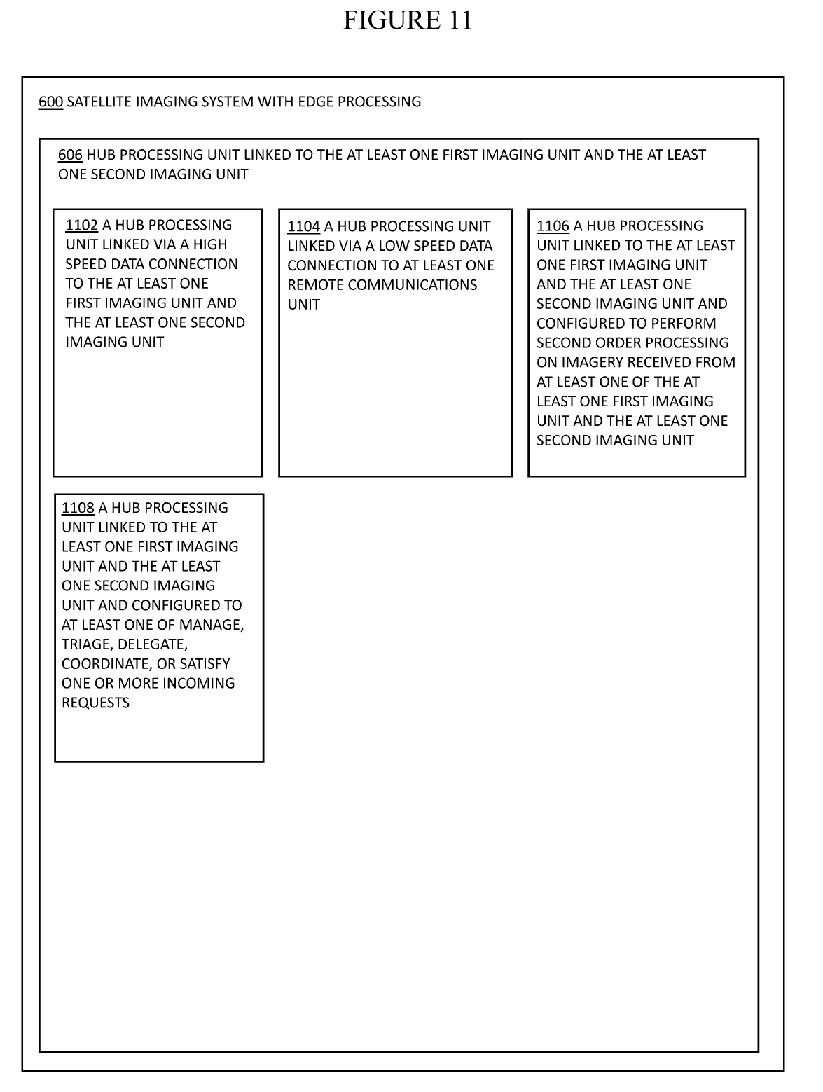

FIG. 11 is a component diagram of a satellite imaging system with edge processing, in accordance with an embodiment.

In one embodiment, the hub processing unit linked to the at least one first imaging unit and the at least one second imaging unit includes, but is not limited to, a hub processing unit linked via a high speed data connection to the at least one first imaging unit and the at least one second imaging unit at 1102. In one example, a hub processing unit 502 is linked via a high speed data connection to the image processors 504 and 504N of the at least one first imaging unit 202 and the at least one second imaging unit 204, respectively. The high speed data connection is provided by a wire or trace coupling and communications protocol. Data speeds between the hub processing unit 502 and the image processors 504 and 504N can be in the range of tens of megabytes per second through hundreds of gigabytes or more per second. For instance, data rates of approximately 10 gigabytes per second are possible with USB 3.1 and data rates of approximately 10 to a gigabyptes per second are possible with ethernet. Thus, the hub processor 502 can obtain image data provided by the image processors 504 and 504N in real-time or near real-time as capture of the image data by the image sensors 508 and 508N without substantial lag due to communications constraints.

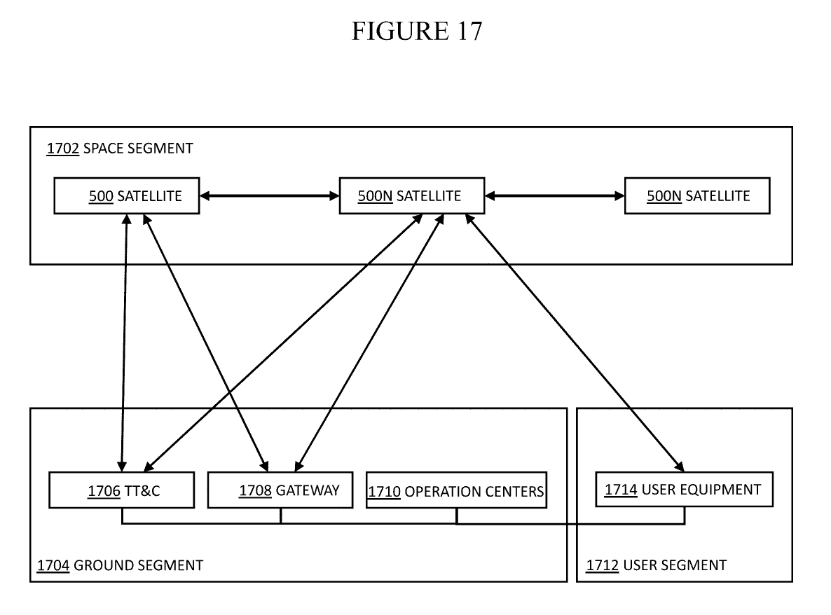

In one embodiment, the hub processing unit linked to the at least one first imaging unit and the at least one second imaging unit includes, but is not limited to, a hub processing unit linked via a low speed data connection to at least one remote communications unit at 1104. For example, the hub processing unit 502 is linked via a low speed data connection using the wireless communication interface or gateway 506 to at least one remote communications unit on the ground (FIG. 17). Low speed data connection does not necessarily mean slow in terms of user or consumer perception. Low speed data connection in the context used herein is intended to mean slower relative to the high speed data connection that exists on-board the satelite (e.g., between the hub processor 502 and the image processor 504). The wireless communication interface or gateway 506 between the satellite 500 and a ground station or another satellite 500N can use one or more of the following frequency bands: Ka-band, Ku-band, X-band, or similar. There can be one, two, or more wireless communication interfaces or gateways 506/antennas per satellite 500 (e.g., one antenna can be positioned forward and another antenna can be positioned aft relative to an orbital progression). Data bandwidth rates of the wireless communication interface or gateway 506 can range from a few kilobytes per second to hundreds of megabytes per second or even gigabytes per second. More specifically, bandwidth rates can be approiximately 200 Mbps per satellite with a burst of around two times this amount for a period of hours. The bandwidth rate of the wireless communication interface or gateway 506 to the ground stations is therefore substantially dwarfed by the image capture data rate of the satellite 500, which can in some embodiments be approximately 400 gigabytes per second. Through the image reduction operations and other edge processing operations performed on-board the satellite 500 and discussed herein, high resolution imagery can still be be transmitted over the wireless communication interface 506 despite its constraints with an average user-to-satellite latency of less than milliseconds or preferrably less than around 100 milliseconds.

In one embodiment, the hub processing unit linked to the at least one first imaging unit and the at least one second imaging unit includes, but is not limited to, a hub processing unit linked to the at least one first imaging unit and the at least one second imaging unit and configured to perform second order processing on imagery received from at least one of the at least one first imaging unit and the at least one second imaging unit at 1106. For example, the hub processing unit 502 is linked to the at least one first imaging unit 202 and the at least one second imaging unit 204 and is configured to perform second order processing on imagery received from at least one of the at least one first imaging unit 202 and the at least one second imaging unit 204. The hub processor 502 can receive constituent component parts of imagery from one or more of the at least one first imaging unit 202 and the at least one second imaging unit 204 each associated with different fields of view, such as fields of view 404 and 406, via the image processors 504 and 504N. The hub processor 502 obtains the component parts of the imagery and performs second order processing prior to communication of image data associated with the imagery via the wireless communication interface or gateway 506. For example, the second order processing can include any of the first order processing discussed and illustrated with respect to the image processor 504 or 504N. These operations include pixel decimation, resolution reduction, pixel reduction, background subtraction, unchanged area removal, previously transmitted area removal, image pre-processing, etc. Additionally or alternatively, the hub processor 502 can perform operations such as stitching of constituent image parts into a composite image, compression, and/or encoding. Stitching can involve aligning, comparison, keypoint detection, registration, calibration, compositing, and/or blending, for example, to combine two image parts into a composite image. Compression can involve reduction of image data to use fewer bits than an original representation and can include lossless data compression or lossy data compression. Encoding can involve storing information in accordance with a protocol and/or providing information on how a recipient should process data.

As an example, hub processor 502 can receive three video parts A, B, and C from three image processors 504 and 504N1 and 504N2. The three video parts A, B, and C cover content of subfields of fields of view 404 and 406, which were captured by image sensors 508 and 508N1 and 508N2. The three image processors 504 and 504N1 and 504N2 performed first order processing on the respective video parts A, B, and C in parallel to identify and retain video portions related to a major calving of an iceberg near the North Pole. The first order processing included removal of pixel data associated with unchanging ocean imagery, unchanging snow and icebergy imagery, and resolution reduction by approximately fifty percent of the remaining imagery associated with the calving itself. The hub processor 502 obtains the residual video image content A, B, and C from each of the image processors 504 and 504N1 and 504N2 and stitches the constituent parts into a composite video. The composite video is compressed and encoded for transmission as a video of the calving with few to no indications that the video was actually sourced from disparate sources. The resultant composite video of the calving is communicated via the wireless communication interface or gateway 506 within milliseconds for high resolution display on one or more ground devices (e.g., a computer, laptop, tablet or smartphone).

In one embodiment, the hub processing unit linked to the at least one first imaging unit and the at least one second imaging unit includes, but is not limited to, a hub processing unit linked to the at least one first imaging unit and the at least one second imaging unit and configured to at least one of manage, triage, delegate, coordinate, or satisfy one or more incoming requests at 1108. For example, the hub processing unit 502 is linked to the at least one first imaging unit 202 and the at least one second imaging unit 204 and is configured to at least one of manage, triage, delegate, coordinate, or satisfy one or more incoming requests received via the communication interface or gateway 506. Requests received via the communication interface or gateway 506 can include program requests or user requests from a ground station or device. Furthermore requests can be generated on-board the satellite 500 or another satellite 500N via any of the image processors 504 and 504N and/or the hub processor 502, such as by an application for performing machine vision or artificial intelligence. Requests can be for imagery associated with a particular field of view, imagery associated with a particular object, imagery associated with a GPS coordinate, imagery associated with a particular event or activity, text output, binary output, or the like. Management of the requests can include obtaining the request, determining the operations required to satisfy the request, identifying one or more of the imaging units 202, 204, 104, or 210 with access to content for satisfying the request, obtaining image data responsive to the request, generating binary or text data responsive to the request, initiating responsive processes or actions based on image or binary or text data, and/or transmitting communication data responsive to the request. Triage can include the hub processor 502 determining which of the image processors 504 and 504N have access to information required for satisfying a request. The hub processor 502 can determine the access based on queries to the image processors 504 and 504N; based on stored information regarding orbital path, GPS location, and alignment of respective fields of view; or based on image data or other information previously transmitted by the image processors 504 and 504N. Delegating can include the hub processor 502 initiating processes or actions with respect to one or more of the image processors 504 and 504N, such as initiating multiple parallel actions by a plurality of the image processors 504 and 504N. Coordinating can include the hub processor 502 serving as an intermediary between a plurality of the image processors 504 and 504N, such as transmitting information to one image processor 504N in response to information received from another image processor 504.

For example, hub processor 502 can receive a program request of an on-board machine vision application for detecting smoke or fire associated with a wildfire and determining locations of a wildfire. The hub processor 502 can transmit image recognition content to each of the image processors 504 and 504N for storage in memory. The image processors 504 and 504N perform image recognition operations in parallel using the image recognition content with respect to imagery obtained for respective fields of view, such as fields of view 404 and 406, to detect imagery associated with a wildfire. In response to detection of a wildfire by at least one of the image processors 504 and 504N, the image processors 504 and 504N perform pixel decimation, pixel reduction, and cropping operations on respective imagery to retain that which pertains to the wildfire at a specified resolution (e.g., mobile phone screen resolution). The reduced imagery is obtained by the hub processor 502 from the image processors 504 and 504N, which transmits to a recipient (e.g., natural disaster personnel) a binary indication of wildfire detection, GPS coordinate data of the wildfire, and a video of the wildfire stitched together from multiple constituent parts. Additionally, the hub processor 502 may trigger one or more other image processors 504N to begin tracking video information associated with vehicles in and around an area where the wildfire exists, which video can be used for investigative purposes.

Reference and illustration has been made to a single hub processor 502 linked with a plurality of image processors 504 and 504N. However, in certain embodiments a plurality of hub processors 502 are provided on the satellite 500, whereby each of the hub processors 502 are associated with a plurality of image processors. In this example, a hub manager processor can perform management operations with respect to the plurality of hub processors 502.

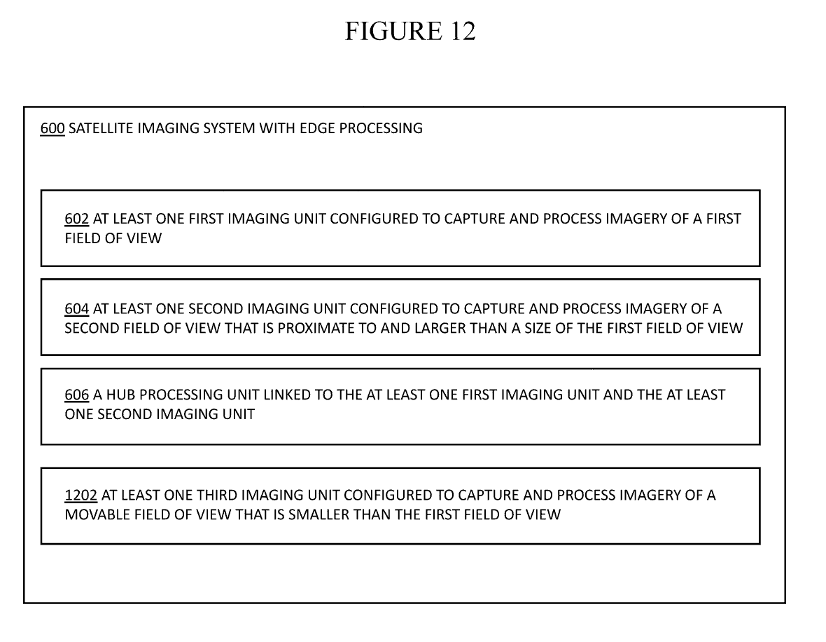

FIG. 12 is a component diagram of a satellite imaging system with edge processing, in accordance with an embodiment. In one embodiment, a satellite imaging system with edge processing 600 includes, but is not limited to, at least one first imaging unit configured to capture and process imagery of a first field of view at 602; at least one second imaging unit configured to capture and process imagery of a second field of view that is proximate to and larger than a size of the first field of view at 604; at least one third imaging unit configured to capture and process imagery of a movable field of view that is smaller than the first field of view at 1202; and a hub processing unit linked to the at least one first imaging unit and the at least one second imaging unit and the at least one third imaging unit at 606. For example, a satellite 500 includes an imaging system 100 with edge processing. The satellite imaging system 100 includes, but is not limited to, at least one first imaging unit 202 configured to capture and process imagery of a first field of view 406; at least one second imaging unit 204 configured to capture and process imagery of a second field of view 404 that is proximate to and larger than a size of the first field of view 406; at least one third imaging unit 104 configured to capture and process imagery of a movable field of view 408 that is smaller than the first field of view 406; and a hub processing unit 502 communicably linked to the at least one first imaging unit 202 and the at least one second imaging unit 204 and the at least one third imaging unit 104.

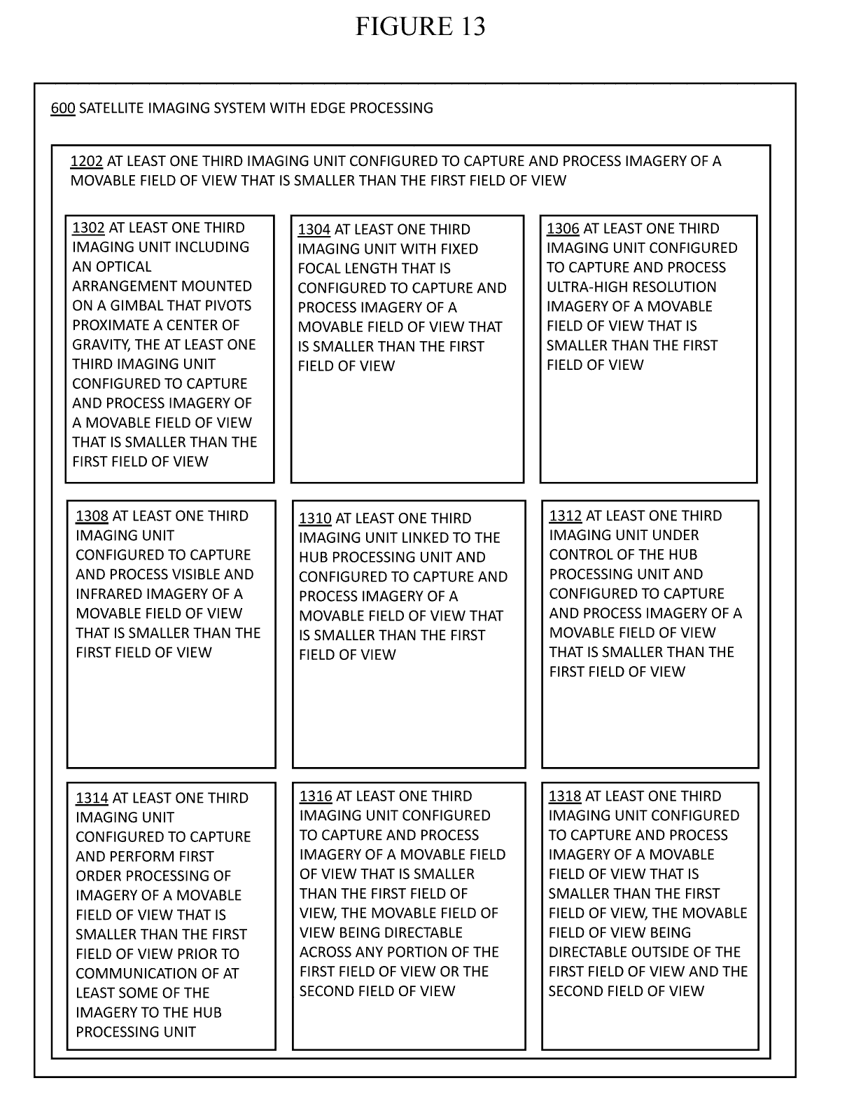

FIG. 13 is a component diagram of a satellite imaging system with edge processing, in accordance with an embodiment.

In one embodiment, the at least one third imaging unit configured to capture and process imagery of a movable field of view that is smaller than the first field of view includes, but is not limited to, at least one third imaging unit including an optical arrangement mounted on a gimbal that pivots proximate a center of gravity, the at least one third imaging unit configured to capture and process imagery of a movable field of view that is smaller than the first field of view 1302. For example, the at least one third imaging unit 104 includes an optical arrangement 514 mounted on a gimbal that pivots proximate a center of gravity. The optical arrangement 514 pivots, rotates, moves, and/or steers to adjust alignment of a field of view 408. Slew of the optical arrangement 514 can therefore result in counter-forces that may affect the stability of image capture of one or more other imaging units (e.g., another third imaging unit 104, a fourth imaging unit 210, the second imaging unit 204, or the first imaging unit 202). In this particular embodiment, a gimbal is mounted to the optical arrangement 514 near or at a center of gravity of the optical arrangement 514 to reduce counter-effects of slew.

In one embodiment, the at least one third imaging unit configured to capture and process imagery of a movable field of view that is smaller than the first field of view includes, but is not limited to, at least one third imaging unit with fixed focal length that is configured to capture and process imagery of a movable field of view that is smaller than the first field of view at 1304. For example, the at least one third imaging unit 104 includes an optical arrangement 514 with a fixed focal length that is configured to capture and process imagery of a movable field of view 408 that is smaller than the first field of view 406. In certain embodiments, a catadioptric design of the spot imager 104 can include a primary reflector 306; a secondary reflector 308; three meniscus singlets as refractive elements 310 positioned within a lens barrel 312; a beamsplitter cube 314 to split visible and infrared channels; a visible image sensor 316; and an infrared image sensor 318. The primary reflector 306 and the secondary reflector 308 can include mirrors of Zerodur or CCZ; a coating of aluminum having approximately 10A RMS surface roughness; a mirror substrate thickness to diameter ratio of approximately 1:8. The dimensions of the steerable spot imager 104 include an approximately 114 mm tall optic that is approximately 134 mm in diameter across the primary reflector 306 and approximately 45 mm in diameter across the secondary reflector 308. Characteristics of the steerable spot imager 104 can include temperature stability; low mass (e.g., approximately 1 kg of mass); few to no moving internal parts; and positioning of the image sensors within the optical arrangement 514.

Many other steerable spot imager 104 configurations are possible, including a number of all-refractive type lens arrangements. For instance, one possible spot imager 104 achieving less than approximately 3 m spatial resolution at 500 km orbit includes a 209.2 mm focal length, a 97 mm opening lens height; a 242 mm lens track; less than F/2.16; spherical and aspherical lenses of approximately 1.3 kg; and a beam splitter for a 450 nm-650 nm visible channel and an 800 nm to 900 nm infrared channel.

Another steerable spot imager 104 configuration includes a 165 mm focal length; F/1.7; 2.64 degree diagonal object space; 7.61 mm diagonal image; 450-650 nm waveband; fixed focus; limited diffraction; and anomalous-dispersion glasses. Potential lens designs include a 9-element all-spherical design with a 230 mm track and a 100 mm lens opening height; a 9-element all-spherical design with 1 triplet and a 201 mm track with a 100 mm lens opening height; and an 8-element design with 1 asphere and a 201 mm track with a 100 mm lens opening height. Other steerable spot imager 104 configurations can include any of the following lens or lens equivalents having focal lengths of approximately 135 mm to 200 mm: OLYMPUS ZUIKO; SONY SONNAR T*; CANON EF; ZEISS SONNAR T*; ZEISS MILVUS; NIKON DC-NIKKOR; NIKON AF-S NIKKOR; SIGMA HSM DG ART LENS; ROKINON 135M-N; ROKINON 135M-P, or the like.

In one embodiment, the at least one third imaging unit configured to capture and process imagery of a movable field of view that is smaller than the first field of view includes, but is not limited to, at least one third imaging unit configured to capture and process ultra-high resolution imagery of a movable field of view that is smaller than the first field of view at 1306. For example, the at least one third imaging unit 104 is configured to capture and process ultra-high resolution imagery of a movable field of view that is smaller than the first field of view 406. The field of view 408 is movable and steerable in certain embodiments anywhere throughout the fisheye 402 field of view, the outer field of view 404, and/or the inner field of view 406. In some embodiments, the field of view 408 is additionally movable outside the fisheye field of view 402. In embodiments with additional third imaging units 104, a plurality of fields of view 408 are independently movable and/or overlappable within and/or outside any of the fisheye field of view 402, the outer field of view 404, and the inner field of view 406. The field of view 408 is smaller in size that the field of views 406, 402, and 404 and, in one particular embodiment, corresponds to an approximate area of coverage of a 20 kilometer diagonal portion of Earth at an approximately 4:3 aspect ratio and yields an approximate spatial resolution of 1-3 meters.

In certain embodiments, the third imaging unit 104 is programmed to respond to objects, features, activities, events, or the like detected within one or more other fields of view 408, 406, 404, and/or 402. Alternatively and/or additionally, the third imaging unit 104 is programmed to respond to one or more user requests or program requests for panning and/or alignment. In certain cases, the third imaging unit 104 responds to client or program instructions for alignment, but in an event no client or program instructions are received reverts to automated alignment on detected objects, events, features, activities, or the like within field of view 400. In one particular embodiment, the spot field of view 408 dwells on a particular target constantly as the satellite 500 progresses in its orbital path, thereby creating multiple frames of video of the target. Small movements of the third imaging unit 104 are automatically made to accomplish the fixation despite satellite 500 orbital movement.

For example, a ballistic missile launch can be detected within the fisheye field of view 402 by an image processor 504N. Hub processor 502 can then control image processor 504N1 to hone the third imaging unit 104 and the spot field of view 408 on the ballistic missile. Updated tracking information from the image processor 504N can be provided as ongoing feedback to the image processor 504N1 to control movement of the third imaging unit 104 and the spot field of view 408.

In one embodiment, the at least one third imaging unit configured to capture and process imagery of a movable field of view that is smaller than the first field of view includes, but is not limited to, at least one third imaging unit configured to capture and process visible and infrared imagery of a movable field of view that is smaller than the first field of view at 1308. For example, the at least one third imaging unit 104 is configured to capture and process visible and infrared imagery of a movable field of view that is smaller than the first field of view 406. Visible imagery is that light reflected off of Earth, weather, or that emitted from objects or devices on Earth, for example, that is within the visible spectrum of approximately 390 nm to 700 nm. Visible imagery of the spot field of view 408 can include content such as video and/or static imagery obtained using the third imaging unit 104 as the satellite 500 progresses through its orbital path and the third imaging units 104 is moved within its envelope (e.g., plus or minus 70 degrees). Thus, visible imagery can include a video of any specific areas within the outskirts of Bellevue to Bremerton in Washington via Mercer Island, Lake Washington, Seattle, Puget Sound, following the path of the satellite 500. This visible imagery can therefore include a momentary or dwelled focus on terrain (e.g., Mercer Island), traffic (e.g., 520 bridge), cityscape (e.g., Queen Anne Hill), people (e.g., a protest march downtown Seattle), aircraft (e.g., planes on approach to or taxing at Boeing Field Airport), boats (e.g., cargo ships within Puget Sound and Elliot Bay), and weather (e.g., clouds at convergence zone near Everett, Wash.) at spatial resolutions of approximately one to three meters.

Infrared imagery is light having a wavelength of approximately 700 nm to 1 mm. Near-infrared imagery is light having a wavelength of approximately 0.75-1.4 micrometers. The infrared imagery can be used for night vision, thermal imaging, hyperspectral imaging, object or device tracking, meteorology, climatology, astronomy, and other similar functions. For example, infrared imagery of the third imaging unit 104 can includes scenes of Earth experiencing nighttime (e.g., when the satellite 500 is on a side of the Earth opposite the Sun). Alternatively, infrared imagery of the third imaging unit 104 can include scenes of Earth experiencing cloud coverage. In certain embodiments, the infrared imagery and visible imagery are captured simultaneously by the third imaging unit 104 using a beam splitter. In other embodiments, the third imaging unit 104 is configured to capture infrared imagery of the field of view 408 that overlaps a particular other field of view (e.g., field of view 404) having visible imagery captured or vice versa to enable combination infrared and visible imagery capture.

In one embodiment, the at least one third imaging unit configured to capture and process imagery of a movable field of view that is smaller than the first field of view includes, but is not limited to, at least one third imaging unit linked to the hub processing unit and configured to capture and process imagery of a movable field of view that is smaller than the first field of view at 1310. For example, the at least one third imaging unit 104 is linked to the hub processing unit 502 via an image processor 504N and is configured to capture and process imagery of a movable field of view 408 that is smaller than the first field of view 406. The hub processor 502 can provide instructions to the image processor 504N of the third imaging unit 104 to capture imagery of particular objects, events, activities, or the like. Alternatively, hub processor 502 can provide instructions to the image processor 504N of the third imaging unit 104 to capture imagery associated with a particular GPS coordinate or geographic location. Hub processor 502 can also provide instructions or requests based on image content detected using one or more of the other imaging units (e.g., first imaging unit 202, second imaging unit 204, fourth imaging unit 210, or third imaging unit 104N). Hub processor 502 can also receive and perform second order processing on image content or data provided by an image processor 504N associated with the third imaging unit 104.

As an example, hub processor 502 can request of the plurality of third imaging units 104 and 104N a scan of the field of view 400 for a missing vessel. The third imaging units 104 and 104N can execute systematic scans of the field of view 400, such as each scanning a particular area repetitively using the fields of view 408. Image processors 504N and 504N1 can process the image data obtained from the image sensors 508N of each of the third imaging units 104 in parallel in an attempt to identify an object or feature indicative of the missing vessel. The hub processor 502 can receive the GPS coordinates of the missing vessel along with select imagery of the missing vessel from the image processor 504N associated with the third imaging unit 104N that identified the missing vessel.

In one embodiment, the at least one third imaging unit configured to capture and process imagery of a movable field of view that is smaller than the first field of view includes, but is not limited to, at least one third imaging unit under control of the hub processing unit and configured to capture and process imagery of a movable field of view that is smaller than the first field of view at 1312. For example, the at least one third imaging unit 104 is under control of the hub processing unit 502 and is configured to capture and process imagery of a movable field of view 408 that is smaller than the first field of view 406. The hub processing unit 502 can provide actuation signals directly or indirectly to the gimbal 110 of the third imaging unit 104 to control alignment of the field of view 408. Alternatively, the hub processing unit 502 can provide varying levels of instruction to a control unit of the gimbal 110 (or an independent actuation control unit) to direct alignment of the field of view 408. The various levels of instruction include, for example, a coordinate, an area, or a pattern, which can be reduced by the control unit of the gimbal 110 to precisce parameter values for directing one or more motors of the gimbal 110. Control of actuation of the third imaging unit 104 can also be provided by a processor physically independent of the third imaging unit 104 and the hub processor 502 or by the image processor 504N.

In certain embodiments, a movement coordination control unit is provided for concerted control of a plurality of the third imaging unit 104 and/or the third imaging unit 104N. For example, the movement coordination control unit can determine the actuation position of each of the third imaging units 104 and 104N to determine whether actuation of one particular third imaging unit 104 would result in crashing with respect to an adjacent third imaging unit 104 (e.g., adjacent imaging units 104 and 104N pointed at each other resulting in lens crashing). In an event of lens crashing appears likely, the movement coordination control unit can identify another of the third imaging units 104N available for actuation. The movement coordination control unit can therefore avoid physical conflict between the third imaging units 104 and 104N thereby enabling a smaller footprint of the imaging system 100. Another operation of the movement coordination control unit can include movement balancing among the plurality of third imaging units 104 and 104N in an effort to cancel out motion as much as possible (e.g., movement to left and movement to right provided by select third imaging units 104 and 104N to cancel motion forces).

In one embodiment, the at least one third imaging unit configured to capture and process imagery of a movable field of view that is smaller than the first field of view includes, but is not limited to, at least one third imaging unit configured to capture and perform first order processing of imagery of a movable field of view that is smaller than the first field of view prior to communication of at least some of the imagery to the hub processing unit at 1314. For example, the at least one third imaging unit 104 is configured to capture and perform using the image processor 504N first order processing of imagery of a movable field of view 408 that is smaller than the first field of view 406 prior to communication of at least some of the imagery to the hub processing unit 502. The third imaging unit 104 captures ultra high resolution imagery of a small spot field of view 408. The ultra-high resolution imagery can be video on the order of 20 megapixels per frame and 20 frames per second, or more. However, not all of the ultra-high resolution imagery of the spot field of view 408 may be needed or required. Accordingly, the image processor 504N of the third imaging unit 104 can perform first order reduction operations on the imagery prior to communication to the hub processor 502. Reduction operations can include those such as pixel decimation, resolution reduction, cropping, static or background object removal, un-selected area removal, unchanged area removal, previously transmitted area removal, parallel request consolidation, or the like.

For example, in an instance where a high-zoom area is requested within the overall spot view 408 (e.g., the lower right portion of the spot view 408 comprising only a few percentage of the overall area of the spot view 408), pixel cropping can be performed by the image processor 504N to remove all pixel data outside the area requested. Pixel decimation can be avoided within the remaining high-zoom area requested to preserve as much pixel data as possible. Additionally, the image processor 504N can perform pixel decimation involving uninteresting objects within the high-zoom area requested, such as removing background or non-moving objects. Additionally, image processor 504N can remove pixels that are not requested or that correspond to pixel data previously transmitted and/or that is unchanged since a previous transmission. For example, a close-up image of a highway and moving vehicles can involve the image processor 504N of the third imaging unit 104 removing pixel data associated with the highway that was previously communicated in an earlier frame, is unchanged, and that does not contain any moving vehicles (e.g., all road surface pixel data).

In certain embodiments, the image processor 504N performs machine vision or artificial intelligence operations on the image data of the field of view 408. For instance, the image processor 504N can perform image or object or feature or pattern recognition with respect to the image data of the field of view 408. Upon detecting a particular aspect, the image processor 504N can output binary data, text data, program executables, or a parameter. An example of this in operation includes the image processor 504N detecting a presence of a whale breach within the field of view 408. Output of the image processor 504N may include GPS coordinates and a count increment, which can be used by environmentalists and government agencies to track whale migration and population, without necessarily requiring transmission of any image data.

In one embodiment, the at least one third imaging unit configured to capture and process imagery of a movable field of view that is smaller than the first field of view includes, but is not limited to, at least one third imaging unit configured to capture and process imagery of a movable field of view that is smaller than the first field of view, the movable field of view being directable across any portion of the first field of view or the second field of view at 1316. For example, the at least one third imaging unit 104 is configured to capture and process imagery of a movable field of view 408 that is smaller than the first field of view 406, the movable field of view 408 being directable across any portion of the first field of view 406, the second field of view 404, or the fourth field of view 402. The third imaging unit 104 is substantially unconstrained (e.g., +/−70 degree×degrees articulation envelop) and is directable on an as needed basis to move and align the field of view 408 where requested and/or needed. The field of view 408 offers enhanced spatial resolution and acuity and can be used for increased discrimination of areas, objects, features, events, activities, or the like.

For example, a user request for a global scene view can be satisfied by the first imaging unit 202 or the second imaging unit 204 or even the fourth imaging unit 210 without burdening the spot imaging unit 104. However, a user request for imagery associated with a particular building, geographical feature, or address can be satisfied by the spot field of view 408 and the third imaging unit 104 given the ultra high spatial resolution and acuity offered by the third imaging unit 104. As another example, a user request for a particular cityscape can be satisfied by the field of view 404 and the second imaging unit 204 at one moment, but not possible over time due to the orbital path of the satellite 500. In this instance, spot field of view 408 can be controlled to track the particular cityscape as it moves beyond the field of view 404. An additional operation of the spot field of view 408 and the third imaging unit 104 is to enhance the resolution of the image data obtained using another imaging unit (e.g., the first imaging unit 202). For instance, parking lots can be enhanced in image data obtained using the first imaging unit 202 using image data obtained using the third imaging unit 104, to enable vehicle counting and determining shopping trends for example.

In one embodiment, the at least one third imaging unit configured to capture and process imagery of a movable field of view that is smaller than the first field of view includes, but is not limited to, at least one third imaging unit configured to capture and process imagery of a movable field of view that is smaller than the first field of view, the movable field of view being directable outside of the first field of view and the second field of view at 1318. For example, the at least one third imaging unit 104 is configured to capture and process imagery of a movable field of view 408 that is smaller than the first field of view 406, the movable field of view 408 being directable outside of the first field of view 406 and the second field of view 404. As referenced above, spot field of view 408 is substantially unconstrained and can travel within a substantial entirety of the field of view 400 (e.g., plus or minus 70 degrees×360 degrees of motion). Imagery captured by the fourth imaging unit 210 associated with the fisheye field of view 402 can be relatively low in spatial resolution as compared to that captured by the third imaging unit 104 associated with the field of view 408. Accordingly, fisheye field of view 402 is useful for providing overall big picture scene information, context, and motion detection, but may not enable the acuity, spatial resolution, and zoom levels required. Accordingly, spot field of view 408 can be used to supplement the fisheye field of view 402 when additional acuity or resolution is needed or requested.

As an example, infrared image content captured by the fourth imaging unit 210 covering the fisheye field of view 402 can indicate severe temperature gradations over a particular geographical area. The third imaging unit 104 can be directed to the particular geographical area to sample video content associated with the spot field of view 408. Image processor 504N can obtain the video content and process the video content using feature, object, pattern, or image recognition to determine the source and/or effects of the temperature gradation (e.g., a wildfire, a hurricane, an explosion, etc.). Image processor 504N can then return a binary or textual indication of the cause and/or reduced imagery associated with the cause.

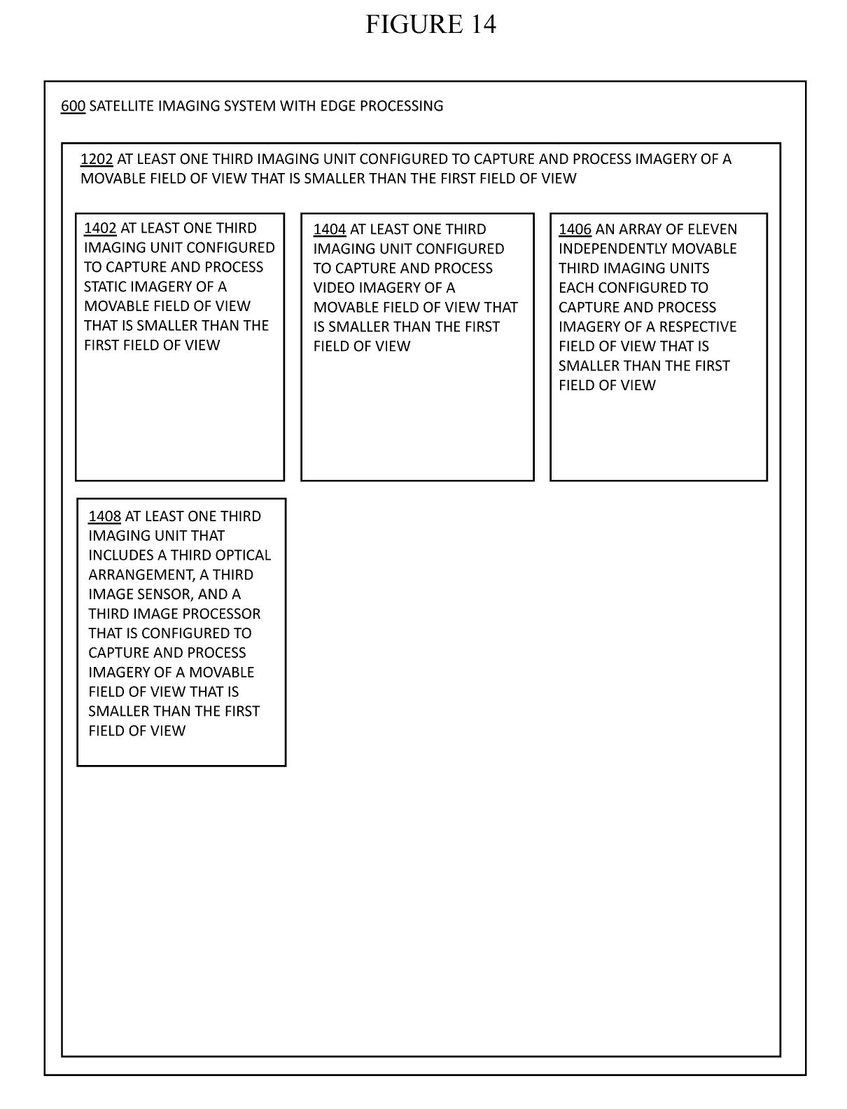

FIG. 14 is a component diagram of a satellite imaging system with edge processing, in accordance with an embodiment.

In one embodiment, the at least one third imaging unit configured to capture and process imagery of a movable field of view that is smaller than the first field of view includes, but is not limited to, at least one third imaging unit configured to capture and process static imagery of a movable field of view that is smaller than the first field of view at 1402. For example, the at least one third imaging unit 104 is configured to capture and process static imagery of a movable field of view 408 that is smaller than the first field of view 406. The at least one third imaging unit 104 can capture static imagery in response to a program command, a user request, or a hub processor 502 request, such as in response to one or more objects, features, events, activities, or the like detected within one or more other fields of view (e.g., field of view 402, 404, or 406). Static imagery can include a still visible and/or infrared or near-infrared images. Additionally, static imagery can include a collection of still visible and/or infrared or near-infrared images. For example, image processor 504 can detect one or more instances of crop drought or infestation using video imagery captured by the first imaging unit 202 and corresponding to the field of view 406. Hub processor 502 can then instruct the third imaging unit 104 to steer to and/or align the field of view 408 on the area of crop drought or infestation. Third imaging unit 104 can capture one or more still images of the crop drought or infestation and the image processor 504N can perform first order processing on the one or more still images and/or determine an assessment of the damage. As another example, the at least one third imaging unit 104 can capture one or more still images of a city or other structure over the course of the satellite 500 orbit. The one or more still images will have different vantage points of the city or other structure and can be used to recreate a high spatial resolution three-dimensional image of the city or other structure.

In one embodiment, the at least one third imaging unit configured to capture and process imagery of a movable field of view that is smaller than the first field of view includes, but is not limited to, at least one third imaging unit configured to capture and process video imagery of a movable field of view that is smaller than the first field of view at 1404. For example, the at least one third imaging unit 104 is configured to capture and process video imagery of a movable field of view 408 that is smaller than the first field of view 406. The third imaging unit 104 can capture video at approximately one to sixty frames per second or approximately twenty frames per second. The third imaging unit 104 can capture video of a fixed field of view 408 or can capture video of a moving field of view 408 using one or more pivots, joints, or other articulations such as gimbal 110. The moving field of view 408 enables tracking of moving content and also enables dwelling on fixed content, albeit at different vantage points due to orbital transgression of the satellite 500.

In one embodiment, the at least one third imaging unit configured to capture and process imagery of a movable field of view that is smaller than the first field of view includes, but is not limited to, an array of eleven independently movable third imaging units each configured to capture and process imagery of a respective field of view that is smaller than the first field of view at 1406. For example, the array of eleven independently movable third imaging units 104 and 104N are each configured to capture and process imagery of a respective field of view that is smaller than the first field of view 406. The array of eleven independently movable third imaging units 104 and 104N can be arranged in a 3×3 grid of active third imaging units 104 and 104N1-N8 with two additional non-active backup third imaging units 104N9 and 104N10 flanking the global imaging array 102. Each of the independently movable third imaging units 104 and 104N1-N10 can pivot with a range of motion of approximately 360 degrees in an X plane and approximately 180 degrees in a Y plane. In one particular embodiment, the Y plane movement is constrained to approximately +/−70 degrees. Spacing of the independently movable third imaging units 104 and 104N1-N10 can be such that the range of motion envelopes do not overlap or partially overlap. Partial overlap of the motion envelopes enables a smaller footprint of the imaging system 500 but has the potential for adjacent ones of the movable third imaging units 104 and 104N1-N10 to crash or physically touch. Proximity sensing at the third imaging units 104 and 104N1-N10 or coordinated motion control of each of the independently movable third imaging units 104 and 104N1-N10 (e.g., using proximity sensors or a reservation or occupation table) can be implemented to prevent crashing. Although reference is made to eleven of the third imaging units 104 and 104N1-N10, in practice other amounts are possible. For instance, the third imaging units 104 and 104N can range from zero to tens or even hundreds in amount. Additionally, the third imaging units 104 and 104N1-N10 can be arranged in a line, circle, square, rectangle, triangle, or other regular or irregular pattern. The third imaging units 104 and 104N1-N10 can also be arranged on opposing faces (e.g., to capture images of earth and outerspace) or in cube, pyramid, sphere, or other regular or irregular two or three-dimensional form.

In one embodiment, the at least one third imaging unit configured to capture and process imagery of a movable field of view that is smaller than the first field of view includes, but is not limited to, at least one third imaging unit that includes a third optical arrangement, a third image sensor, and a third image processor that is configured to capture and process imagery of a movable field of view that is smaller than the first field of view at 1408. For example, the at least one third imaging unit 104 includes a third optical arrangement 516, a third image sensor 508N, and a third image processor 504N that is configured to capture and process imagery of a movable field of view 408 that is smaller than the first field of view 406. The third image processor 504N can process raw ultra-high resolution imagery associated with the field of view 408 in real-time or near-real-time independent of image data associated with one or more of the other fields of view (e.g., fields of view 402, 404, and 406). Processing operations can include machine vision, artificial intelligence, resolution reduction, image recognition, object recognition, feature recognition, activity recognition, event recognition, text recognition, pixel decimation, pixel cropping, parallel request reductions, background subtraction, unchanged or previously communicated image decimation, or the like. Output of the image processor 504 can include image data, binary data, alphanumeric text data, parameter values, control signals, function calls, application initiation, or other data or function.

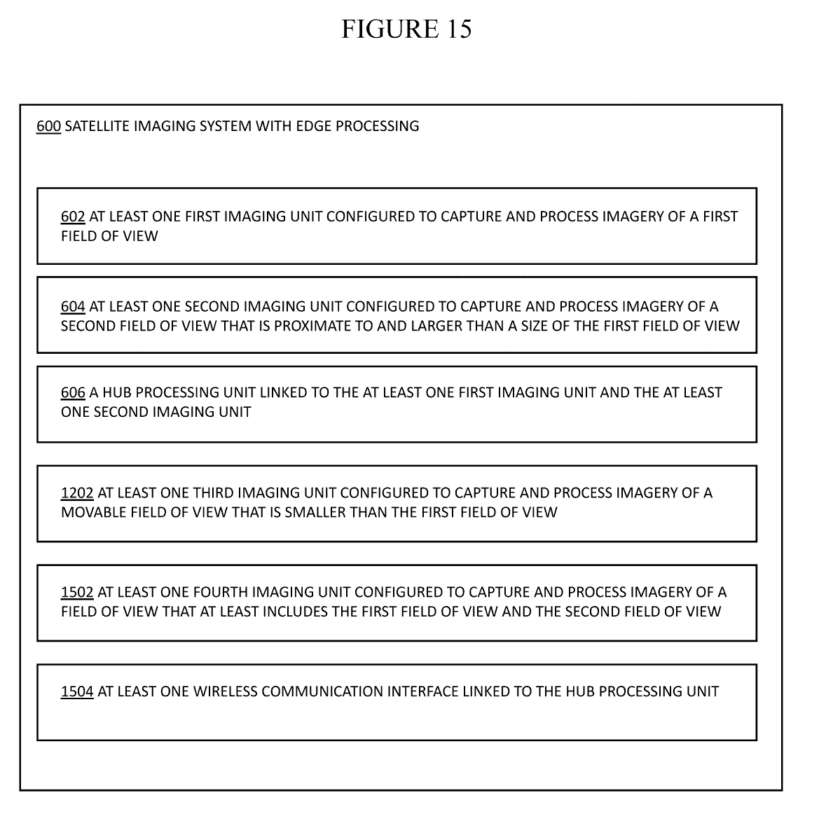

FIG. 15 is a component diagram of a satellite imaging system with edge processing, in accordance with an embodiment. In one embodiment, a satellite imaging system with edge processing 600 includes, but is not limited to, at least one first imaging unit configured to capture and process imagery of a first field of view at 602; at least one second imaging unit configured to capture and process imagery of a second field of view that is proximate to and larger than a size of the first field of view at 604; at least one third imaging unit configured to capture and process imagery of a movable field of view that is smaller than the first field of view at 1202; at least one fourth imaging unit configured to capture and process imagery of a field of view that at least includes the first field of view and the second field of view at 1502; a hub processing unit linked to the at least one first imaging unit, the at least one second imaging unit, the at least one third imaging unit and the at least one fourth imaging unit at 606; and at least one wireless communication interface linked to the hub processing unit at 1504. For example, a satellite imaging system 100 with edge processing includes, but is not limited to, at least one first imaging unit 202 configured to capture and process imagery of a first field of view 406; at least one second imaging unit 204 configured to capture and process imagery of a second field of view 404 that is proximate to and larger than a size of the first field of view 406; at least one third imaging unit 104 configured to capture and process imagery of a movable field of view 408 that is smaller than the first field of view 406; at least one fourth imaging unit 210 configured to capture and process imagery of a field of view 402 that at least includes the first field of view 406 and the second field of view 404; a hub processing unit 502 linked to the at least one first imaging unit 202, the at least one second imaging unit 204, the at least one third imaging unit 104, and the at least one fourth imaging unit 210; and at least one wireless communication interface 506 linked to the hub processing unit 502.

The fisheye imaging unit 210 provides a super wide field of view for an overall scene view 402. There can be one, two, or more of the fisheye imaging unit 210 per satellite 500. The fisheye imaging unit includes an optical arrangement 516 that includes a lens, image sensor 508N (infrared and/or visible), and an image processor 504N, which may be dedicated or part of a pool of available image processors (FIG. 5). The lens can comprise a ½ Format C-Mount Fisheye Lens with a 1.4 mm focal length from EDMUND OPTICS. This particular lens has the following characteristics: focal length 1.4; maximum sensor format ½″, field of view for ½″ sensor 185×185 degrees; working distance of 100 mm-infinity; aperture f/1.4-f/16; maximum diameter 56.5 mm; length 52.2 mm; weight 140 g; mount C; type fixed focal length; and RoHS C. Other lenses of similar characteristics can be substituted for this particular example lens.

The field of view 402 can span approximately 180 degrees in diameter to provide an overall scene view of Earth from horizon to horizon and that overlaps spot field of view 408, inner field of view 406, and outer field of view 404. Spatial resolution can be approximately 25 meters to 100 meters from 400-700 km altitude (e.g., 50 meter spatial resolution). The field of view 402 therefore includes areas of Earth in front of, behind, above, and below the field of view 406 and the field of view 404 and includes areas overlapping with the field of view 406 and field of view 404. During an orbital path of the satellite 500, therefore, portions of Earth will first appear in the fisheye field of view 402 before moving through the outer field of view 404 and the inner field of view 406. Likewise, portions of the Earth will leave through the fisheye field of view 402 of the satellite 500. The fourth imaging unit 210 can therefore capture video, still, and/or infrared imagery that can be used for change detection, movement detection, object detection, event or activity identification, or for overall scene context. Content of the fisheye field of view 402 can trigger actuation of the third imaging unit 104 or initiate machine vision or artificial intelligence processes of one or more of the image processors 504N associated with one or more of the first imaging unit 202, second imaging unit 204, and/or third imaging unit 104; or of the hub processor 502.

For example, the fourth imaging unit 210 can detect ocean discoloration present in imagery associated with the fisheye field of view 402, which may be caused by oil spillage or leakage, organisms, or the like. The detection of the discoloration can be performed locally using the image processor 504N associated with the fourth imaging unit 210 and can include comparisons with historical image data obtained by satellite 500 or another satellite 500N. Spot imaging units 104 can be called to align with the ocean discoloration and can collect ultra-high resolution video and infrared imagery. Image processors 504N associated with the spot imaging units 104 can perform image recognition processes on the imagery to further determine a cause and/or source of the ocean discoloration. Additionally, image processors 504N associated with the first imaging unit 202 and the second imaging unit 204 can have processes initiated associated with spillage detection and recognition in advance of the ocean discoloration coming into the field of view 406 and 404.

FIG. 16 is a perspective view of a satellite constellation 1600 of an array of satellites that each include a satellite imaging system, in accordance with an embodiment. For example, satellite constellation 1600 includes an array of satellites 500 and 500N that each include a satellite imaging system 100 to provide substantially constant real-time “fly-over” video of Earth.

Each satellite 500 and 500N can be equipped with the satellite imaging system 100 to continuously collect and process approximately 400 Gbps or more of image data. The satellite constellation 1600 in its entirety can therefore collect and process approximately 30 Tbps or more of image data (e.g., approximately 20 frames per second using image sensors of approximately 20 megapixels). Processing power for each of the satellites 500 and 500N can be approximately 20 teraflops and processing power for the satellite constellation 1600 can be approximately 2 petaflops.

Satellite constellation 1600 can include anywhere from 1 to approximately or more satellites 500 and 500N. For instance, the satellites 500 and 500N can range in number from 84 to 252 with spares of approximately 2 to 7.

Satellite constellation 1600 can be at anywhere between approximately 55 to 65 degrees inclination and at anywhere between approximately 400-700 km altitude. One specific inclination range is between 60 to 65 degrees relative to the equator. A dog-leg maneuver with NEW GLENN can be used for higher angles of inclination (e.g., 65 degrees). A more specific altitude range can include 550 km to 600 km above Earth.

Satellite constellation 1600 can include anywhere from approximately 1 to 33 planes with anywhere from one to sixty satellites 500 and 500N per plane. Satellite constellation 1600 can include a sufficient number of satellites to provide substantially complete temporal coverage (e.g., 70 percent of the time or more) for elevation angles of degrees, 20 degrees, and 30 degrees above the horizon on positions of Earth between approximately +/−75 degrees N/S latitudes. In one embodiment, the satellite constellation includes at least two satellites 500 and 500N above the horizon (e.g., above 15 degrees elevation) substantially all times (e.g., 70 percent of the time or more) at positions on Earth between approximately +/−70 degrees North and South latitudes. Additionally, the satellite constellation 1600 can include at least one satellite 500N above approximately 30 degrees elevation at substantially all times (e.g., 70 percent of the time or more), which can limit spot view imaging unit 210 slew amounts to less than approximately 45-50 degrees from nadir. Further, the satellite constellation 1600 can include at least one satellite 500N above approximately 40 degrees elevation at substantially all times (e.g., 70 percent of the time or more), which can improve live 3D video capabilities and limit spot view imaging unit 210 slew amounts to less than approximately 30 degrees from nadir.

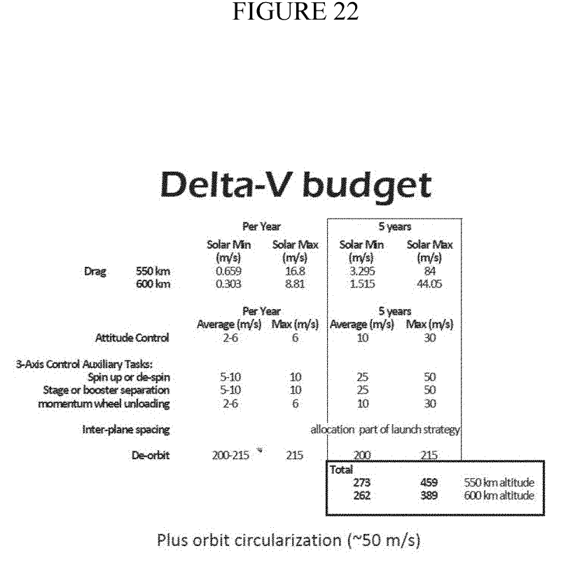

Satellite constellation 1600 can be launched using one or more of the following options: FALCON 9 (around 40 satellites per launch); NEW GLENN (around 66 satellites per launch); ARIANE 6; SOYUZ; or the like. The satellite constellation 1600 can be launched in large clusters into a Hohmann transfer orbit followed by sequenced orbit raising. One possible Delta-V budget that can be used as part of the launch strategy is included in FIG. 22.

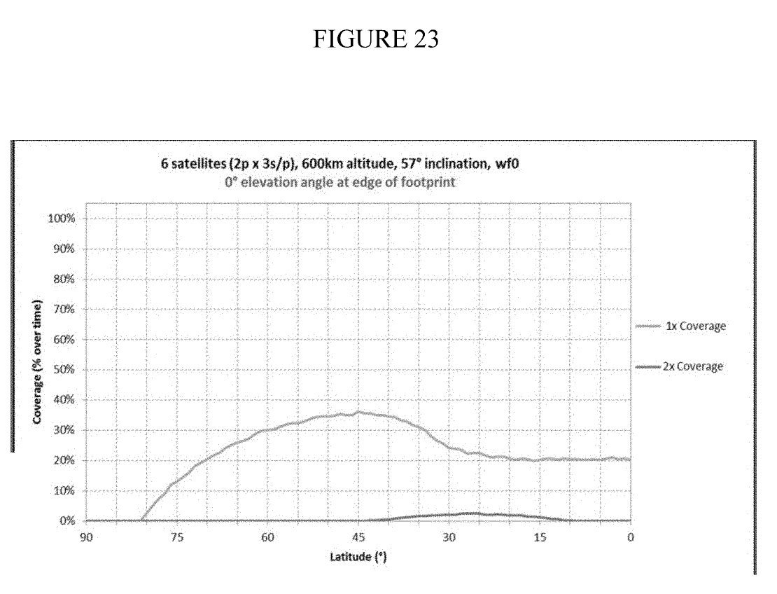

A number of specific satellite constellation 1600 configurations are possible. One particular configuration includes 6 satellites 500 and 500N1-N5 within 2 planes of 3 satellites/plane at 600 km altitude and 57 degrees inclination and a Walker Factor of 0. The amount of coverage of this satellite configuration is provided in FIG. 23.

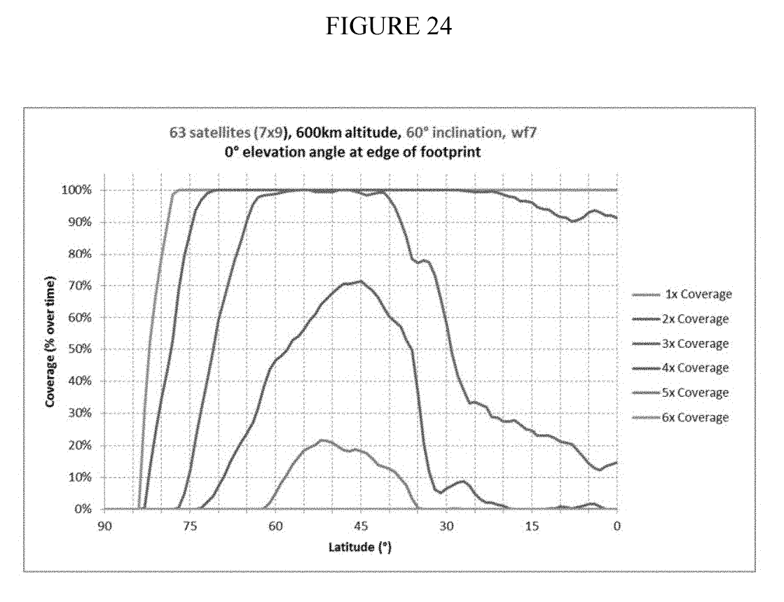

Another particular configuration includes 63 satellites 500 and 500N1-N62 within 7 planes of 9 satellites/plane at 600 km altitude and 60 degrees inclination and a Walker Factor of 7. The amount of coverage of this satellite configuration is provided in FIG. 24.

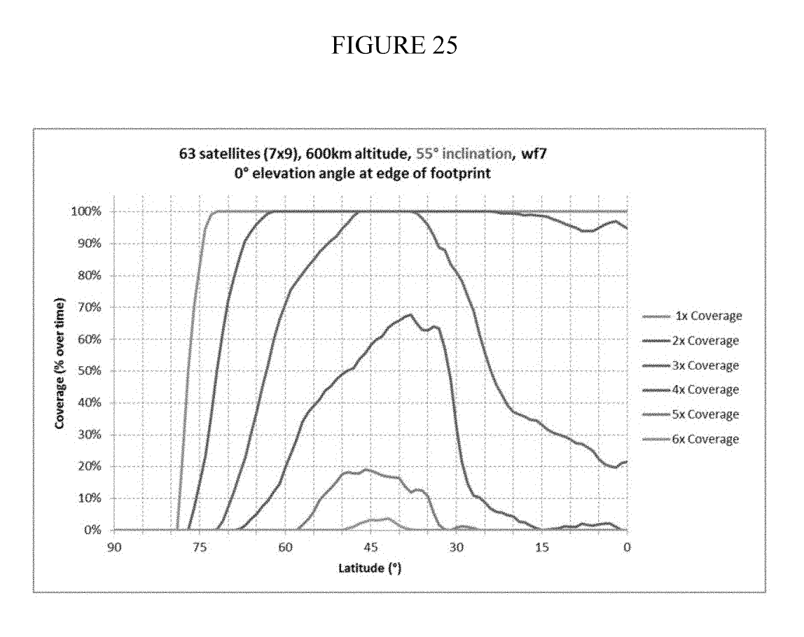

Another particular configuration includes 63 satellites 500 and 500N1-N62 within 7 planes of 9 satellites/plane at 600 km altitude and 55 degrees inclination and a Walker Factor of 7. The amount of coverage of this satellite configuration is provided in FIG. 25.

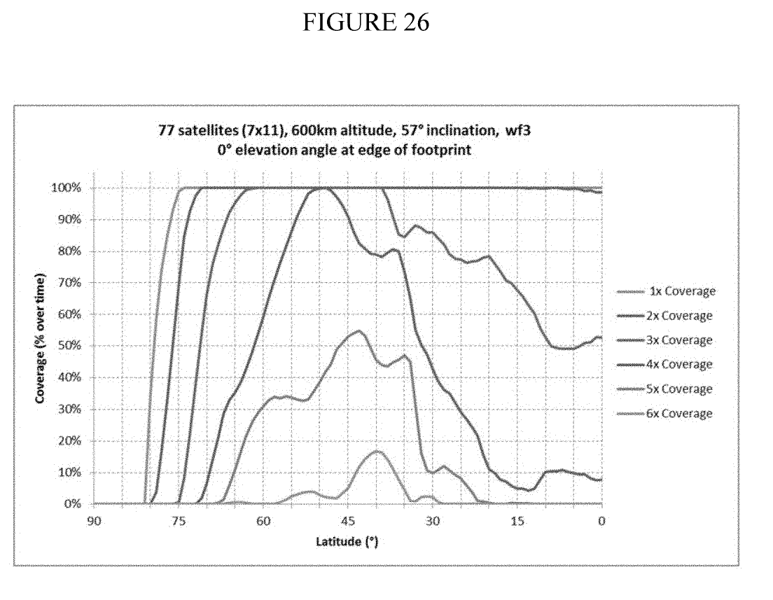

Another particular configuration includes 77 satellites 500 and 500N1-N76 within 7 planes of 11 satellites/plane at 600 km altitude and 57 degrees inclination and a Walker Factor of 3. Approximately 7 spare satellites may be included. The amount of coverage of this satellite configuration is provided in FIG. 26.

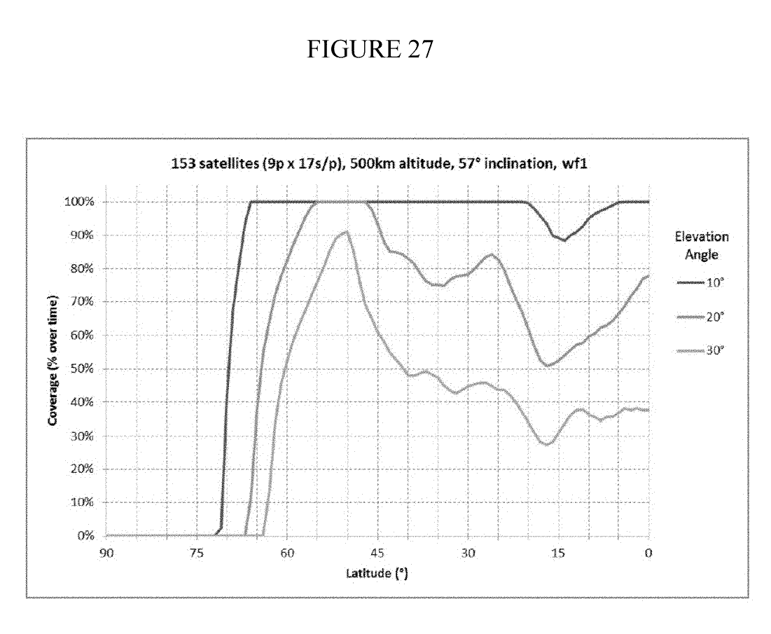

Another particular configuration includes 153 satellites 500 and 500N1-N152 within 9 planes of 17 satellites/plane at 500 km altitude and 57 degrees inclination. The amount of coverage of this satellite configuration is provided in FIG. 27.

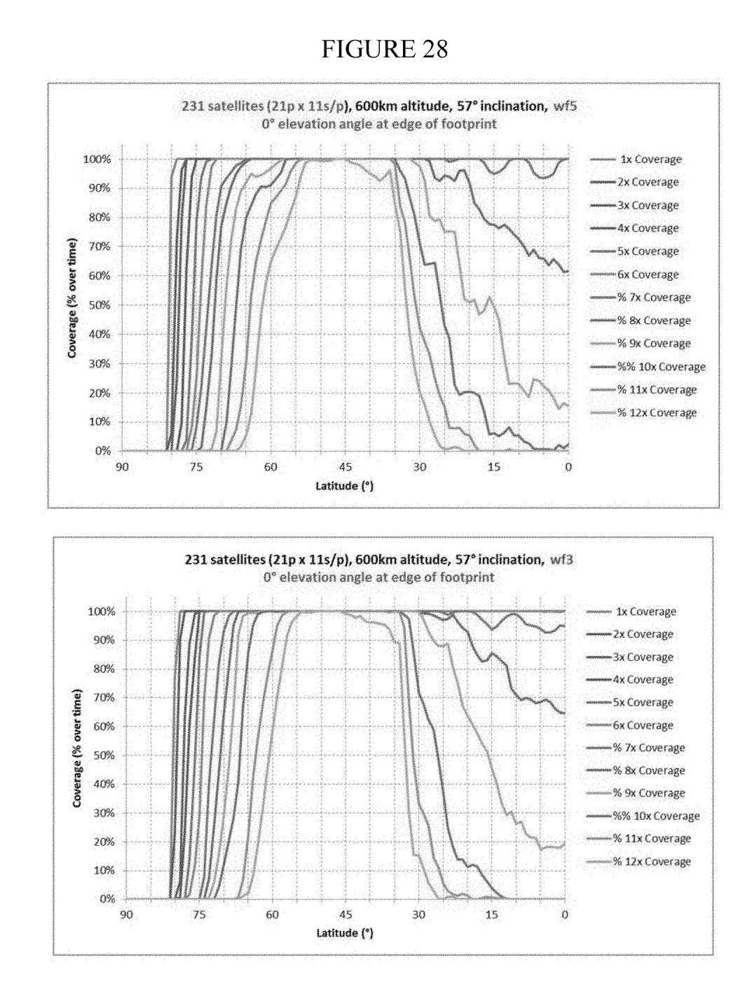

Another particular configuration includes 231 satellites 500 and 500N1-N230 within 21 planes of 11 satellites/plane at 600 km altitude and 57 degrees inclination. Approximately 21 spare satellites can be included and Walker Factors can range from 3 to 5. The amount of coverage of these satellite configurations is provided in FIGS. 28-31.

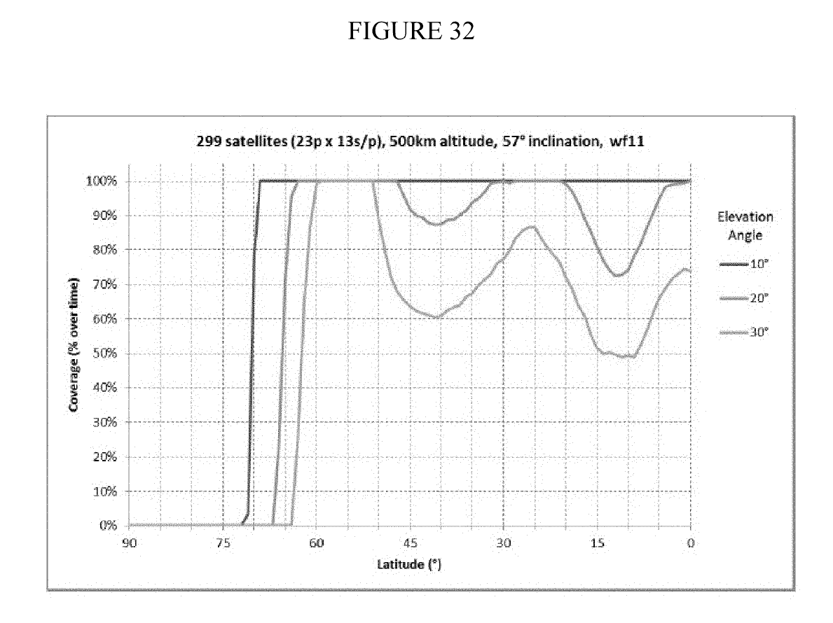

Another particular configuration includes 299 satellites 500 and 500N1-N298 within 23 planes of 13 satellites/plane at 500 km altitude and 57 degrees inclination. The amount of coverage of this satellite configuration is provided in FIG. 32.

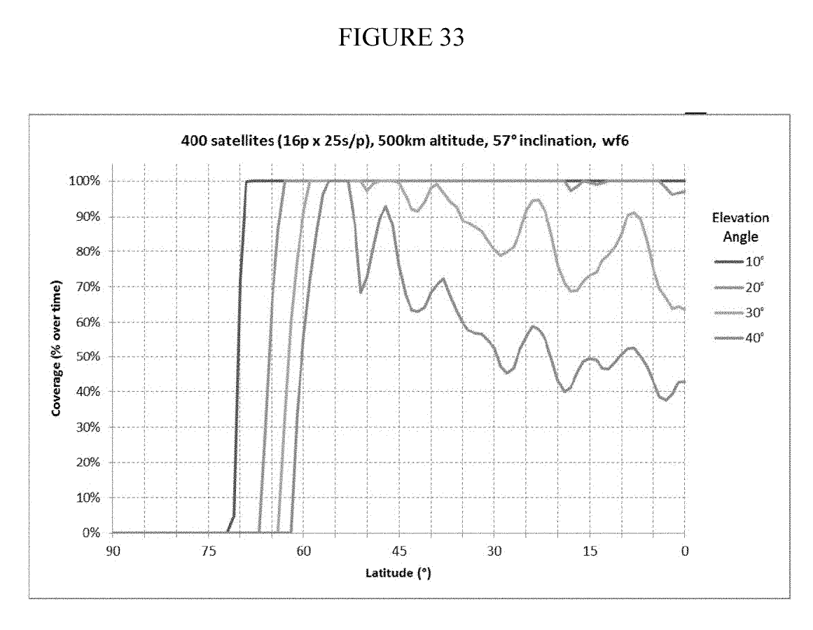

Another particular configuration includes 400 satellites 500 and 500N1-N399 within 16 planes of 25 satellites/plane at 500 km altitude and 57 degrees inclination. The amount of coverage of this satellite configuration is provided in FIG. 33.

The satellite constellation orbital altitude can range from low to medium to high altitudes, such as between 160 km to approximately 2000 km or more. Orbits can be circular or elliptical or the like.

FIG. 17 is a diagram of a communications system 1700 involving the satellite constellation 1600, in accordance with an embodiment. In one embodiment, communications system 1700 includes a space segment 1702, a ground segment 1704, and a user segment 1712. Space segment 1702 includes the satellite constellation 1600 comprised of satellites 500 and 500N. The ground segment 1704 includes TT&C 1706, gateway 1708, and an operation center 1710. The user segment 1712 includes user equipment 1714.

The satellites 500 and 500N can communicate directly between each other via an inter-satellite link (ISL). The TT&C 1706, the gateway 1708, and the user equipment 1714 can each communicate with the satellites 500 and 500N. The TT&C 1706, the gateway 1708, the operations center 1710, and the user equipment 1714 can also communicate with one another via a private and/or public network. The TT&C 1706 provides an interface to telemetry data and commanding. The gateway 1708 provides an interface between satellites 500 and 500N and the ground segment 1704 and the user segment 1712. The operations center 1710 provides satellite, network, mission, and/or business operation functions. User equipment 1714 may be part of the user segment 1712 or the ground segment 1704 and can include equipment for accessing satellite services (e.g., tablet computer, smartphone, wearable device, virtual reality goggles, etc.). The satellites 500 and 500N provide communication, imaging capabilities, on-board processing, on-board switching, sufficient power to meet mission objectives, and/or other features and/or applications. In certain embodiments, any of the TT&C 1706, gateway 1708, operation center 1710, and user equipment 1714 can be consolidated in whole or in part into integrated systems. Additionally, any of the specific responsibilities or subsystems of the TT&C 1706, gateway 1708, operation center 1710, and user equipment can be distributed or separated into disparate systems.

TT&C 1706 (Tracking, Telemetry & Control) includes the following responsibilities: ground to satellite secured communications, carrier tracking, command reception and detection, telemetry modulation and transmission, ranging, receive commands from command and data handling subsystems, provide health and status information, perform mission sequence operations, and the like. Interfaces of the TT&C 1706 include one or more of a satellite operations system, an altitude determination and control, command and data handling, electrical power, propulsion, thermal—structural, payload, or other related interfaces.

Gateway 1708 can include one or more of the following responsibilities: receive and transmit communications radio frequency signals to/from satellites 500 and 500N, provide an interconnect between the satellite segment 1702 and the ground segment 1704, provide ground processing of received data before transmitting back to the satellite and to user equipment 1714, and other related responsibilities. Subsystems and components of the gateway 1708 can include one or more of a satellite antenna, receive RF equipment, transmit RF equipment, station control center, internet/private network equipment, COMSEC/network security, TT&C equipment, facility infrastructure, data processing and control capabilities, and/or other related subsystems or components.

The operation center 1710 can include a data center, a satellite operation center, a network center, and/or a mission center. The data center can include a system infrastructure, servers, workstations, cloud services, or the like. The data center can include one or more of the following responsibilities: monitor system and servers, system performance management, configuration control and management, system utilization and account management, system software updates, service/application software updates, data integrity assurance, data access security management and control, data policy management, or related responsibility. The data center can include data storage, which can be centralized, distributed, cloud-based, or scalable. The data center can provide data retention and archivable for short, medium, or long term purposes. The data center can also include redundancy, load-balancing, real-time fail-over, data segmentation, data security, or other related features or functionality.

The satellite operation center can include one or more of the following responsibilities: verify and maintain satellite health, reconfigure and command satellites, detect and identify and resolve anomalies, perform launch and early orbit operations, perform deorbit operations, coordinate mission operations, coordinate the constellation 1600, or other related management operations with respect to launch and early orbit, commissioning, routine/normal operation, and/or disposal of satellites. Additional satellite operations include one or more of access availability to each satellite for telemetry, command, and control; integrated satellite management and control; data analysis such as historical and comparative analyses about subsystems within a satellite 500 and throughout the constellation 1600; storage of telemetry and anomaly data for each satellite 500; provide defined telemetry and status information; or related operations. Note that the satellite bus of satellite 500 can include subsystems including command and data handling, communications system, electrical power, propulsion, thermal control, altitude control, guidance navigation and control, or related subsystems.

The network operations center can include one or more of the following responsibilities with respect to the satellite and terrestrial network: network monitoring; problem or issue response and resolution; configuration management and control; network system performance and reporting; network and system utilization and accounting; network services management; security (e.g., firewall and instruction protection management, antivirus and malware scanning and remediation, threat analysis, policy management, etc.); failure analysis and resolution; or related operations.

The mission center can include one or more of the following responsibilities: oversight, management, decision making; reconciling and prioritizing payload demands with bus resources; provide linkage between business operations demands and capabilities and capacity; planning and allocating resources for mission; managing tasking and usage and service level performance; verifying and maintaining payload health; reconfiguring and commanding payload; determining optimal attitude control; or related operation. The mission center can include one or more of the following subsystems: payload management and control system; payload health monitoring system; satellite operations interface; service request/tasking interface; configuration management system; service level statistics and management; or related system.

Connectivity and communications support for satellites 500, TT&C 1706, gateway 1708, and operation center(s) 1710 can be provided by a network. The network can include space-based and terrestrial networks and can provide support for both mission and operations. The network can include multiple routes and providers and enable incremental growth for increased demand. Network security can include link encryption, access control, application security, behavioral analytics, intrusion detection and prevention, segmentation, or related security features. The network can further include disaster recovery, dynamic environment and route management, component selection, or other related features.

User equipment 1714 can include computers and interfaces, such as a mobile phone, smart phone, laptop computer, desktop computer, server, tablet computer, wearable device, or other device. User equipment 1714 can be connected to the ground segment via the Internet or private network.

In one particular embodiment, the satellites 500 and 500N are configured for inter-satellite links or communication. The satellite 500 can include two communication antennas with one pointing forward and the other pointing aft. One antenna can be dedicated to transmit operations and the other antenna can be dedicated to receive operations. Another satellite 500N in the same orbital plane can be a dedicated satellite-to-ground conduit and can be configured to receive and transmit communications to and from the satellite 500 and to and from the gateway 1708. Thus, in instances where a plurality of satellites 500 and 500N are within a single orbital plane, one or more satellites 500N can be a designated conduit and the other satellite 500 can transmit and receive communications to and from the gateway 1708 via the designated conduit satellite 500N. Communications can hop between satellites within an orbital plane until a dedicated conduit gateway satellite 500N is reached, which conduit gateway satellite 500N can route the communications to the gateway 1708 in the ground segment 1704. A constellation 1600 of satellites can include as many as approximately 30 to 60 dedicated conduit gateway satellites 500N. In certain embodiments, there can be cross-link communications between satellites 500 and 500N in different orbital planes. In other embodiments, there are no cross-links and inter-satellite links are confined to within a same orbital path. In this instance a flat and low mass holographic antenna can be used that does not require beam steering. In certain embodiments, the conduit gateway satellite 500N can communicate with the gateway 1708 upon passing over the gateway 1708. Space-to-ground communications can include use of Ka-band; Ku-band; Q/V-band; X-band; or the like and can enable approximately 200 Mbps of bandwidth with bursts of approximately two times this amount for a period of hours and enable average latency of less than approximately 100-250 milliseconds. Higher ultra-high capacity data links can be used to enable at least approximately 1-5 Gbps bandwidth.

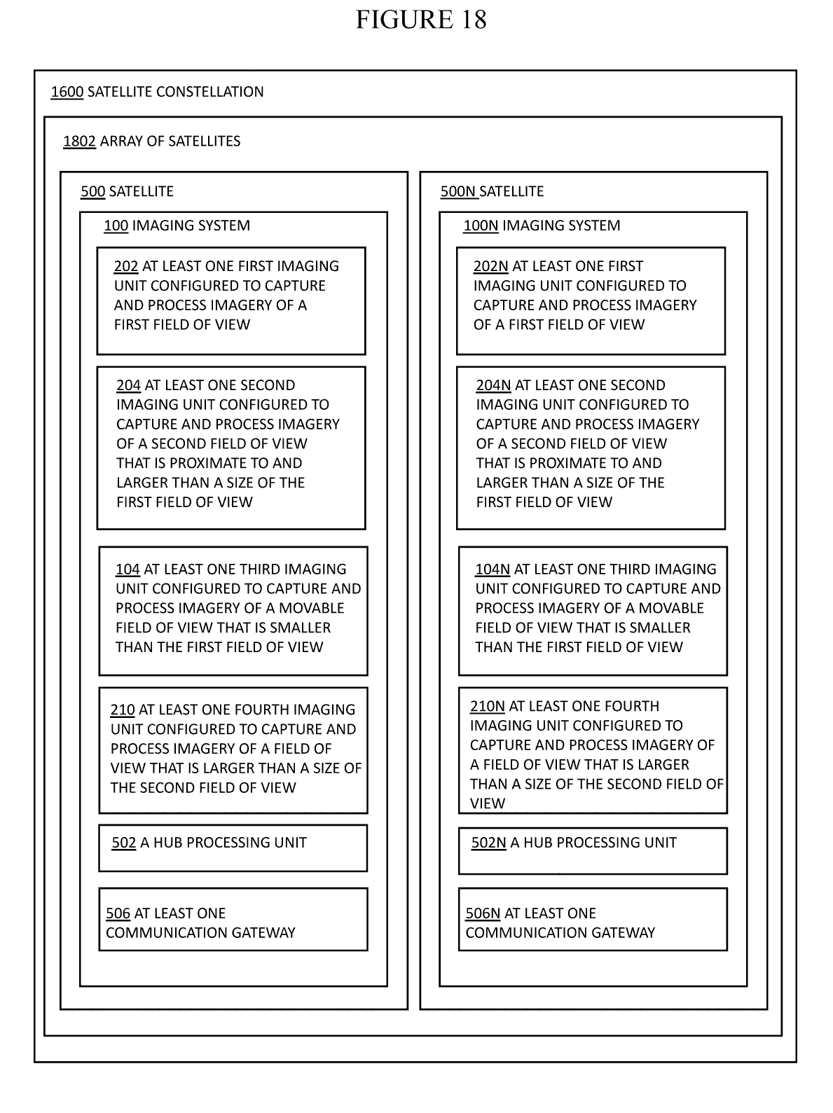

FIG. 18 is a component diagram of a satellite constellation 1600 of an array of satellites that each include a satellite imaging system, in accordance with an embodiment. In one embodiment, a satellite constellation 1600 includes, but is not limited to, an array 1802 of satellites 500 and 500N that each include a satellite imaging system 100 and 100N including at least: at least one first imaging unit 202 configured to capture and process imagery of a first field of view 406; at least one second imaging unit 204 configured to capture and process imagery of a second field of view 404 that is proximate to and that is larger than a size of the first field of view 406; at least one third imaging unit 104 configured to capture and process imagery of a movable field of view 408 that is smaller than the first field of view 406; at least one fourth imaging unit 210 configured to capture and process imagery of a field of view 402 that is larger than a size of the second field of view 404; a hub processing unit 502; and at least one communication gateway 506.

The satellites 500 and 500N of the satellite constellation 1600 are arranged in an orbital configuration that can be defined by: altitude, angle of inclination, number of planes, number of satellites per plane, number of spares, phase between adjacent planes, and other relevant factors. For example, one satellite constellation 1600 configuration can include 400 satellites 500 and 500N1-N399 within 16 planes at 57 degrees of inclination with 25 satellites per plane at 500 km altitude. Other configurations are possible and have been discussed and illustrated herein.

Each of the satellites 500 and 500N of the satellite constellation 1600 include an array of imaging units (e.g., imaging units 202, 204, 104, and/or 210) that each include optical arrangements and image sensors (FIG. 5) for capturing high resolution imagery associated with field of view 400. Image processors 500 and 504N (FIG. 5) are configured to perform parallel image processing operations on captured imagery associated with the array of imaging units. Thus, each satellite 500 and 500N is configured to obtain high resolution imagery associated with a respective field of view 400, which field of view 400 is tiled into a plurality of fields of view (e.g., fields of view 402, 404, 406), which plurality of fields of view are tiled into subfields thereof (FIG. 4). The satellite constellation 1600 can therefore be configured to capture and process high resolution fly-over video imagery of substantially all portions of Earth in real-time using on-board parallel image processing of high resolution imagery associated with tens, hundreds, or even thousands of tiles of fields and subfields of view. Depending on the satellite constellation 1600 configuration implemented, there can be overlap in some fields of view 402, 404, 406, and subfields thereof between adjacent or proximate satellites 500 and 500N. For example, fisheye field of view 402 of satellite 500 can at least partially overlap with fisheye field of view 402 of adjacent satellite 500N. The satellite constellation and the constituent satellites 500 and 500N can work in concert to provide real-time video, still images, and/or infrared images of high resolution on an as-needed and as-requested basis for satellite-based applications (e.g., machine vision or artificial intelligence) and to user equipment 1714.

For example, sources of imagery can transition from one satellite 500 to another satellite 500N based on orbital path position and/or elevation above the horizon. For instance, a user device 1714 can output a video of a particular city over the course of a day, which video can be captured by a plurality of satellites 500 and 500N throughout the orbital progression. Beginning at an angle of elevation above the horizon of approximately degrees, satellite 500 can function as the initial source of the video imagery of the city. As satellite 500 moves to approximately less than 15 degrees of the opposing horizon, the source of the video imagery can transition to satellite 500N which has risen or is positioned more than approximately 15 degrees of the horizon.

As another example, handoffs between sources of imagery can be made to track moving objects, events, activities, or features. For example, satellite 500 can serve as a source of imagery associated with a particular fast moving aircraft being tracked by a flight security application on-board at least one of the satellites 500 and 500N. As the aircraft moves within the field of view 400 of the satellite 500 and transitions to an edge of the field of view 400, the source of the imagery associated with the aircraft can transition to a second satellite 500N and its respective field of view 400. This type of transition can occur between satellites 500 and 500N within a same orbital plane or within adjacent orbital planes.

As another example, a source of imagery being output on user equipment can seamlessly jump from one satellite 500 to another satellite 500N based on requested information. For example, a user device 1714 can output imagery associated with a hurricane off the coast of Florida that is sourced from a satellite 500. In response to a user request for any shipping vessels that may be affected by the hurricane, satellite 500N1 can identify and detect shipping vessels within a specified distance of the hurricane and serve as the source of real-time video imagery of those vessels for output via the user equipment 1714. Another satellite 500N2 can additionally serve as the source of real-time imagery associated with flooding detected on coastal sections of Florida with on-board processing.

A further example includes a machine vision application that is hosted on one satellite 500. The machine vision application can perform real-time or near-real-time image data analysis and can obtain the imagery for processing from the satellite 500 as well as from another satellite 500N via inter-satellite communication links. For example, satellite 500 can host a machine vision application for identifying locations and durations of traffic congestion and capturing imagery associated with the same. Satellite 500 can perform these operations with respect to imagery obtained within its associated field of view 400, but can also perform these operations with respect to imagery obtained from another satellite 500N. Alternatively, machine vision applications can be distributed among one or more of the satellites 500 and 500N for the image recognition and first order processing to reduce communication bandwidth of imagery between satellites 500 and 500N.

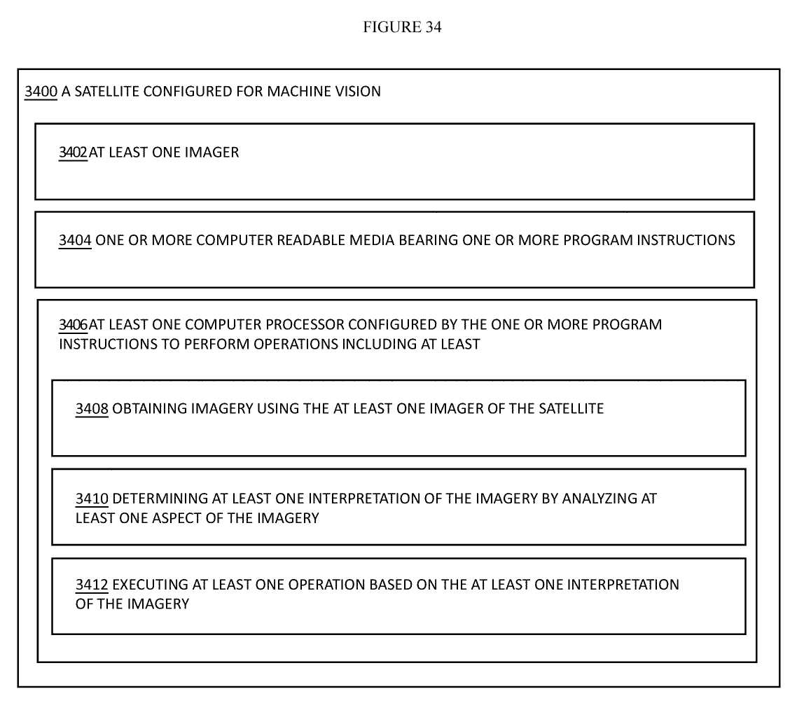

FIG. 34 is a component diagram of a satellite with machine vision, in accordance with an embodiment. In one embodiment, a satellite configured for machine vision 3400 includes, but is not limited to, at least one imager 3402; one or more computer readable media 3404 bearing one or more program instructions; and at least one computer processor 3406 configured by the one or more program instructions to perform operations including at least: obtaining imagery using the at least one imager of the satellite at 3408; determining at least one interpretation of the imagery by analyzing at least one aspect of the imagery at 3410; and executing at least one operation based on the at least one interpretation of the imagery at 3412.

The satellite configured for machine vision 3400 can include the satellite imaging system 100 and can include any of the components and/or can be configured to perform any of the operations illustrated and/or described with respect to FIGS. 1-33. For instance, the satellite configured for machine vision 3400 can include the steerable spot imagers 104 and the global imaging array 102. The global imaging array can include the outer imaging unit 204, the inner imaging unit 202, and the fisheye imaging unit 210. Additionally, the satellite configured for machine vision 3400 and its associated imaging units can provide the outer cone field of view 404, the inner cone field of view 406, the spot cone field of view 408, and the fisheye field of view 402. Furthermore, the satellite configured for machine vision 3400 can include an array of imaging units (e.g., 202, 204, 104, 210, 202N, 204N, 104N, and/or 210N), wherein each of the array of imaging units can include an optical arrangement, an image sensor, and an image processor (e.g., 510, 508, and 504). A plurality of image processors can be linked to a hub processor 502, for providing distributed processing of pixel data.

The satellite configured for machine vision 3400 provides intelligent vision or artificial intelligence or related functionality at the level of the satellite 500 or at the level of image processors 504 or 504BN within the satellite 500. Interpretive operations and/or executive operations are provided that can go beyond merely image capture and communication to enable local decision making and action without necessarily requiring transfer of image data. Configuration of the satellite 3400 can include obtaining imagery using the at least one imager at 3408, determining at least one interpretation of the imagery by analyzing at least one aspect of the imagery at 3410, and executing at least one operation based on the at least one interpretation of the imagery at 3412.

Applications and embodiments of the satellite configured for machine vision 3400 are described and illustrated further herein. Some of which can include, for example, monitoring for disasters and notifying personnel or dispatching resources; detecting environmental, geological, or migration events and recording scientific data or transmitting high resolution imagery of the events to specified destinations; identifying illegal fishing or shipping vessels using image and vessel shipping plans/authorizations and notifying personnel; monitoring vessel and aircraft movements against shipping and flight plans to ensure safety; detecting military or national security threats using changes in imagery in real-time and coordinating resources and/or defense systems; detecting instances of resource constraints and facilitating resource assignments; tracking assets and detecting instances of loss or potential loss and retroactively identifying causes or responsible entities and/or coordinating responses; detecting crop loss or determining crop health and scheduling or managing solutions; creating real-time mappings of activities, events, or objects; repositioning assets based on real-time events, activities, or objects detected; or many other configurations (e.g., such as in fields of consumer, commercial, government, and/or non-profit).

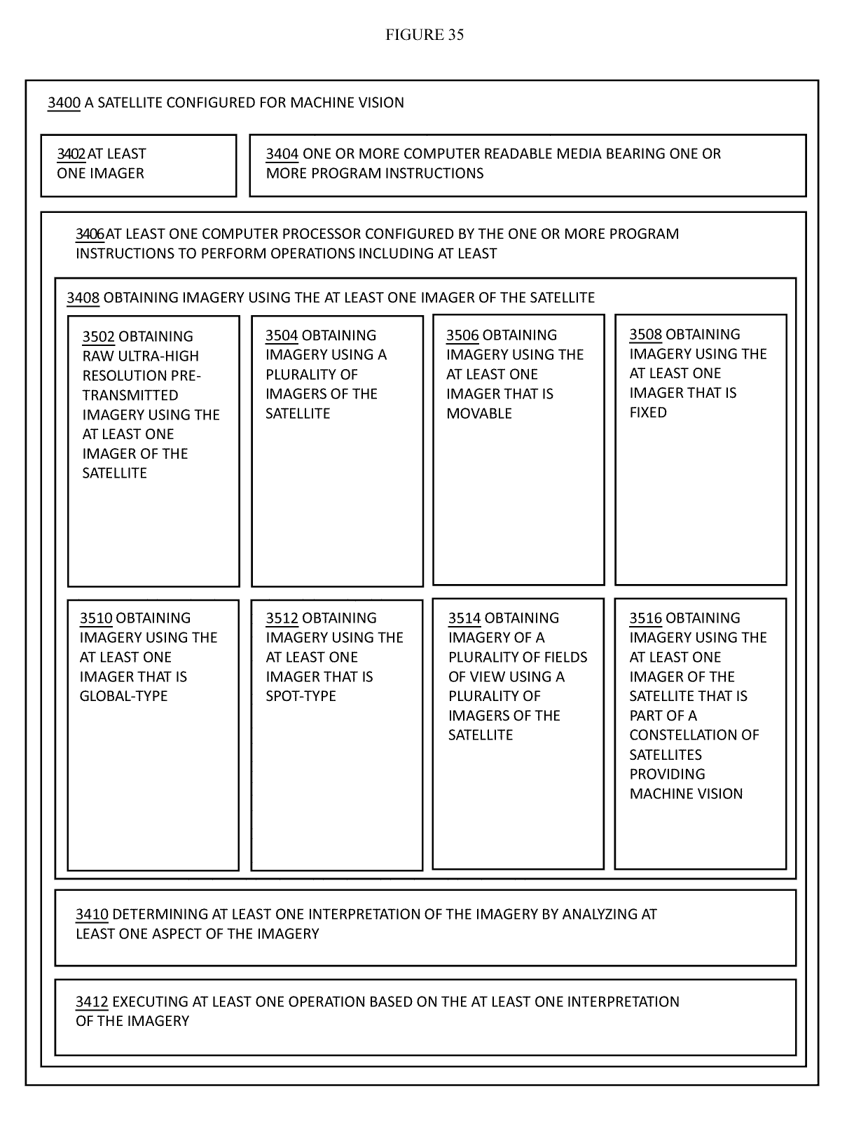

FIG. 35 is a component diagram of a satellite with machine vision, in accordance with an embodiment. In one embodiment, a satellite configured for machine vision 3400 includes, but is not limited to, at least one imager 3402; one or more computer readable media 3404 bearing one or more program instructions; and at least one computer processor 3406 configured by the one or more program instructions to perform operations including at least: obtaining imagery using the at least one imager of the satellite at 3408; determining at least one interpretation of the imagery by analyzing at least one aspect of the imagery at 3410; and executing at least one operation based on the at least one interpretation of the imagery at 3412. In certain embodiments, the obtaining imagery using the at least one imager of the satellite at 3408 includes one or more of: obtaining raw ultra-high resolution pre-transmitted imagery using the at least one imager of the satellite at 3502; obtaining imagery using a plurality of imagers of the satellite at 3504; obtaining imagery using the at least one imager that is movable at 3506; obtaining imagery using the at least one imager that is fixed at 3508; obtaining imagery using the at least one imager that is global-type at 3510; obtaining imagery using the at least one imager that is spot-type at 3512; obtaining imagery of a plurality of fields of view using a plurality of imagers of the satellite at 3514; and obtaining imagery using the at least one imager of the satellite that is part of a constellation of satellites providing machine vision at 3516.

In one embodiment, the obtaining raw ultra-high resolution pre-transmitted imagery using the at least one imager of the satellite at 3502 includes the satellite 500 obtaining ultra-high resolution imagery using at least one of the spot imagers 104 or at least one of the imagers of the global imaging array 102. The ultra-high resolution imagery can be of one particular field of view, such as one subfield of the inner cone field of view 406. The ultra-high resolution imagery can be on the order of a few to hundreds of megapixels or more, which can be captured at a rate of a few to hundreds or more frames per second. In instances where the satellite 500 includes a plurality of imagers, ultra-high resolution imagery can be captured in parallel using an array of imagers, such as an array of steerable spot imagers 104, an array of outer imagers 204, an array of inner imagers 202, an array of fisheye imagers 210, or any combination or sub combination thereof. The parallel capture of ultra-high resolution imagery using an array of imagers can significantly increase the amount of available pixel data, such as to a total of approximately tens to hundreds or more of gigabytes per second. In certain instances, multiple satellites can capture ultra-high resolution imagery using one or an array of imagers in parallel, resulting in more available pixel data, such as on the order of tens to hundreds or more of terabytes per second. The ultra-high resolution imagery can yield one to hundreds of meters of spatial resolution from hundreds of miles of orbital altitudes, which can vary between various imagers (e.g., approximately 40 m spatial resolution for the inner imagers 202, approximately 95 m spatial resolution for the outer imagers 204, and approximately 1 m spatial resolution for the spot imagers 104). In any event, the ultra-high resolution imagery can include content such as weather or other atmospheric conditions, outer space events or objects, or surface/ground objects, activities, or events.

For example, ultra-high resolution imagery can be obtained of a hurricane using a plurality of different imagers. The fisheye imager 210 can capture a substantial entirety of the hurricane while the various outer imagers 204 and inner imagers 202 can capture higher detail sections or portions of the hurricane. One or more of the spot imagers 104 can be aligned on and can capture imagery associated with the eye of the hurricane in further detail. The volume of image data of the hurricane captured at any given moment or over time can significantly exceed a communication bandwidth capacity of the satellite 500. However, the image data can be interpreted, such as by one or more image processors 504, to identify or detect the hurricane, remove pixel data unrelated to the hurricane, reduce a resolution of retained pixel data, and output resultant image data associated with the hurricane to a specific destination and/or output an alphanumeric textual indication of the hurricane and its coordinates. Thus, actions can be taken with respect to the image data of the hurricane in near-real-time with capture of the image data without requiring that any or all of the image data be communicated.

In one embodiment, obtaining imagery using a plurality of imagers of the satellite at 3504 includes the satellite 500 obtaining imagery using a plurality of the steerable imagers 104, the outer imagers 204, the inner imagers 202, and/or the fisheye imagers 210. The obtained imagery can be independent, overlap, or partially overlap. For instance, the imagery can include image data associated with nine of the inner cone fields of view 406, which partially overlap at their respective edges. Alternatively, the imagery can include image data associated with one of the outer cone fields of view 404 and can include overlapping image data associated with the fisheye field of view 402. Additionally, the imagery can include image data associated with the spot cone field of view 408 that is independent of and not overlapping with image data associated with the inner field of view 406. The imagery can therefore be obtained using an array of imagers associated with a variety of fields of view, such as tens or hundreds or more imagers and associated fields of view.

For example, imagery can be obtained using the fisheye imager 210 associated with a wide oceanic area of Earth. Additionally, imagery can be obtained using the spot imager 104, which spot imager 104 includes a spot cone field of view 408 that is aligned with a particular shipping vessel present within the wide oceanic area. The image data of the fisheye imager 210 can include a lower spatial resolution of the shipping vessel and surrounding areas while the image data of the spot imager 104 can include a higher spatial resolution of the shipping vessel. Additionally, imagery can be obtained using another spot imager 104N of another spot cone field of view 408N, which imagery can include image data of a high spatial resolution associated with one or more other objects in a vicinity to the shipping vessel. Further, imagery can be obtained using a plurality of inner imagers 202 including image data associated with a plurality of inner cone fields of view 406, some of which include image data of the shipping vessel and surrounding areas. One of the image processors 504 or the hub processor 502 can recognize the shipping vessel within the imagery, determine whether the shipping vessel is authorized based on sailing plan data and the GPS coordinates/time data associated with the shipping vessel, and can alert border security or other personnel of the possible presence of an unauthorized shipping vessel. Other intelligent operations can further be performed, including guiding one or more unmanned surveillance drones to the shipping vessel using constant feedback of position data obtained using one of the spot imagers 104.

In one embodiment, the obtaining imagery using the at least one imager that is movable at 3506 includes one of the spot imagers 104 obtaining imagery by pivoting, rotating, shifting, or otherwise moving or articulating. Imagery of the spot imager 104 can therefore include a moving field of view 408 that can dwell on a particular area or move to a different area. Movement of the spot imager 104 can be controlled by a user, by program instruction, or based on analysis of image data obtained from the spot imager 104 or another imager, such as the outer imager 204, the inner imager 202, or the fisheye imager 210. In certain embodiments, a plurality of spot imagers 104 each independently obtain imagery associated with movable spot fields of view 408. In some instances, other imagers, such as the outer imager 204, the inner imager 202, and/or the fisheye imager 210 can move by pivoting, rotating, shifting, or otherwise shifting or articulating.

For example, the spot imager 104 can be programmed to track one or more aircraft flying or ground taxiing on Earth. The spot imager 104 can obtain imagery associated with the aircraft and a processor associated with the spot imager 104 can determine a speed, direction, or other trajectory or vector information using the imagery. Based on the speed, direction, or other trajectory information, the processor can control the spot imager 104 to maintain a fix on the aircraft throughout one or more portions of flight. The image data from the aircraft can be used by the processor to further determine a route, a location, and/or groundspeed of the aircraft. This data can be used by the processor to calculate an arrival time of the aircraft and update one or more computer systems to reflect such arrival time (e.g., commercial airline databases that are used to populate arrivals and departure screens at an airport terminal). Furthermore, the processor can compare the arrival time with an expected arrival time, and upon delay, can dispatch or recommend one or more actions. Actions may include diverting another aircraft to the destination point to pick up the passengers that would otherwise have to wait for the delayed aircraft.

In one embodiment, the obtaining imagery using the at least one imager that is fixed at 3508 includes one imager of the global imaging array 102 obtaining imagery associated with a fixed alignment relative to the satellite 500 throughout its orbital transgression. The one imager can include one of the inner imagers 202, the outer imagers 204, and/or the fisheye imager 210. For instance, the imagery obtained can include image data associated with the fisheye field of view 402, which can remain fixed in alignment relative to the satellite 500 but include changing content as the satellite 500 moves along its orbit. In certain embodiments, the spot imager 104 is similarly fixed or fixable in alignment relative to the satellite 500.

For instance, one of the inner imagers 202 can capture image data associated with farmlands in the midwestern portion of America as the satellite 500 moves along its orbit. A processor 504 associated with the inner imager 202 can detect discoloration that is abnormal for a particular time of the season, determine the coordinates of the discoloration, and compare those coordinates to agricultural planting and harvest data. Based on the comparison, the processor 504 can determine that a particular area has a crop that is infested, exposed to drought, or otherwise underperforming. The processor can initiate a notification to a farmer or farm management entity along with coordinates and an assessment of the likely cause. The processor 504 can further control one or more sprinklers, irrigation systems, or aerial fertilizer/pesticide/fungicide dispensers to treat the area corresponding to the coordinates. Upon further request or as needed, the imagery associated with the area can be reduced and transmitted, such as to support decision making on the ground.

In one embodiment, the obtaining imagery using the at least one imager that is global-type at 3510 includes obtaining imagery using the global imaging array 102. The global imaging array 102 can include a plurality of imagers, such as inner imagers 202, outer imagers 204, and fisheye imagers 210. The global imaging array 102 can include fewer or greater numbers of imagers and the imagers can be in different combinations. Moreover, the global imaging array 102 can include imagers mounted in a plane, on a curve (convex or concave), in a spherical form, or in some other regular or irregular form. There can in certain embodiments be multiple instances of the global imaging array 102, such as two or more of the global imaging arrays 102. Additionally, the global imaging array 102 can include one or more of the spot imagers 104.

For example, the global imaging array 102 can obtain imagery of an animal migration using the fisheye imager 210. A processor 504N associated with the fisheye imager can detect a herd of animals coming into the fisheye field of view 402 as a result of the orbital transgression of the satellite 500. The detection of the herd of animals can be made based on image recognition or neural network comparisons performed by the processor 504N. As a result, the processor 504N can signal for execution of one or more animal migration tracking applications to begin collecting image data from the outer imagers 204 and the inner imagers 202 and to begin tracking the animal migration using one of the spot imagers 104. The animal tracking application can identify animals, determine an animal count, determine migration or feeding patterns, document GPS coordinates of the migration track, and transmit an alert to one or more entities that includes at least some of the data determined based on the image data.

In one embodiment, the obtaining imagery using the at least one imager that is spot-type includes the spot imager 104 obtaining imagery associated with the spot cone field of view 408. The spot imager 104 is steerable, movable, and/or articulatable relative to the satellite 500. The spot imager 104 is configured to obtain high spatial resolution image data associated with a relatively small window area. Thus, image spatial resolutions of approximately 1-5 meters are possible, enabling a high degree of fidelity from hundreds of miles of orbital altitude. In certain embodiments, the satellite 500 includes an array of approximately 9-11 spot imagers 104, which can be independently moved, steered, or articulated relative to one another.

For example, the spot imagers 104 can be programmed to train on moving objects or changes to collect high spatial resolution image data. In the case of ice calving, a processor 504N coupled to the fisheye imager 210 can detect and recognize potential ice calving in the fisheye field of view 402. In real-time or near-real-time, the processor 504N can identify an available spot imager 104 with the closest alignment to the ice calving and direct the available spot imager 104 to the ice calving. The spot imager 104 can collect high spatial resolution imagery of the ice calving before the calving has completed based on the near-instantaneous detection and control of the spot imager 104 (e.g., hundreds or thousandths of a second or less in response time). A processor 504N associated with the spot imager 104 can document the location of the ice calving, determine a size of the ice break-off, reduce and select relevant imagery, transmit the data to scientists, or update shipping navigational systems regarding a potential new navigational pathway.

In one embodiment, obtaining imagery of a plurality of fields of view using a plurality of imagers of the satellite includes obtaining imagery of one or more of the spot field of view 408, the inner cone field of view 406, the fisheye field of view 402, and the outer cone field of view 404, or any of the subfields thereof. The inner cone field of view 406 can include approximately nine subfields arranged in a grid. The outer cone field of view 404 can include approximately six subfields arranged about a perimeter of the inner cone field of view 406. The fisheye field of view 402 can include the inner cone field of view 406 and the outer cone field of view 404 as well as additional area surrounding the outer cone field of view 404. The spot field of view 408 can move anywhere throughout the fisheye field of view 402 or beyond. The fields of view 402, 404, 406, and 408 can be expanded or reduced as required for a particular application. Moreover, any of the subfields of the fields of view 402, 404, 406, and 408 can be increased or reduced in size or amount. For instance, the inner cone field of view 406 and the outer cone field of view 404 can be larger in area or reduced in area or eliminated. Likewise, the subfields of the inner cone field of view 406 and the outer cone field of view 404 can be reduced in number to one or increased in number to tens or hundreds of subfields. The spot cone field of view 408 can be increased in size or decreased in size and can be duplicated by an array of spot cone fields of view 408. The fisheye field of view 402 can be extended or decreased in area or even duplicated (e.g., to provide a view of outer space and a view of Earth on the same satellite 500).

For example, imagery can be obtained using a plurality of the fields of view 402, 404, 406, and 408 and the subfields thereof. Parallel application processes can be executed in real-time or in near-real-time on the obtained image data. One application process can, for instance, analyze image data for instances of lightning strikes and determine a quantity, location, and quality parameter of the lightning strikes. Another application process can analyze the same image data for another purpose, such as identifying vehicle movement along a road; determining a direction, speed and a quantity of the vehicles; alerting security personnel regarding the vehicles; and securing one or more entrances or exits automatically based on the vehicles. Yet another application process can identify traffic congestion, determine a delay factor for the traffic congestion, and open or close additional travel lanes to mitigate the traffic congestion.

In one embodiment, obtaining imagery using the at least one imager of the satellite that is part of a constellation of satellites providing machine vision at 3516 includes obtaining imagery using the satellite 500 that is part of a satellite constellation 1600. The imagery can be obtained using a plurality of satellites 500 and 500N that are part of the constellation 1600. Satellites 500 and 500N can each include the imaging system 100 or components thereof. Local processing of image data can be performed on-board the respective satellites 500 and 500N on raw image data collected, although some distributed processing of the image data is possible between the satellites 500 and 500N. Each of the satellites 500 can be configured to performed dedicated, independent, or parallel processes on image data. Furthermore any of the image data or analysis resultant therefrom on one satellite 500 can be used to control operations and processes of a different satellite 500. Thus, collectively, the constellation 1600 of satellites can includes significant amounts of imagers, such as forty to seventy imagers per satellite 500 times N number of satellites in the constellation 1600. The total image data per second collected can be on the order of terabytes per second (e.g., forty to seventy imagers per satellite 500 or around seven-hundred to twenty-one hundred imagers in total each collecting nine to twenty-one megapixels of image data at twenty frames per second).

For example, spot imager 104 of satellite 500 can collect image data associated with parking locations within a given city. The image data can be processed on-board by a processor 504N associated with the spot imager 104 to determine a length of time each vehicle has been parked and compare that length of time against known parking time limits for the area. Vehicles likely to be moved can be determined based on the same and the geographic coordinates of potentially available parking spaces can be transmitted to vehicles on the ground, such as to control automated driving of a vehicle toward the area where a parking spot will likely become available. Additionally, the parking data can be transmitted to another satellite 500N trailing the satellite 500 in its orbital path. Satellite 500N can continue the parking analysis processes upon being positioned to capture the city and parking image data after the satellite 500 has moved beyond access to the requisite ground features.

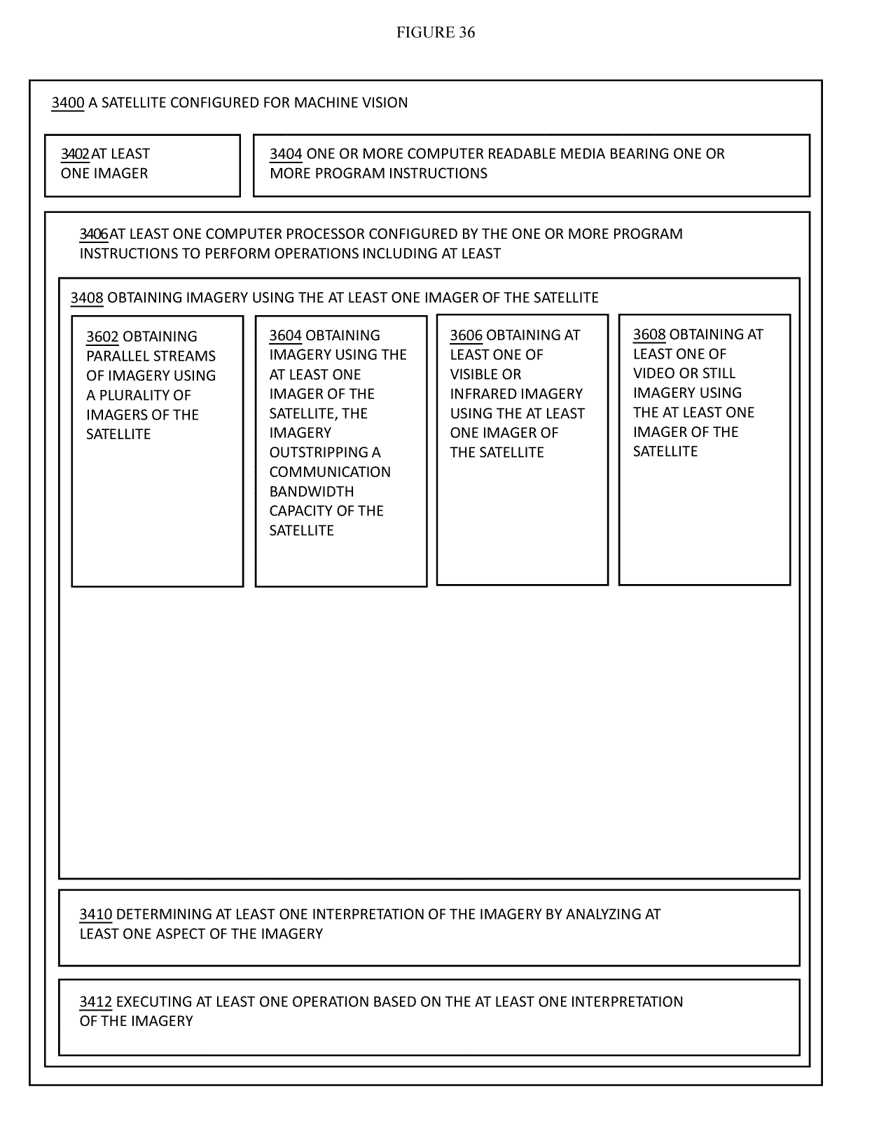

FIG. 36 is a component diagram of a satellite with machine vision, in accordance with an embodiment. In one embodiment, a satellite configured for machine vision 3400 includes, but is not limited to, at least one imager 3402; one or more computer readable media 3404 bearing one or more program instructions; and at least one computer processor 3406 configured by the one or more program instructions to perform operations including at least: obtaining parallel streams of imagery using a plurality of imagers of the satellite at 3602, obtaining imagery using the at least one imager of the satellite, the imagery outstripping a communication bandwidth capacity of the satellite at 3604, obtaining at least one of visible or infrared imagery using the at least one imager of the satellite at 3606, and obtaining at least one of video or still imagery using the at least one imager of the satellite at 3608.

In one embodiment, obtaining parallel streams of imagery using a plurality of imagers of the satellite at 3602 includes obtaining parallel streams of imagery using a plurality of any of the inner imagers 202, the outer imagers 204, the fisheye imagers 210, and the spot imagers 104. The parallel streams of imagery can arise from a plurality of subfields of any of the inner imagers 202, the outer imagers 204, the fisheye imagers 210, and the spot imagers 104. Dedicated or assignable processors 504 and 504N are associated with each of the inner imagers 202, the outer imagers 204, the fisheye imagers 210, and the spot imagers 104, and subfields thereof. The processors 504 and 504N can execute the same or different operations or processes on the respective incoming imagery to enable parallel processing of high resolution image data. Thus, streams of tens, hundreds, or even thousands of image data can be processed in parallel using a plurality of processors 504 and 504N that can be performing similar or different functions.

For example, one stream of image data including a parking lot can result in a dedicated processor 504N determining a quantity of parking spots full or empty, an average duration of parking spot occupancy, a density map of parking usage over time, preparation of parking lot data over time, such as hourly, daily, monthly, or during holidays, and predictions of business and consumer demand for planning purposes based on the image data obtained. Another stream of image data including smoke can result in a dedicated processor 504N determining a smoke beginning time, a precise location of the smoke, an intensity determination, a growth determination of the smoke over a period, and a determination of authorization for smoke based on permit data. Upon a determination of a likely unauthorized or unanticipated fire, based on analysis of the foregoing, the processor 504N can alert relevant emergency responders to the fire, coordinate air firefighting traffic, and collect and retain historical high spatial resolution imagery from a period prior to the smoke for investigative and causation determination purposes.

In one embodiment, the obtaining imagery using the at least one imager of the satellite, the imagery outstripping a communication bandwidth capacity of the satellite at 3604 includes the satellite 500 obtaining imagery that exceeds a capacity for transmission at any given moment in time. For example, the satellite 500 can obtain gigabytes or terabytes per second of image data while having a communication bandwidth constraint of approximately a few hundred megabytes or a few gigabytes per second. The satellite 500 can collect image data independent and decoupled from any communication bandwidth constraints. For instance, terabytes of image data can be collected despite having a communication link via interface 506 limited to only a few hundred bytes per second. The satellite 500 performs local processing at the satellite or at the imager level to process the image data in real-time or in near-real-time to recognize objects or events, interpret the data, and execute operations that may not require any transmission of data or may only require transmission of data that can be accommodated within the bandwidth constraints.

For example, a processor 504 on the satellite 500 can process incoming image data and recognize gaps in the ice and movement of icebergs within the Artic region. The gaps and movements can be modeled to predict shipping lanes available for vessels. The shipping lanes can be transmitted requiring only a few bytes per second of bandwidth despite the image data collected being megabytes or gigabytes in size. Alternatively, a processor 504 on the satellite 500 can process incoming image data and recognize flooding over wide areas. The flooding can be converted to depth and area information over a particular geographic area. The depth and area information can be transmitted again requiring only a few bytes per second despite the imagery being megabytes or gigabytes in size. Alternatively, a processor 504 on the satellite 500 can process incoming image data and retain only that image data pertaining to a convoy of military vehicles along a road. Previously transmitted unchanged image data can also be removed and the resolution of the remaining imagery can be reduced to match a screen resolution of a viewing device. The reduction in image data to that which is required or needed while removing or decimating non-interesting image data enables even relatively high resolution image data to be transmitted via bandwidth constrained networks.

In one embodiment, the obtaining at least one of visible or infrared imagery using the at least one imager of the satellite at 3606 includes at least one of the imagers of the global imaging array 102 and the steerable spot imager 104 capturing either or both of visible and infrared imagery. Any of the imagers of the satellite 500 can collect either or both of infrared and visible imagery either in parallel or in series at different times. A processor of the satellite 500 can trigger initiating of either infrared or visible imagery based on an application, a process, a request, image data, or information determined from the image data. Alternatively, some of the imagers of the global imaging array 102 or the spot imager 104 can be dedicated to infrared or visible image capture.

For example, an inner imager 202 can capture visible imagery associated with weather formations, including cloud formations and precipitation. Outer imager 204 can capture infrared imagery associated with heat and radiation. A processor 504N on the satellite 500 can obtain the visible imagery and the infrared imagery and determine cloud coverage, cloud movement, areas of precipitation, temperature gradations, cold front areas, warm front areas, occluded front areas, high pressure systems, low pressure systems, and the like. The processor 504N can further render weather predictions based on one or more models local to the satellite 500 and transmit any of the determined information, weather predictions, or portions of the infrared or visible imagery to one or more recipients. In one particular embodiment, the processor 504N of the satellite 500 can detect a hurricane or typhoon based on image data and issue weather warnings, such as to vessels, aircraft, and people in a geographic vicinity to the hurricane or typhoon. The processor 504N can take additional derivative actions, such as ordering supplies or emergency support services in anticipation for a future need of those items.

In one embodiment, the obtaining at least one of video or still imagery using the at least one imager of the satellite at 3608 includes at least one imager of the global imaging array 102 or the spot imager 104 obtaining video and/or still imagery. Any of the inner imager 202, the outer imager 204, the fisheye imager 210, or the spot imagers 104 can capture video or still imagery, based on a program, process, request, or based on the content of imagery. The still imagery may be expressed as a slow frame rate and the video imagery can be expressed as a frame rate that yields perceptible animation. Video imagery may be captured at rates of around twenty frames per second, but higher frames per second that are imperceptible to humans are also possible. These higher frame rates can be on the order of hundreds or thousands of frames per second. Higher frame rates can enable a processor to make more accurate decisions and/or detections of various objects, events, or activities. In some embodiments, the imagery can be captured at a variable frame rate that depends on program instruction, user request, processes, or content of imagery.

For example, spot imager 104 can obtain video imagery at a frame rate of approximately ten frames per second of a particular geographical area. A processor 504N can obtain the video imagery and detect an object or event that requires additional image data for recognition. The spot imager 104 can then increase its frame rate and be controlled to dwell on the particular object or event, such as increase its frame rate to fifty or more frames per second in burst mode. The processor 504N can then obtain the imagery at the high frame rate and use the different angles, due to dwell and movement of the satellite, to recreate a super resolution still image of the object or event. Use of this technique can enable enhanced recognition, such as via neural network comparisons, to identify the object or event and take further secondary actions.

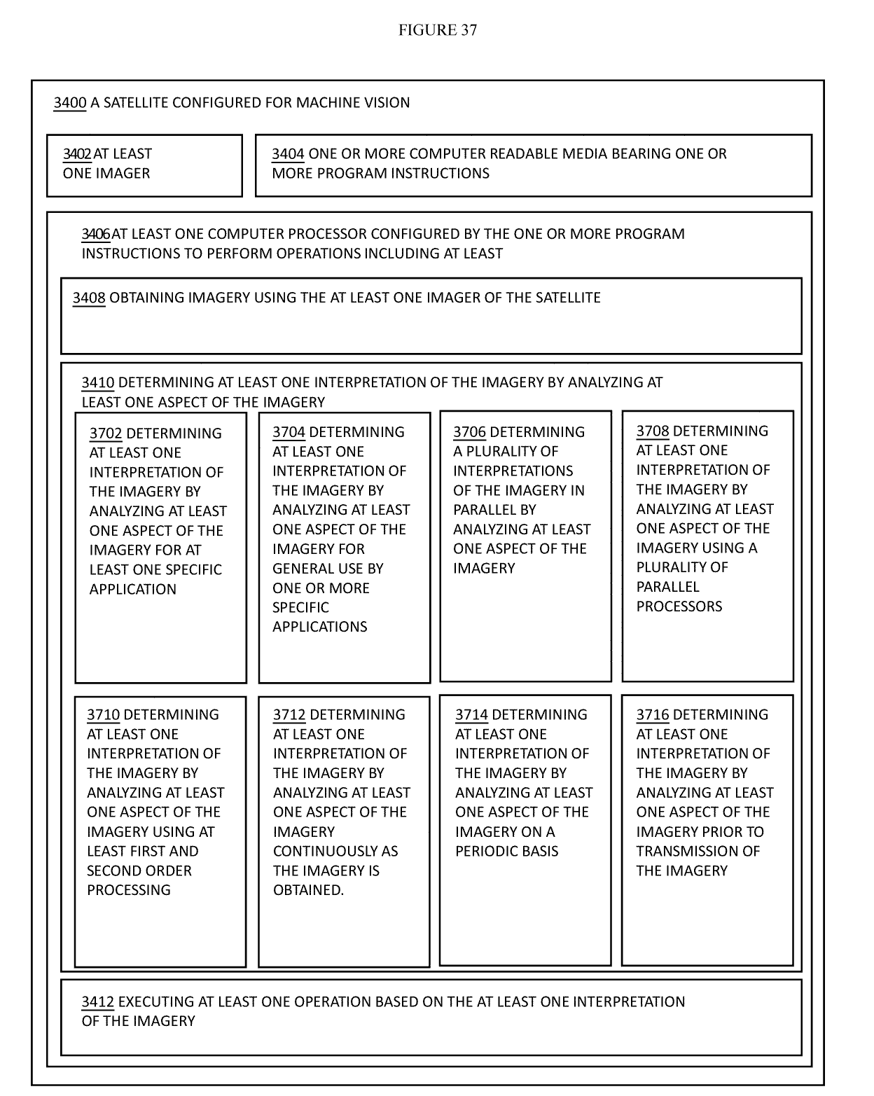

FIG. 37 is a component diagram of a satellite with machine vision, in accordance with an embodiment. In one embodiment, a satellite configured for machine vision 3400 includes, but is not limited to, at least one imager 3402; one or more computer readable media 3404 bearing one or more program instructions; and at least one computer processor 3406 configured by the one or more program instructions to perform operations including at least: determining at least one interpretation of the imagery by analyzing at least one aspect of the imagery for at least one specific application at 3702; determining at least one interpretation of the imagery by analyzing at least one aspect of the imagery for general use by one or more specific applications at 3704; determining a plurality of interpretations of the imagery in parallel by analyzing at least one aspect of the imagery at 3706; determining at least one interpretation of the imagery by analyzing at least one aspect of the imagery using a plurality of parallel processors at 3708; determining at least one interpretation of the imagery by analyzing at least one aspect of the imagery using at least first and second order processing at 3710; determining at least one interpretation of the imagery by analyzing at least one aspect of the imagery continuously as the imagery is obtained at 3712; determining at least one interpretation of the imagery by analyzing at least one aspect of the imagery on a periodic basis at 3714; and/or determining at least one interpretation of the imagery by analyzing at least one aspect of the imagery prior to transmission of the imagery at 3716.

In one embodiment, determining at least one interpretation of the imagery by analyzing at least one aspect of the imagery for at least one specific application at 3702 includes the satellite 500 hosting one or more applications on-board and analyzing imagery captured using either or both of the global imaging array 102 and/or the spot imager 104 in accordance with the one or more locally hosted applications. In one particular embodiment, the satellite 500 includes an application programming interface (API) that includes one or more subroutine definitions, protocols, and tools for building customized applications for interacting with ultra-high resolution imagery captured using the global imaging array 102 and/or the spot imager 104. The satellite 500 can include and/or provide baseline image processing operations on the raw image data captured using the global imaging array 102 or the spot imager 104. The baseline image processing operations can include object recognition, feature recognition, vector extraction, movement detection, event detection, neural network processing, cropping, pixel decimation, resolution reduction, zoom/pan, static object removal, unchanged object removal, compression, stitching, or other operations disclosed herein. These baseline image processing operations can be harnessed by one or more other customized applications via the API. The customized applications can be locally hosted on the satellite 500 or partially or fully hosted on another of the satellites 500N or external to the satellite 500. The customized applications have access to and use the data enabled by the baseline image processing operations of the satellite 500 (e.g., imagery that is raw, decimated, cropped, stitched, etc. or non-image data that is binary, textual, vector, alphanumeric, parameter, or variable type) to perform more specific operations.

For example, the satellite 500 can provide neural network analysis feature and object recognition on raw imagery and provide non-image data regarding the object or feature to one or more custom applications via the API. For instance, the feature and object recognition can include identification of the feature or object, size, color, orientation, movement vector, geographical location, time, or other related parameters. Customized applications can request information on specific identified objects or features via the API and further process the data, such as format, organize, analyze, compare, or other related operation. In one specific case, the customized application is an air traffic safety application that requests information regarding airplane traffic via the API. The air traffic safety application is not required to perform image analysis on the raw image data collected by the satellite 500, but can instead make requests via the API for locations, directions, speeds, timing data for aircraft detected. Upon receiving the air traffic information, the air traffic safety application can perform airplane specific operations on the data, such as mapping air traffic, comparing observed air traffic with expected air traffic provided via flight plans, and notifying air traffic control (ATC) regarding potential conflicts. Another custom application can use the same air traffic information provided via the API to perform other functions, such as providing a consumer interface for scheduling tracking of airplanes to determine arrival and departure times. Many other custom applications can be configured at the satellite 500 to perform unique operations, such as in the fields of news reporting, media, gaming, national security, weather, geo-monitoring, migration tracking, shipping, traffic management, parking space monitoring, natural disasters, or other consumer, business, government, or non-profit related applications.

In one embodiment, the determining at least one interpretation of the imagery by analyzing at least one aspect of the imagery for general use by one or more specific applications at 3704 includes the satellite 500 performing an initial analysis on ultra-high resolution raw imagery as the imagery is captured by the imaging system 100. The initial analysis can be leveraged by other specific applications in real-time or non-real-time as needed. For example, the initial analysis can include identifying changed pixel data between successive frames, identifying pixel data that includes movement, determining pixel data that is associated with an object or event of interest, detecting an instance of an event, feature, object, or aspect, determining distances, size, movement vectors, speeds, shapes, or the like. This image or non-image data can then be used and/or made available to a specific application for further processing. For instance, the specific application can process select pixel data pre-determined to include a moving object to perform objection recognition, such as through neural network analysis, and provide an identification of the moving object to another application or process. The other application or process can be on another satellite 500N or otherwise remote from the satellite 500.

As one particular example, the imagery captured by the global imaging array 102 can be analyzed to detect all instances of moving objects, such as planes, ships, vehicles, migrating animals, flooding, traffic, etc. The pixel data surrounding the moving objects can be retained at ultra-high resolutions with the remaining imagery decimated (e.g., removed, deleted, buffered, stored). The retained pixel data can be provided to a plurality of applications on-board the satellite 500 that further analyze the image data for unique processing operations in parallel or independently of one other. One particular application can identify natural disaster instances of flooding, earthquakes, typhoons, hurricanes, tsunamis, fire, etc. and can provide image or non-image data associated with each to additional custom applications (e.g., one application for fire support and another application for hurricane support). Output of these additional custom applications can be further provided to yet further applications that can provide even more specific operations (e.g., fire tracking, air tanker coordination, residence and commercial warnings, smoke environmental tracking).

In one embodiment, the determining a plurality of interpretations of the imagery in parallel by analyzing at least one aspect of the imagery at 3706 includes the satellite 500 hosting a plurality of different applications that analyze the same imagery captured by the imaging system 100, for different purposes. The plurality of different applications can directly analyze incoming raw image data captured by the imaging system 100 in parallel, such as by replicating and communicating the imagery to each of the plurality of different applications or by storing and enabling each of the plurality of different applications to access the imagery. Alternatively, the plurality of different applications can directly analyze incoming raw image data captured by the imaging system 100 in series by enabling each application to process the imagery prior to communication of the imagery to another of the plurality of applications. Further, the plurality of different applications can indirectly access the imagery in parallel or in series through an API interaction with another process or application that has performed some baseline operations on the imagery. The plurality of different applications can perform different functions for entirely different purposes and results.

For instance, imagery captured by an inner imaging unit 202 of the inner core field of view 406 can be streamed in real-time as ultra-high resolution imagery to the image processor 504 and 504N, which can each be performing different analysis on the same imagery. One image processor 504 can detect whale breaches and the other image processor 504N can detect ice calving instances, using the same imagery from the same field of view 406. As another example, imagery captured by the fisheye imager 210 associated with the fisheye field of view 402 can include infrared and visible spectrum imagery. The image processor 504 or 504N can process both or either of the infrared or visible spectrum imagery to identify features or events or objects, such as detecting an explosion based on the presence of visible fire or smoke and based on a heat concentration.

In one embodiment, the determining at least one interpretation of the imagery by analyzing at least one aspect of the imagery includes, but is not limited to, determining at least one interpretation of the imagery by analyzing at least one aspect of the imagery using a plurality of parallel processors at 3708 includes the satellite 500 having processors 504 and 504N each analyzing different imagery captured by the imaging system 100 for a common purpose or function. For instance, the imaging system 100 can capture imagery of different fields of view, such as spot cone field of view 408, inner cone field of view 406, fisheye field of view 402, and outer cone field of view 404, using the global imaging array 102 and the spot imager 104. A plurality of processors 504 and 504N can independently process in parallel different imagery obtained using various imagers of the global imaging array 102 and/or the spot imager 104, for the same purpose or function. The purpose or function can include identifying, detecting, or recognizing objects, events, activities, aspects, movement, or features; performing analysis, comparison, processes, or evaluations; and/or providing image or non-image outputs, for example.

For instance, image processor 504 can process imagery associated with an inner imaging unit 202 and inner cone field of view 406 while image processor 504N can process imagery associated with outer imaging unit 204 and outer cone field of view 404, for purposes of determining instances of border security breaches around a nation. These processes can include identifying instances of vehicles, people, aircraft, or ships in certain geographic areas, comparing those instances to expected vehicles, people, aircraft, or ships from a data source, determining non-image evaluation data such as quantity, location, direction, size, speed, or the like, performing image reduction operations to retain changing non-static imagery at specified resolutions, and outputting at least some of the foregoing for communication to a ground station or entity. Each processor 500 and 504N therefore can have access to ultra high resolution imagery and perform operations confined to certain fields of view to enable more rapid interpretation of imagery through parallel processing. Such parallel processing on a single satellite 500 can enable fast processing of significant amounts of image data, such as image data on the order of four hundred Gbps per satellite or thirty Tbps per constellation of satellites 500 and 500N. Significant processing power can also be enabled, such as on the order of twenty teraflops per satellite or two petaflops per constellation.

In one embodiment, the determining at least one interpretation of the imagery by analyzing at least one aspect of the imagery using at least first and second order processing at 3710 includes the image processor 504 performing first order processing and hub processor 502 performing second order processing. A plurality of image processors 504 and 504N can perform first order processing on imagery obtained from respective imagers of the global imaging array 102 and the spot imagers 104. The hub processor 502 can obtain the results of the first order processing from the image processors 504 and 504N and perform additional second order processing. First order processing can include pixel reduction, pixel decimation, static object removal, unchanged pixel removal, previously obtained or transmitted pixel removal, cropping, sectioning, resolution changes, object recognition, feature recognition, event recognition, detection of movement, interpretation of imagery, binary or text, or parameter conversion, feature vector determinations, or other disclosed or related function. Second order processing can include any of the foregoing, compression, stitching, image processing, or the like.

For example, image processor 504 and 504N can independently evaluate different imagery for instances of drought conditions, such as low mountain snowpack for a specified time of season, for different sections of a mountain range area. Measurements and an outline of the snowpack can be further determined by each of the image processors 504 and 504N. Hub processor 502 can obtain the measurements and the outline information for the snowpack for the different sections of the mount range area form the image processors 504 and 504N and can perform further interpretive functions using the entirety of the data. For instance, a totality of the snowpack can be estimated, charted, and forwarded to one or more city planners or officials as binary or alphanumeric text data. Image data of the snowpack can be recreated on the ground or outside of the satellite 500 based on the outline information transmitted as non-image data. Other alerts can also be triggered, such as alerting members of the population affected via social media when the snowpack falls below a specified threshold level.

In one embodiment, the determining at least one interpretation of the imagery by analyzing at least one aspect of the imagery continuously as the imagery is obtained at 3710 includes an image processor 504 processing real-time or near-real-time ultra high resolution imagery obtained from an imager of the satellite imaging system 100. The image processor 504 is positioned in proximity to or collocated with an imager of the imaging system 100 (e.g., inner imaging unit 202). The image processor 504 therefore can have direct access to captured ultra-high resolution imagery, including substantially every pixel, as the imagery is obtained without requiring prior-low-bandwidth-constrained communication of the imagery. Thus, image processor 504 can perform operations such as image reduction, interpretation, and non-image or image output as the imagery is captured. Some or all of the imagery may be discarded, decimated, buffered, or stored for post-processing of the imagery by the image processor 504.

For example, inner imager 202 can capture approximately twenty Gbps of imagery of an international shipping port, an amount that substantially exceeds a communication link 506 bandwidth constraint of the satellite 500. Image processor 504 can obtain the imagery of the international shipping port as it is captured in real-time or near-real-time and evaluate the imagery to identify any instance of unusual activity. Instances of unusual activity can be based on a neural network analysis of customary activity, such as typical locations and movement patterns of people, vehicles, and equipment in and around the shipping containers. Deviations from normalcy (e.g., a person present in one area of the shipyard that typically has no people) can be detected. Imagery associated with the unusual event can be stored and metadata added to include time, location, and description of the unusual activity, while other imagery associated with typical or normal operations can be decimated or stored for archival. The image processor can trigger an alert or notification to security personnel on the ground at the port in real-time or near-real-time to enable evaluation, the alert including the select imagery and the metadata.

In one embodiment, the determining at least one interpretation of the imagery by analyzing at least one aspect of the imagery on a periodic basis at 3714 includes image processor 504 executing an operation or process with respect to imagery obtained from the imaging system 100 on a periodic or non-real-time basis. The periodic basis can be an interval, on-demand, scheduled, momentary, regular, or irregular with respect to raw captured imagery of the imaging system 100. In instances of multiple image processors 504 and 504N, each of the image processors can perform periodic operations with respect to imagery captured on a synchronized, random, or coordinated basis. The non-real-time basis can include the image processor 504 accessing stored imagery, such as a historical archive of a video Earth database. In instances of multiple image processors 504 and 504N, the non-real-time access can likewise be synchronized, random, or coordinated. The periodic or non-real-time operations or processes performed by the image processors 504 and 504N can be the same or can be different, such as the same interpretation of image data captured by two different imagers or different interpretations of the same or different imagery captured by two different imagers.

For instance, an image processor 504 can process real-time high resolution imagery every fifteen minutes whenever non-ocean or non-ice surfaces are present with the captured imagery from the inner imaging unit 202 to detect an instance of a fire through the presence and expansion of smoke. Upon detecting the instance of a first, the image processor 504 or another image processor 504N can request archival imagery from the prior fifteen minutes from an Earth video archive at the satellite 500 created from non-analyzed stored imagery. The image processor 504 can determine from the archived imagery any potential causes of the fire, such as instances of vehicles or people in the vicinity of the fire. The image processor 504 or the hub processor 502 can transmit an alert via the low-bandwidth communication link of the satellite 500 to fire and rescue personnel, including GPS coordinates, time, size, and select imagery associated with the fire. Potential investigation-relevant information can also be included, such as images of cars or people in the vicinity of the fire.

In one embodiment, the determining at least one interpretation of the imagery by analyzing at least one aspect of the imagery prior to transmission of the imagery at 3716 includes the image processor 504 or the hub processor 502 or another processor on-board the satellite 500 interpreting the imagery before any of the imagery is transmitted via a communication link 506, such as to another satellite 500N or to a ground entity. The interpretation can include deducing one aspect based on raw image data, which one aspect is not facially present in the raw image data. Interpretation can include, for example, identifying objects, detecting events, performing feature recognition, detecting movement, identifying edges, determining movement paths, determining locations, performing neural network analysis, or other similar first order interpretations. However, interpretation can include additional levels of interpretation that are based on other image interpretations (e.g., by other image processors 504N or on other satellites 500N) or that are based on additional data source information (e.g., ground based data sources or data sources that are at least partially resident on the satellite 500). The second order or additional levels of interpretation can include analysis, comparisons, evaluations, predictions, or the like.

For instance, a processor 504N on the satellite 500 can obtain raw imagery and detect an instance of a hurricane forming. The processor 504N can track movement and growth of the hurricane and make a prediction based on modeling applications as to the path of the hurricane and the potential landfall location of the hurricane. The processor 504N can then transmit communications to emergency personnel, weather forecasters, news media outlets, and registered individuals to alter them of the hurricane, size, landfall location, and recommend courses of actions (e.g., evacuation routes).

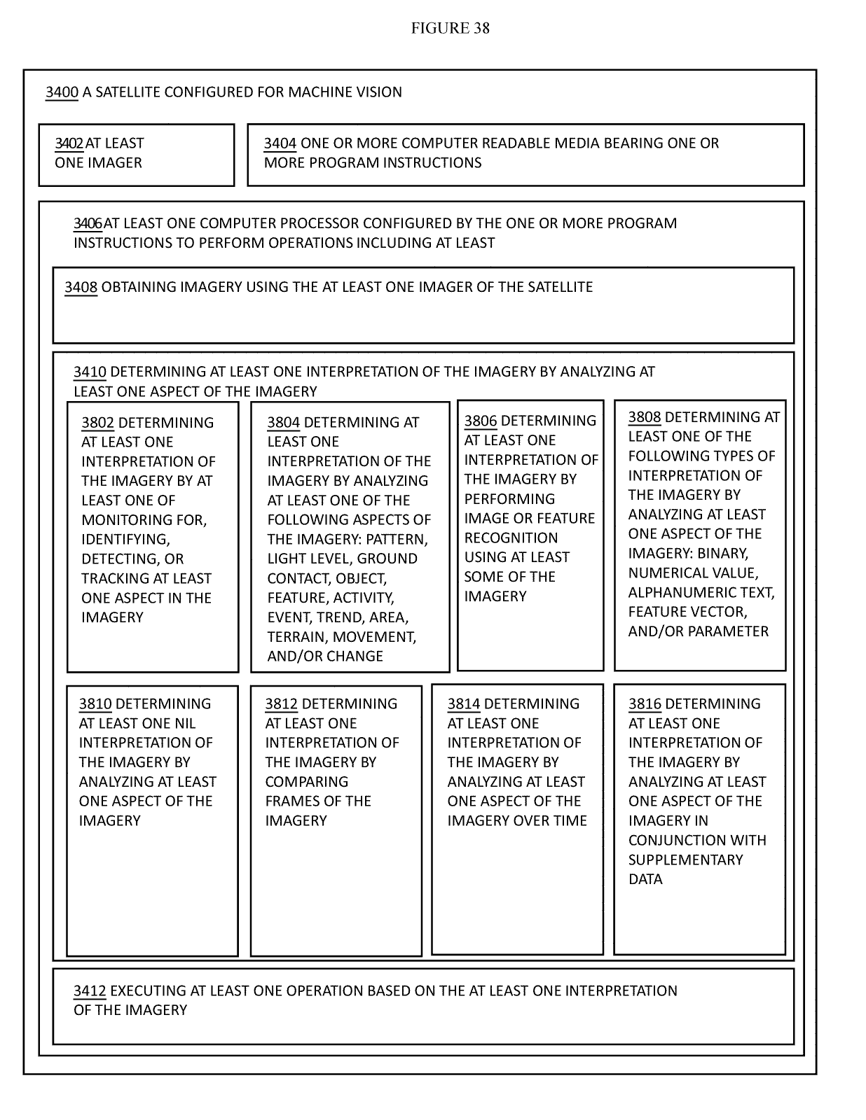

FIG. 38 is a component diagram of a satellite with machine vision, in accordance with an embodiment. In one embodiment, a satellite configured for machine vision 3400 includes, but is not limited to, at least one imager 3402; one or more computer readable media 3404 bearing one or more program instructions; and at least one computer processor 3406 configured by the one or more program instructions to perform operations including at least: determining at least one interpretation of the imagery by at least one of monitoring for, identifying, detecting, or tracking at least one aspect in the imagery at 3802; determining at least one interpretation of the imagery by analyzing at least one of the following aspects of the imagery: pattern, light level, ground contact, object, feature, activity, event, trend, area, terrain, movement, and/or change at 3804; determining at least one interpretation of the imagery by performing image or feature recognition using at least some of the imagery at 3806; determining at least one of the following types of interpretation of the imagery by analyzing at least one aspect of the imagery: binary, numerical value, alphanumeric text, feature vector, and/or parameter at 3808; determining at least one nil interpretation of the imagery by analyzing at least one aspect of the imagery at 3810; determining at least one interpretation of the imagery by comparing frames of the imagery at 3812; determining at least one interpretation of the imagery by analyzing at least one aspect of the imagery over time at 3814; and determining at least one interpretation of the imagery by analyzing at least one aspect of the imagery in conjunction with supplementary data at 3816.

In one embodiment, the determining at least one interpretation of the imagery by at least one of monitoring for, identifying, detecting, or tracking at least one aspect in the imagery at 3802 includes an image processor 504 or hub processor 502 of the imaging system 100 monitoring, identifying, detecting, or tracking aspects in imagery collected via the global imaging array 102 or the spot imager 104. Monitoring can include analyzing every pixel of every frame of ultra high resolution imagery or can include analyzing a subset or select set of pixels of at least some of the frames of ultra high resolution imagery. Identifying can include a binary, alphanumeric text, pixel selection, or other information describing or illustrating an aspect. Detecting can include a binary, analog voltage level, digital voltage level, argument, or other flag indicating a presence of an aspect. Tracking can include one or more positions, coordinates, vectors, or other indications as to location and movement of an aspect relative to the satellite 500 or relative to Earth.

For example, an image processor 504 can monitor real-time ultra high resolution imagery as it is captured by the inner imaging unit 202 to identify and detect one or more instances of a launch vehicle, rocket, space shuttle, or the like. Monitoring can be performed on every pixel of every frame within a specified geographic expected area of the launch vehicle (e.g., over Southern Florida) and during an expected period of launch (e.g., 8:30 AM Eastern time-9:30 AM Eastern time). Identification and detection of the launch vehicle can be determined by determining pixel coloration changes across a field of view commensurate in speed, size, and color or a launch vehicle, such as traveling thousands of miles per hour with a solid color lead edge and a trailing yellow/red stream with a curvilinear line of gray. Tracking can include calculating the precise GPS position over time using triangulation position information determined from imagery collected from at least two other satellites 500N. The speed, GPS location information, and feature vector information can be transmitted without any imagery from the satellite 500 to a ground station to enable real-time or near-real-time output and analysis. The imagery of the launch vehicle can be recreated for output at a user device or ground station using the non-imagery data transmitted.

In one embodiment, determining at least one interpretation of the imagery by analyzing at least one of the following aspects of the imagery: pattern, light level, ground contact, object, feature, activity, event, trend, area, terrain, movement, and/or change at 3804 includes a processor 504 or 504N analyzing pattern, light level, ground contact, object, feature, activity, event, trend, area, terrain, movement, or change using real-time or near-real-time imagery collected using the imaging system 100. Analyzing a pattern can include determining an instance of a repeated or a recurring pixel color or shape. Analyzing light level can include determining a binary value, an analog value, or a color or shade indication for light. Analyzing ground contact can include determining a binary value, an analog value, or an area where visual ground contact is made, such as where there is an absence of cloud or smoke obscuring terrain. Analyzing an object, feature, activity, or event can include performing image recognition and/or neural network analysis to identify the object, feature, activity, or event and/or one or more characteristics thereof. Analyzing a trend can include determining movement, growth, reduction, or characteristic change over time. Analyzing an area or terrain can include determining one or more aspects within the area or terrain and/or determining one or more changes within the area or terrain relative to one or more previous times. Analyzing change or movement can include identifying at least one difference in position of one or more aspects between one or more frames.

For example, in a case of a forest fire detection and management application, the image processor 504 can interpret real-time imagery captured using the global imaging array 102 to identify a forest fire. The application can include analyzing imagery to determine a pattern of red, yellow, orange, and gradations of gray. In response to determination of such a pattern, pixel data associated with the pattern can be processed using neural network analysis or image recognition to confirm an instance of a forest fire. The application can then identify the perimeter of the forest fire and track its growth by performing change analysis of pixel data (e.g., green or brown pixel data changing to red or yellow pixel data). Location GPS coordinates of the forest fire along with size, growth, intensity, and trend information can be communicated from the satellite 500 in near-real-time to alert one or more first responders or emergency personnel. Furthermore, temporary flight restrictions (TFRs) can be automatically established through the FAA (Federal Aviation Administration) to prevent unauthorized and unsafe flight in and around the forest fire. The application of the satellite 500 can additionally alert one or more homes or user devices within a specified radius of the forest fire to enable early response and evacuation.

In one embodiment, determining at least one interpretation of the imagery by performing image or feature recognition using at least some of the imagery includes the image processor 504N performing image or feature recognition using real-time or near-real-time imagery captured via the spot imager 104. Image or feature recognition can include recognition based on supervised learning using a training set of labeled data and a model for reconciling uncertain results; unsupervised learning using unlabeled data and inherent patterns present in previously recognized objects or aspects; or semi-supervised learning based on a combination of labeled and unlabeled data. In certain embodiments, the image or feature recognition can be based on classification or clustering based on some similarity measure, such as distances or vectors. In other embodiments, the image or feature recognition can be based on a feature vector or a dot product, which can involve categories, ordinals, integers, or real-values, for example. The image or feature recognition can also be understood to include machine vision, artificial intelligence, machine learning, computer vision, machine perception, or the like.

For example, image processor 504N can obtain ultra high resolution imagery using the spot imager 104 that has been aligned to movement detected using the fisheye imaging unit 210. The image processor 504N can perform neural network analysis on one or more objects present within imagery associated with the spot cone field of view 408. The neural network analysis can include converting the one or more objects to feature vectors and comparing the feature vectors to a dataset created at least in part from past recognition analyses. The image processor 504N can identify through neural network analysis an instance of troop, tank, and rocket launcher movement in North Korea by matching at least some of the feature vector information. Previously, unlearned feature vector information can be added to the dataset to enable future machine vision analysis. Feature vector information associated with the troop, tank, and rocket launcher movement can be communicated from the satellite 500 to a ground station to enable visual recreation of the imagery. Furthermore, the processor 504N can control one or more surveillance satellites to collect addition image information of the troop, tank, and rocket launcher movement for national security purposes.

In one embodiment, determining at least one of the following types of interpretation of the imagery by analyzing at least one aspect of the imagery: binary, numerical value, alphanumeric text, feature vector, and/or parameter at 3808 includes image processor 504 deducing a binary, numerical, alphanumeric text, feature vector, or parameter from real-time or near-real-time imagery captured using the imaging system 100. A binary value can be zero or one or HIGH or LOW based on the content of the imagery. A numerical value can be an integer, unsigned, signed, long, or float value based on the content of the imagery. Alphanumeric text can include any text or symbol, such as that represented by one or more bytes of data. A feature vector can include an n-dimensional vector of numerical features that represent an object. A parameter can include a variable value, such as text, binary, Boolean, integer, float, or the like.

For example, in the context of an asset transportation application, the image processor 504 can analyze imagery collected using the satellite imaging system 100 to make the following interpretations. First, the application can interpret a binary indication, such as a one, that the imagery contains a train and one or more shipping containers, based on one or more feature vectors deduced from the imagery and a neural network analysis. Based on the binary indication, the application can then quantify the number of shipping containers, such as one-hundred and thirty four shipping containers. Additionally, the application can further interpret the imagery to determine a number of alphanumeric descriptors, such as the color of each shipping container, a position of each shipping container from the front, a travel speed of the train, and a current location of the train. In one particular embodiment, a large one or two dimensional barcode can be disposed on the top of the shipping containers, such as via paint or decal, and the application can further collect the barcode information as a parameter value for each shipping container using the ultra-high resolution imagery collected by the satellite imaging system 100. The parameter value can be used by the application to further identify the shipping container, its origin, a scheduled route, its destination, and its scheduled arrival time. The application can determine from this information any deviation. The application can then communicate any of the resultant interpretive information to an asset transportation tracking system on the ground without requiring any transmission of imagery from the satellite 500.

In one embodiment, determining at least one nil interpretation of the imagery by analyzing at least one aspect of the imagery at 3810 includes the image processor 504 determining the non-existence of an aspect within real-time or near-real-time imagery collected using the imaging system 100. The non-existence of the aspect can include non-existence at a specific point in time, non-existence at specified intervals, or non-existence for a specified duration of time, for example. The non-existence can be represented by a Boolean, binary, alphanumeric text, integer, float, or another parameter. Alternatively, the non-existence can be represented as an absence of any parameter.

For instance, a news reporting application can run on the satellite 500 and analyze imagery collected in real-time from the imaging system 100 to detect any instance of a plurality of events. Events can include, rioting, demonstrations, marches, picketing, or any other aggregation or congregation of people. Other events may be monitored as well, in addition to these specific examples. In response to an absence of detecting any such events, the application can return a Boolean false value with respect to a specific geographic area. For instance, the application can return false values for each section of Seattle monitored, such as downtown, SODO, Capitol Hill, Queen Anne, U-District, etc. In the event that the application identifies a grouping or people that may be indicative of a monitored event, the application can return a Boolean true value for that particular area, such as true for the Ballard area of Seattle. No imagery is required to be transmitted beyond the Boolean value and a news reporting agency can dispatch helicopters or ground-based crews based on the Boolean value alone.

In one embodiment, determining at least one interpretation of the imagery by comparing frames of the imagery at 3812 includes the image processor 504 comparing real-time frames captured by the imaging system 100. The compared frames can be sequential frames, frames at specified intervals (e.g., every 10^{th} frame), frames at specific times (e.g., every hour), frames captured by different imagers (e.g., inner imager 202 and outer imager 204), or frames captured by different satellites 500 and 500N. The comparison can involve a color, pattern, shape, position, movement, size, feature, or other aspect.

For instance, in a context of a border control application, the image processor 504 can compare successive frames of real-time imagery captured using the inner imager 202 with regard to positioning of one or more objects on the ground in an area proximate the Southern U.S. border. For instance, the comparison of successive frames can indicate that a vehicle is driving closer to a secured portion of the U.S. border known to harbor illegal immigration activity. Alternatively, the comparison of successive frames can indicate that objects are being moved across the Rio Grande river. Alternatively, the image processor 504 can compare frames of real-time imagery at intervals of every week with regard to a size or quantity of activity, such as a quantity of people, a number of vehicles, or a size of structures in a particular area proximate to the Northern U.S. border. Thus, the image processor 504 can make interpretations such as increasing activity, decreasing activity, or evolving activity over longer periods of time. For instance, using a comparative analysis, the image processor 504 can determine that over the course of the last three months a wooded area has been cleared and that small aircraft are being operated therefrom. The results of the comparison and interpretation can be communicated from the satellite 500 independent of any imagery to enable border control agencies to respond and investigate potential issues.

In one embodiment, determining at least one interpretation of the imagery by analyzing at least one aspect of the imagery over time at 3814 includes the hub processor analyzing aspects of imagery captured using the global imaging array 102 and the spot imager 104 over time. The analysis of the aspects over time can include sequential frame analysis, periodic analysis, interval analysis, analysis triggered by change, or the like. The hub processor 502 can obtain first order analysis of imagery over time with respect to certain fields of view, such as from image processors 504 and 504N. Hub processor 502 can then perform second order analysis over time with respect to the first order analysis. Alternatively either of the image processor 504 or the hub processor 502 can independently perform analysis on imagery over time. The analysis can include, for example, position tracking, growth tracking, change detection, route monitoring, affected area determinations, or the like.

For example, each image processor 504 and 504N of an array can independently analyze imagery obtained from respective imagers, such as imagers 202 and imagers 204, with respect to flood areas resultant from a particular hurricane. The imagers 2020 and 204 have different respective fields of view 406 and 404, respectively, each covering different geographic portions. The image processors 504 and 504N can track the flood progress over the course of time for the different geographic portions, from just before flooding to a period following receding of flood waters. Tracking can include determining time and boundaries of flood waters for each geographic portion, as well as predictions for movement of flood waters over the course of the next few hours. The tracking information from each of the image processors 504 and 504N can be obtained by the hub processor 502, which then combines the time, boundaries, and predictions into a holistic model of current and expected flood progress. The model can then be transmitted for consumer, news, emergency response, and first responder access, without requiring transmission of image data from the satellite 500.

In one embodiment, determining at least one interpretation of the imagery by analyzing at least one aspect of the imagery in conjunction with supplementary data at includes the image processor 504 analyzing real-time imagery obtained using the imaging system 100 against supplemental non-image data stored or accessed by the satellite 500. The supplemental data can include text or binary data stored in a table, database, or other data structure. In certain embodiments, the supplemental data can include imagery data. The supplemental data can be stored in memory on the satellite 500, in whole or in part. Additionally, the supplemental data can be stored on another satellite 500 and 500N, in whole or in part. Alternatively, the supplemental data can be stored and accessed from another location, such as ground-based computer storage.

For example, the image processor 504 can obtain imagery using the satellite imaging system 100 and detect a fishing vessel within a particular area off the Coast of Southwestern Alaska. The image processor 504 can determine a feature vector of the fishing vessel as well as a ground track of the fishing vessel. Additionally, the image processor 504 can obtain supplemental data including sailing plan information, fishing vessel licensure information, and fishing authorization information from a database stored on the satellite 500, which database can be periodically updated from a government fishing regulatory agency. The image processor 504 can compare the feature vector information and the ground track information of the fishing vessel against data in the sailing plan information, fishing vessel licensure information, and fishing authorization to determine whether the detected fishing vessel is authorized in the area. In an event that the fishing vessel is unauthorized, an alert can be transmitted from the satellite 500 to the Coast Guard, including location, heading, track, speed, and vector data associated with the fishing vessel. The Coast Guard can use this information, or the information can be used to control navigational equipment of a boat or helicopter, to make contact with the fishing vessel and further investigate.

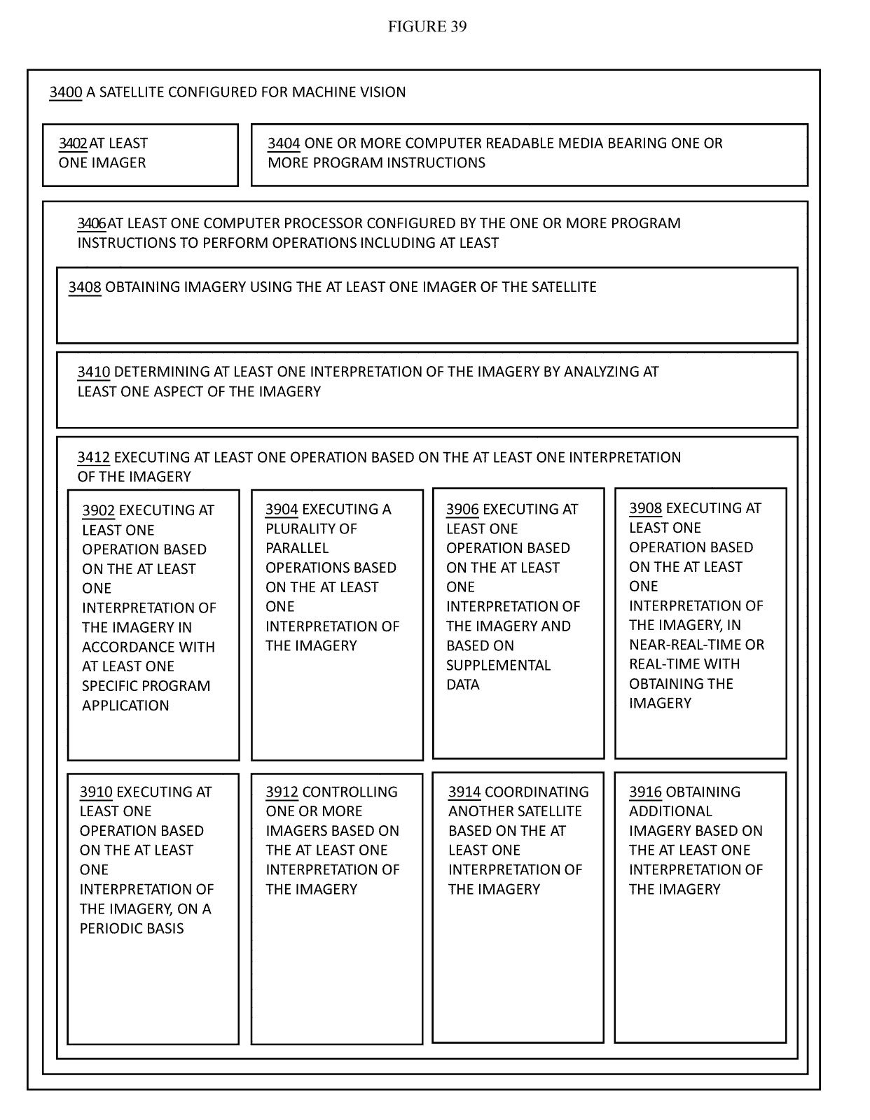

FIG. 39 is a component diagram of a satellite with machine vision, in accordance with an embodiment. In one embodiment, a satellite configured for machine vision 3400 includes, but is not limited to, at least one imager 3402; one or more computer readable media 3404 bearing one or more program instructions; and at least one computer processor 3406 configured by the one or more program instructions to perform operations including at least: executing at least one operation based on the at least one interpretation of the imagery in accordance with at least one specific program application at 3902; executing a plurality of parallel operations based on the at least one interpretation of the imagery at 3904; executing at least one operation based on the at least one interpretation of the imagery and based on supplemental data at 3906; executing at least one operation based on the at least one interpretation of the imagery, in near-real-time or real-time with obtaining the imagery at 3908; executing at least one operation based on the at least one interpretation of the imagery, on a periodic basis at 3910; controlling one or more imagers based on the at least one interpretation of the imagery at 3912; coordinating another satellite based on the at least one interpretation of the imagery at 3914; and obtaining additional imagery based on the at least one interpretation of the imagery at 3916.

In one embodiment, executing at least one operation based on the at least one interpretation of the imagery in accordance with at least one specific program application at 3902 includes the image processor 504 or the hub processor 502 executing an operation based on an application. The application can be a host application native to the satellite 500 for performing baseline image processing and/or interpretation operations. Alternatively, the application can be a locally hosted application that is developed by a 3^{rd} party entity and uploaded to the satellite 500. Further, the application can be a remotely hosted application (e.g., another satellite 500N or a ground-based application) that is developed by a 3^{rd} party entity and that communicates with the satellite 500. The 3^{rd} party application can perform raw image processing and interpretation operations or can interact via an API with a native application on the satellite 500 that performs some baseline image processing and interpretation operations. In the case of the latter, the 3^{rd} party application can perform field specific operations using results of the native application.

For example, a 3^{rd} party in the field of environmental research can develop an application to track and monitor instances of oil or gas spillage. The oil/gas spillage application can be uploaded to the satellite 500 whereby it interfaces with a native application via an API to obtain information on oil and gas spills. This information returned can include location, size, growth, movement, raw real-time imagery, and historical imagery, or the like as it pertains to oil/gas spills. The oil/gas spillage application can package and secure the information obtained in a proprietary manner and communicate the information to one or more recipients that subscribe to the application. The information can then be rendered on a mobile or tablet-based oil/gas spillage application and presented in a customized manner. For instance, the location of the oil/gas spillage can be pinpointed on a map along with information on the oil/gas spillage, such as an image of the suspected cause of the spill and data on the size, timing, spread, and impact of the oil/gas spill.

In one embodiment, executing a plurality of parallel operations based on the at least one interpretation of the imagery at 3904 includes the image processor 504 or the hub processor 502 executing parallel operations based on interpretation of imagery obtained via the satellite imaging system 100. The satellite 500 can host a plurality of applications that can each execute one or many operations on the same imagery. The operations can be executed in series or in parallel and substantially in synchronicity with one or more other operations. The operations can be similar, such as transmit data associated with an event to multiple different recipients. Alternatively, the operations can be different, such as transmit imagery to one recipient and control operations of another satellite. Operations possible can include outputting text, binary info, computer code, image data, video data, summary data, analysis reports, or other data.

For example, 3^{rd} party applications for consumer video viewing, national security, and illegal flight tracking can be operating in parallel on the satellite 500. The imagery obtained using the satellite imaging system 100 can be simultaneously interpreted using image processors 504 and 504N by each of the applications. The consumer video viewing application can identify and obtain pixel reduced video imagery associated with a particular neighborhood, the national security application can provide a binary indication that a missile site has become active, and the illegal flight tracking application can identify a location, speed, altitude, and a ground track of an unauthorized aircraft. Each of this information can be transmitted in parallel or in rapid sequence to disparate recipients, such as a consumer viewing app on a mobile phone, a military defense contractor system, and the FAA, respectively.

In one embodiment, executing at least one operation based on the at least one interpretation of the imagery and based on supplemental data at 3906 can include the image processor 504 executing an operation based on imagery obtained from the inner imager 202 and based on supplemental data local to or accessible from the satellite 500. The supplemental data can include non-image or image data obtained provided from a source other than the satellite or derived from satellite imagery. The supplemental data can be in a structured document, database, or other data source and can be locally stored, stored on another satellite 500N, or accessible from a ground source (e.g., cloud-based storage). The supplemental data can be updated at the satellite 500 on a real-time or non-real-time basis, such as periodically or on-demand. The image processor 504 can make operation determinations based upon or dependent upon the content of the supplemental data.

For example, the image processor 504N can obtain imagery associated with a spot imager 104. In real-time the image processor 504N can identify an aircraft traveling at 500 knots at FL 30 and on a ground track of 279 degrees over the Grand Canyon National Park at 13:04 Zulu time. The image processor 504N can obtain flight plan information provided by the FAA and determine from the flight plan information that the aircraft identified is DELTA flight 1442 enroute to Las Vegas with a scheduled arrival time of 14:10 Zulu time. Based on the foregoing, the image processor 504N can determine that the arrival time of flight 1442 will be ahead of schedule by fifteen minutes. Satellite 500 can then transmit the updated flight information to a ground-based application that tracks flight arrival and departure times for near-real-time consumer access.

In one embodiment, executing at least one operation based on the at least one interpretation of the imagery, in near-real-time or real-time with obtaining the imagery at 3908 includes, but is not limited, to the satellite 500 executing an operation near-instantly with obtaining the imagery. Near-real-time or real-time means at the same time as imagery is captured using the imaging system 100. Time periods associated with real-time or near-real-time can be on the order of nanoseconds to milliseconds to seconds. Non-real-time execution is also possible and can be associated with time periods on the order of milliseconds to minutes to days or even months or years. The specific urgency or execution response period can be determined based on an application specific parameter, a user request, a program request, or even based on conditions or interpretation of image data. That is, the satellite 500 can switch between real-time and non-real-time execution based on content of imagery detected or analyzed.

For example, in the content of an education application, the image processor 504N can obtain imagery and analyze the imagery in real-time for instances of educational material. Educational material can be specified and include ice calving, hurricanes, volcanic eruptions, or earthquakes, for example. In an event that no instances of educational material have been interpreted, the image processor 504N can operate on a periodic non-real-time response basis to intermittently transmit indications of inactivity. However, upon the image processor 504N detecting an instance of educational material, the education application can signal for real-time transmission outputs, such as to provide real-time video of the event in action along with a text or instant message alert of the availability of the video. In this manner, a classroom of students can witness in real-time the educational material as video that is provided from the satellite 500.

In one embodiment, executing at least one operation based on the at least one interpretation of the imagery, on a periodic basis at 3910 includes the satellite 500 executing an operation based on imagery captured using the satellite imaging system 100 on a periodic basis. The periodic basis can be regular or irregular. For instance, the periodic basis can be on fixed, variable, changing, or random intervals. Alternatively, the periodic basis can be on-demand, based on a program instruction, based on a user-request, or based on content of imagery. The periodic basis can also change from periodic to non-periodic based on a program instruction, user request, or based on content of imagery.

For example, in the context of a traffic management application, the satellite 500 can transmit traffic interpretation information for a specific highway/freeway at regular fifteen minute intervals. The traffic interpretation information can include overall time delay along a specified stretch of highway, location of slowdown causes, alternative routes, and best/fastest traffic lane for a given destination. Upon transmission, a traffic alert application system can receive and package the information for distribution to a mobile phone user-facing application, such that the mobile phone user-facing application is refreshed on a periodic basis. However, a request for additional information, such as real-time video of a car crash causing the backup, can be made from the mobile phone user-facing application. The satellite 500 can receive the request and provide a real-time or near-real-time responsive video of the crash. The video can be replicated at a ground-based server to satisfy multiple user request in real-time or near-real-time without requiring multiple parallel transmissions of the video from the satellite 500.

In one embodiment, the controlling one or more imagers based on the at least one interpretation of the imagery at 3912 includes the image processor 504 or the hub processor 502 steering, directing, aligning, panning, zooming, dwelling, fixating, or other similar action with respect to an imager of the global imaging array 102 or the spot imager 104, in response to an interpretation of imagery obtained using the satellite imaging system 100. Steering, directing, or aligning can include mechanical movement of one or more imagers. Panning and zooming can include digital panning and/or zooming, such as through selective pixel retention and decimation, or mechanical panning and/or zooming, such as moving or focusing one or imagers. Dwelling or fixating can include mechanically maintaining alignment with respect to a ground-based object or location independent of the orbital movement of the satellite 500. For example, image processor 504 can analyze and interpret imagery obtained using an inner imager 202 and based on the foregoing can control steering or alignment of the spot imager 104.

As a further example, in the context of an animal migration tracking application, image processor 504N can detect an instance of possible Caribou migration using imagery collected from the fisheye imager 210. Due to the relatively large field of view and lower spatial resolution imagery collected by the fisheye imager 210, the image processor 504N can direct the spot imager 104 to align with the possible Caribou to obtain higher spatial resolution imagery of the same. The image processor 504N can perform interpretive analysis using the higher spatial resolution imagery obtained from the spot imager 104, such as neural network analysis to confirm an instance of Caribou migration, quantifying the Caribou, and determining a location and travel speed of the Caribou. This data can be communicated from the satellite 500 to an environmentalist, a government agency, a hunting application, or an educational facility for further analysis.

In one embodiment, coordinating another satellite based on the at least one interpretation of the imagery includes satellite 500 coordinating satellite 500N based on imagery captured and analyzed using the imaging system 100 of satellite 500. Coordination can include repositioning the satellite 500N or another satellite, controlling one or more imagers of the satellite 500N, initiating an application or process on the satellite 500N, executing one or more operations or processes on the satellite 500N, communicating one or more parameters or arguments to an application operating on the satellite 500N, receiving information from the satellite 500N, or other related operation. Coordinating can be performed at intervals, periodically, based on a program or user request, in real-time, or based on imagery collected, analyzed, or interpreted. In certain embodiments, a plurality of applications operating on satellite 500 can independently coordinate the satellite 500N. For instance, coordination by one application on satellite 500 can include controlling steering or alignment of an imager on satellite 500N, while coordination by another application on satellite 500 can include initiating of a process on satellite 500N. Additionally, coordination can include transmission or receiving image or interpretive data between satellite 500 and satellite 500N. Satellite 500 can transmit raw-ultra high resolution or pixel reduced and compressed imagery to satellite 500N for further operation. Alternatively, satellite 500 can transmit interpretive results to satellite 500N to enable further analysis of imagery.

For example, in the context of a tsunami tracking application, satellite 500 can detect an instance of a tsunami at a particular oceanic location. Also interpreted by the satellite 500 are a travel speed, approximate size, and likely location of impact. This information can be communicated to a ground destination, such as a government agency responsible for emergency relief. The satellite 500 can continue to analyze and interpret real-time imagery collected from the imaging system 100 and feed the same to the ground-based recipient. However, as the satellite 500 transgresses along its orbital path and as the tsunami moves the satellite 500 may lose visual contact with the tsunami. Accordingly, the satellite 500 can transmit the current location of the tsunami to a next-in-line satellite 500N that is within the same orbital plane or an adjacent orbital plane to continue monitoring, analyzing, and interpreting imagery associated with the tsunami. Satellite 500N can initiate the tsunami tracking application, align a spot imager to the tsunami, and continue transmitting interpretive information to the ground-based recipient. The ground-based recipient may not be aware of the hand-off between satellite 500 and 500N.

In one embodiment, obtaining additional imagery based on the at least one interpretation of the imagery at 3916 includes the image processor 504 obtaining imagery from one imager of the satellite imaging system 100 in response to interpretation of imagery obtained from another imager of the satellite imaging system 100. The other imager can include an imager associated with a different tile, subfield, or satellite. The imagery can relate to additional imagery of a same object, feature, event, or aspect or the imagery can relate to additional imagery of a different object, feature, event, or aspect. Furthermore, the imagery can relate to infrared or visible imagery to supplement other imagery that is visible or infrared. The imagery can additionally include imagery obtained from a historical Earth video model to supplement real-time imagery captured.

For example, in the context of disaster-relief monitoring, inner imager 202 can obtain imagery around a burning industrial area. Image processor 504 can analyze the imagery and interpret the content of the imagery as being associated with an explosion and fire. The image processor 504 may not be able to discern the cause or location of the explosion due to that event being outside field of view 406 at the time of its occurrence. Accordingly, image processor 504 can query a historical earth video model created from imagery captured by other imagers of the satellite imaging system 100 and satellite 500N. The image processor 504 can analyze high resolution earth video imagery to determine the first instance of fire or smoke in the industrial area and identify the root cause or location of the explosion. The causation or location of the explosion can be communicated along with other interpretative data to a first responder or to people proximately affected by the fire. In one particular embodiment, the satellite 500 can additionally deploy one or more resources to the location, such as aerial unmanned vehicles to further surveil the fire.

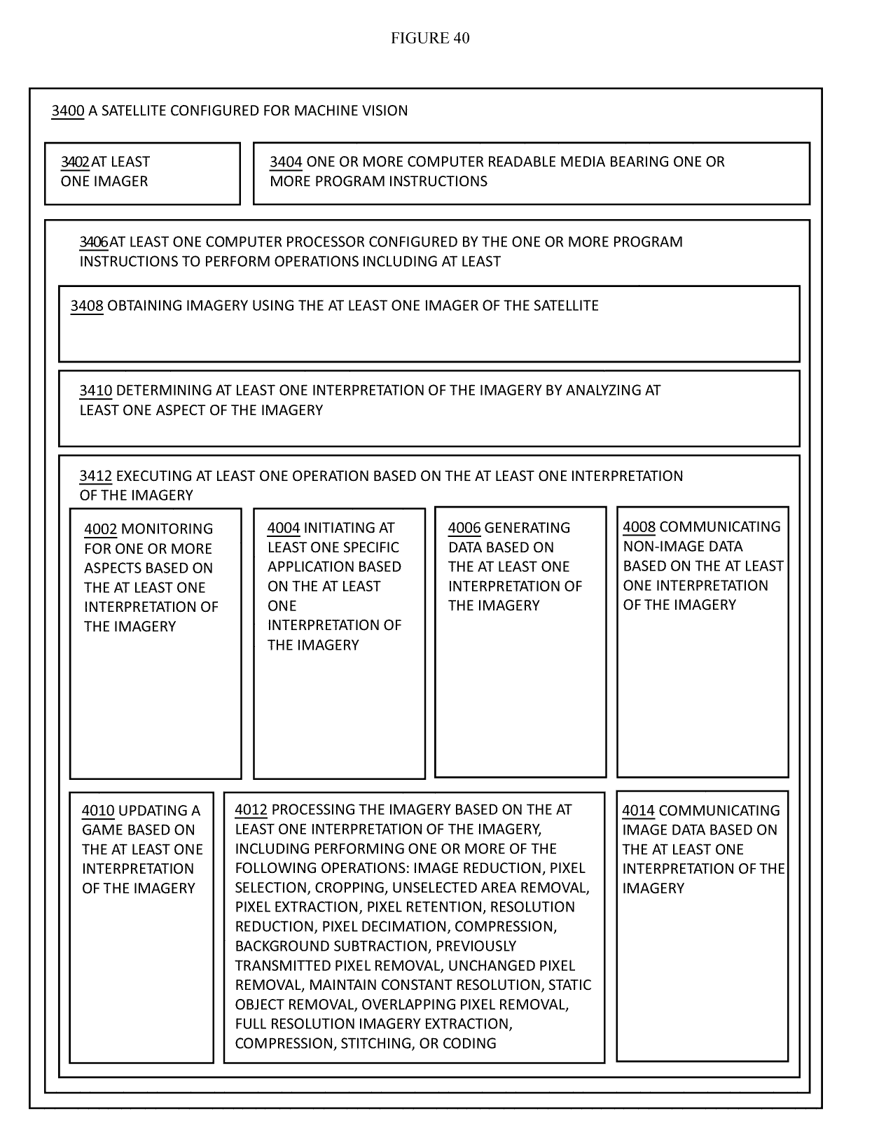

FIG. 40 is a component diagram of a satellite with machine vision, in accordance with an embodiment. In one embodiment, a satellite configured for machine vision 3400 includes, but is not limited to, at least one imager 3402; one or more computer readable media 3404 bearing one or more program instructions; and at least one computer processor 3406 configured by the one or more program instructions to perform operations including at least: monitoring for one or more aspects based on the at least one interpretation of the imagery at 4002; initiating at least one specific application based on the at least one interpretation of the imagery at 4004; generating data based on the at least one interpretation of the imagery at 4006; communicating non-image data based on the at least one interpretation of the imagery at 4008; updating a game based on the at least one interpretation of the imagery at 4010; processing the imagery based on the at least one interpretation of the imagery, including performing one or more of the following operations: image reduction, pixel selection, cropping, unselected area removal, pixel extraction, pixel retention, resolution reduction, pixel decimation, compression, background subtraction, previously transmitted pixel removal, unchanged pixel removal, maintain constant resolution, static object removal, overlapping pixel removal, full resolution imagery extraction, compression, stitching, or coding at 4012; and communicating image data based on the at least one interpretation of the imagery 4014.

In one embodiment, monitoring for one or more aspects based on the at least one interpretation of the imagery at 4002 includes the image processor 504N monitoring for one or more aspects based on at least one interpretation of imagery by the image processor 504. An interpretation can include any of those referenced and illustrated herein, such as object recognition, feature recognition, event detection, activity detection, change detection, movement detection, pixel change, ground contact, obscuration, or another analysis or determinative output. The interpretation can be performed using the image processor 504 or 504N, the hub processor 502, or any other processing component on-board the satellite 500 or 500N. The monitoring can include initiation of an application or process on any of the image processor 504 or 504N or any other processing component on-board the satellite 500 or 500N. The monitoring can include, for instance, interpreting imagery for a specific purpose, such as recognition of a specific object, detection of a specific event or action, recognition of a specific feature, detection of a specific change, detection of a specific movement, detection of a specific pixel change, monitoring a particular area, or any other specific instance of analysis or determinative output described and/or illustrated herein. Thus, in one instance, interpretation by one image processor 504 can initiate more specific monitoring by the same image processor 504 or by a different image processor 504N, such as an image processor 504N associated with a different field of view or associated with a different satellite 500N.

For example, in the context of a national security application, the image processor 504 may detect an instance of naval warship movement off the coast of Russia during a periodic analysis of imagery for naval warships. Further interpretation of the imagery can be performed, including generating feature vector information, position information, heading and track information, groundspeed information, size information, and number information associated with the warships. The interpretation data can be communicated to a ground based system, such as the U.S. Navy systems, for further analysis. Additionally, the image processor 504 can communicate interpretative output to other image processors 504N of the satellite 500 and of other satellites 500N to prioritize and further assist in warship monitoring in and around the Russian coast. For instance, the other image processors 504N can begin monitoring for naval warships or other vessel activity on a real-time continuous basis and can benefit from an enhanced neural network of naval warship recognition information that has been populated with the interpretative output of the image processor 504. The additional monitoring by image processors 504N therefore can enable interpretive analysis with respect to imagery associated with other fields of view, such as outer field of view 404, fisheye field of view 402, and spot field of view 408. Further, other satellites 500N can begin interpretive analysis with respect to imagery associated with other sea-portion areas.

In one embodiment, initiating at least one specific application based on the at least one interpretation of the imagery at 4004 includes image processor 504 initiating an application based on interpretation of imagery by the image processor 504. Image processor 504 can execute a number of applications in series or in parallel and can utilize processing resources of other image processors 504N, the hub processor 502, or another processing component on-board the satellite 500. Applications can be native or custom, such as by third party entities. In certain instances, interpretation of imagery by the image processor 504 for one application or purpose can trigger further interpretation by the image processor 504 for another application or purpose. For instance, a native application to the satellite 500 can perform baseline operations on imagery collected using the imaging system 100. Baseline operations can include neural network or other object recognition, event or activity detection, change detection, quantification or size determination, global positioning determination, time determination, or the like. The output of the baseline operations can then be used to initiate further processes or applications that are dependent or associated with the output.

For example, a traffic management application can be dormant or operating at a low power state, such as sampling outputs from a native process of the satellite 500 for a high density of vehicles within a particular area of GPS coordinates associated with a road, freeway, or highway. For instance, upon the traffic management application receiving an indication of more than fifty percent coverage of vehicles within an area associated with I-5 near the Portland/Vancouver border near Southern Washington, the traffic management application can wake-up or enter an active state. In the active state, the traffic management application can begin additional interpretative analysis on the real-time imagery collected by the imaging system 100, such as determining traffic volume, speed, trends, alternative routes, fastest lanes, causes of slowdowns, and predicted travel time. The additional interpretive output can be communicated to a ground-based system without imagery to populate data of a smartphone or tablet application for consumer traffic awareness.

In one embodiment, generating data based on the at least one interpretation of the imagery at 4006 includes image processor 504 generating additional data based on the content of imagery analyzed by the image processor 504. The generating can be performed in real-time or near real-time with image collection or with interpretive output or can be performed periodically based on real-time or accumulated imagery or interpretive results. The additional data can be image or non-image based, such as historical image data, analysis information, trend data, a heat map, pattern information, recommendations, predictions, control information, or other similar data. The additional data can be stored at the satellite 500, communicated to another satellite 500N, or communicated to a ground-based system with or without the underlying imagery or interpretative output.

For instance, in a neighborhood fire detection application context, real-time imagery can be obtained from the global imaging array 102 and analyzed by the image processor 504 for instances of fire affecting a house or building within a particular neighborhood. Upon detecting an instance of a fire, the image processor 504 can further interpret the imagery to determine location, size, trend, causation, intensity, or other related-information regarding the fire. Based on the interpretive data, such as location and trend data, the image processor can generate additional information such as a sequence of control instructions for alerting emergency responders and affected people and control instructions for programming vehicle navigation systems with an evacuation route. The control instructions can be, for example, i) transmit coordinates, trend, and intensity data to firefighters within a determined zip code; (ii) post imagery and recommendations to determined town social media account; (iii) program navigation systems of vehicles within a specified radius of the fire with an evacuation route; and (iv) control a plurality of manned or unmanned aerial fire-fighting vehicles to dispense fire-retardant on the fire.

In one embodiment, communicating non-image data based on the at least one interpretation of the imagery includes the satellite 500 communicating non-image data via the wireless communication interface 506. The communication of non-image data can be in real-time or near-real-time with interpretation of the imagery or can be random, scheduled, periodic, or on-demand. The non-image data can include alphanumeric text, binary data, a program, a set of instructions, a control signal, a function call, a parameter, a numerical value, GPS coordinates, an alphanumeric description, an argument, a report, an analysis, a trend, a summary, a notification, or other related non-image data. The non-image data can be transmitted directly to a ground station or system or device or can be transmitted to another satellite 500N or other satellite.

For example, in the context of an ice calving application, the image processor 504 can detect and interpret instances of Antarctic ice-calving. Interpretations can include location, size, time, area, or other data related to the calving events. The image processor 504N can collect and store the interpretative data of the course of a summer period and prepare graphical charts, summary text, and maps, for example, for transmission at a specified period. The raw interpretive data and/or any of the graphical charts, summary text, and maps can be transmitted to a ground-based system that distributes the non-image data to educational facilities, government agencies, and interested consumers for further review. Image data associated with the calving, such as high-resolution video of calving events can also be transmitted with the non-image data or can be provided on request.

In one embodiment, updating a game based on the at least one interpretation of the imagery at 4010 includes the satellite 500 transmitting event information to at least one ground-based system for populating a smartphone, tablet, or computer game. For example, the information can include event type, event location, event time, or one or more characteristics of the event such as size, trend, population, area, objects, features, or the like. The information can be transmitted in real-time or near-real-time as occurrence of the event to enable one or more games to be tailored and customized to real-time occurrences. Games can include treasure hunt style, POKEMON GO style, or other real-world interaction games.

For example, in a POKEMON GO game context, the satellite 500 can recognize a tornado or tornado damage and transmit the location coordinates, area affected, estimation of damage, or other information related to the tornado or tornado damage to a ground-based server that analyzes the information and controls parameters of POKÉMON GO. The instance of a tornado or tornado damage can, for instance, result in increased rewards (e.g., candy, XP, or stardust), increased spawn rates, creation of limited edition POKÉMON for the disaster, offers of free items (e.g., 1-use incubators or 8-hour lures) in the POKÉMON GO game. The changes in the POKÉMON GO game can aid in charitable relief for those affected by the tornado or tornado damage. Other events recognized by the satellite 500 can be used to make other similar changes in the POKÉMON GO game, such as environmental, ecological, geological, or human activity related events. The modification of POKÉMON GO to actual real-world detected events in real-time or near-real-time can help maintain interest in the game and generate or maintain momentum with respect to user-engagement.

In one embodiment, the processing the imagery based on the at least one interpretation of the imagery, including performing one or more of the following operations: image reduction, pixel selection, cropping, unselected area removal, pixel extraction, pixel retention, resolution reduction, pixel decimation, compression, background subtraction, previously transmitted pixel removal, unchanged pixel removal, maintain constant resolution, static object removal, overlapping pixel removal, full resolution imagery extraction, compression, stitching, or coding at 4012 can be performed using the image processor 504, image processor 504N, hub processor 502, or other processor on-board the satellite 500. As discussed and illustrated herein, the imaging system 100 can result in continuous capture of hundreds of Mbps or event Gbps in imagery. The image processors 504 and 504N can process and interpret the imagery in real-time or near-real-time to, for instance, identify an object, detect an event or activity, monitor change, quantify information, analyze data, or other related or disclosed operations. Based on interpretive output, the image processor 504 can perform additional image reduction operations, such as those listed or described or illustrated herein. This image reduction operation can enable retention of pixel data of interest or related to an object, event, activity, change, or feature and transmission or storage of the retained pixel data using bandwidth or capacity constrained resources (e.g., a communication link with bandwidth capacity of a few hundred Mbps).

For example, in the context of an agriculture/drought management application, the satellite 500 can collect ultra-high resolution imagery associated with farmland. The image processor 504, for instance, can analyze the imagery to determine instances of drought, malnutrition, or infestation, such as by comparing expected coloration to collected coloration of the farmland. In response to detecting an instance of possible drought, malnutrition, or investigation, the image processor 504 can retain pixel data associated with that farmland and decimate, remove, or store other unrelated pixel data. In the instance of a wide-area of affected farmland, the image processor 504 can further reduce the resolution of the retained pixel data to maintain a resolution that is that of a highest expected screen resolution (e.g., the screen resolution of a tablet computer that will view the imagery). Moreover, the image processor 504 or the hub processor 502 can further compress the retained pixel data before transmitting the pixel data and/or any interpretative output data to a ground-station.

In one embodiment, the communicating image data based on the at least one interpretation of the imagery at 4014 can include the satellite 500 communicating imagery in response to interpretation by an image processor 504 of the imagery. The imagery can be reduced, compressed, stitched, or otherwise processed. Alternatively, the imagery can be raw ultra-high resolution imagery. The imagery can be communicated in real-time or on a periodic, delayed, on-demand, or other non-real-time basis. In certain instances, the imagery is transmitted based on a determination that bandwidth is available for communication from the satellite 500 to a ground station or other satellite 500N.

For example, in the context of a mapping application, the satellite 500 can process ultra-high resolution imagery captured by the imaging system 100 to interpret one or more instances of a new highway being operative. For instance, a highway contained within the imagery can be determined by the image processor 504 to include one or more cars traveling above a specified speed threshold for a first time. Real-time ultra high resolution imagery of the highway can be stored in memory local to the satellite 500 until such time that bandwidth is available. Upon detecting that bandwidth is available, the ultra-high resolution imagery can be obtained from storage and transmitted to a ground-based station for updating a map with high-resolution imagery of the new highway.

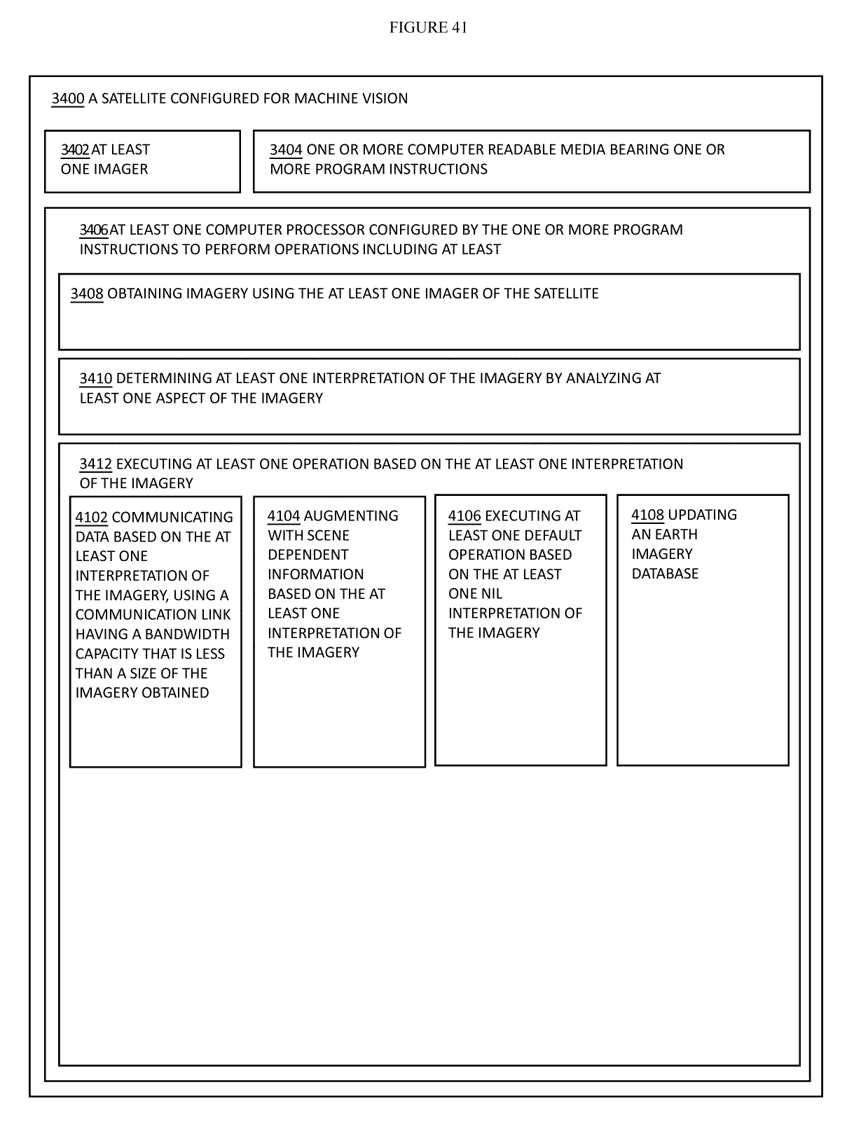

FIG. 41 is a component diagram of a satellite with machine vision, in accordance with an embodiment. In one embodiment, a satellite configured for machine vision 3400 includes, but is not limited to, at least one imager 3402; one or more computer readable media 3404 bearing one or more program instructions; and at least one computer processor 3406 configured by the one or more program instructions to perform operations including at least: communicating data based on the at least one interpretation of the imagery, using a communication link having a bandwidth capacity that is less than a size of the imagery obtained at 4102; augmenting with scene dependent information based on the at least one interpretation of the imagery at 4104; executing at least one default operation based on the at least one nil interpretation of the imagery at 4106; and updating an Earth imagery database at 4108.

In one embodiment, communicating data based on the at least one interpretation of the imagery, using a communication link having a bandwidth capacity that is less than a size of the imagery obtained at 4102 includes the satellite 500 communicating data via the wireless communication interface 506. The satellite image system 100 can collect ultra-high resolution imagery on the order of tens to hundreds or even thousands of Gbps. However, the wireless communication interface 506 can be limited to a bandwidth capacity of tens to hundreds to thousands of Mbps. Thus, the amount of imagery available for transmission can far exceed by at least one order of magnitude the bandwidth capacity of the communication interface 506. The image processors 504, 504N, the hub processor 502, or other processor on-board the satellite 500 can perform edge processing or on-board processing of the image data at the satellite 500 to analyze and interpret the data prior to any transmission. The analysis and interpretation can result in interpretive output that can require merely a few bytes per second and that can be easily packaged and transmitted via the wireless communication interface 506 to a ground-based station or to another satellite 500N.

For example, in the context of an Artic shipping lane application, the satellite 500 can obtain ultra high resolution imagery of the Artic on the order of 1-4 meter spatial resolution. The image processors 504 and 504N can independently analyze the imagery to identify gaps between the ice shelves or icebergs sufficient for ship traffic. Further analysis can be made of the speed or rate of closure or separation between proximate ice shelves or icebergs. Based on the foregoing, the image processors 504 and 504N can apply the gap and closure information to a model and output predictions regarding available shipping lanes for navigating through the Artic. The predicted shipping lane information can be binary, vector, alphanumeric text, or parameter values and can be a mere few to hundreds of bytes of data. The predicted shipping lane information can be transmitted via the wireless communication link 506 to a ground-based navigation data provider for distribution or can be uploaded directly to shipping vessel navigation systems without requiring any imagery to be transmitted.

In one embodiment, augmenting with scene dependent information based on the at least one interpretation of the imagery at 4104 includes the hub processor 502 augmenting image data or non-image data with scene dependent textual, graphical, or symbol information. The satellite 500 can identify objects, structures, vehicles, activities, events, features, occurrences, or the like based on edge-processing performed on imagery collected via the imaging system 100. Based on the interpretive output information, the hub processor 502 can obtain dependent augmentation data, such as search engine results, news, articles, links, tweets, social media threads, events, product information, travel information, social media posts, additional imagery, or any other related data. This augmented data can be communicated with the imagery or with interpretive results of the imagery via the wireless communication interface to a ground-based station. The augmented data can be obtained from local storage within the satellite 500, from another satellite 500, or from a ground-based source. The augmented data can be obtained on demand from a ground-based source or the augmented data can be periodically uploaded to the satellite 500 for usage. Alternatively, the satellite 500 can transmit image or non-image interpretive output via the communication interface 506 whereby the augmented data is combined prior to distribution to the end-user or destination entity.

For example, in the context of a travel agent application, the satellite 500 can obtain real-time ultra high resolution imagery and recognize instances of geological or weather events that may be of interest to tourists. The geological events can include lava flow, a geyser eruption, a fissure in an ice shelf, a sinkhole, a rock slide, snow at a ski resort, or the like. Imagery associated with the event can be obtained and transmitted from the satellite 500 via the wireless communication interface 506 in association with flight, hotel, car rental, or vacation packages tied to the geological or weather event, such as time and location dependent. Consumers of the imagery can be presented with the imagery along with the travel information to enable a further experience with the event.

In one embodiment, the executing at least one default operation based on the at least one nil interpretation of the imagery at 4106 includes the image processor 504 executing a default imager alignment, a default analysis, or a default retention process based on an absence of an meaningful information within imagery captured by the imaging system 100. The image processor 504 can analyze the imagery collected via the imaging system 100 and determine that there are no recognizable features, events, actions, objections, activities, occurrences, or other aspect. In response, the image processor 504 can execute default processes in response to the same, which can include aligning the spot imager 104 to a straight or perpendicular position, monitoring for baseline occurrences or aspects such as movement or pixel changes, or decimating all imagery obtained following the analysis. The image processor 504 can continue to monitor real-time imagery obtained using the imaging system 100 and, in response to the nil interpretation no longer being true, can switch to customized or non-default states, operations, or processes.

For example, in nil interpretation mode, the spot imagers 104 and 104N can be aligned straight and perpendicular to the plate 108 while the image processors 104 and 104N can perform baseline operations such as pixel change or movement recognition operations on collected imagery of the imaging system 100. Thus, the nil interpretation mode can result in more efficient processing and reduced power consumption because of the limited operations that are performed with respect to the imagery. Additionally, storage requirements are limited in the nil interpretation mode as the image processors 104 and 104N can store, discard, delete, or remove all pixel data due to the absence of any interesting aspects. However, in response to the image processor 504 detecting motion or a pixel change, additional more intensive processing operations can be triggered such as: aligning a spot imager on the position of change to collect additional high resolution imagery, performing neural network analysis to recognize the object associated with the change, and triggering one or more additional image processors 504N to begin analyzing for similar changes in their respective fields of view (e.g., outer cone field of view 404).

In one embodiment, updating an Earth imagery database at 4108 includes the hub processor 502 obtaining imagery using the imaging system 100 and adding the imagery to a historical Earth imagery database. The imagery stored can be still imagery or video imagery, which can be organized according to time to provide a substantially complete imagery archive of Earth. The historical Earth imagery database can be local to the satellite 500 or the imagery can be transmitted to a ground-based location. In the case of transmitting the imagery, bandwidth availability can be confirmed prior to transmission and any prior transmitted, unchanged, or static pixel data can be omitted and gap-filled post-transmission using previously transmitted imagery from a ground source. In certain instances, vector data is transmitted in lieu of at least some imagery, which vector data can be used to recreate the image data post transmission by a ground system.

For example, the image processors 504 and 504N can collect raw ultra-high resolution video imagery of field of view 400 at approximately 20 frames per second. Satellites 500N can similarly collect raw ultra-high resolution video imagery of respective fields of view 400N. Thus, video imagery can be collected in real-time or near-real-time of substantially the entirety of Earth. Each satellite 500 and 500N can transmit video imagery in real-time or as bandwidth becomes available to an Earth-based station for addition to an Earth video archival database. To limit or reduce bandwidth requirements, the video imagery communicated from the satellites 500 and 500N can be reduced to extract unchanged pixels, static pixels, or previously communicated objects. The historical high resolution Earth video archive is available for rewinding, playing, fast-forwarding, and otherwise viewing substantially any point on Earth at substantially any point in time. In one particular embodiment, imagery of the Earth video archive can be analyzed and interpreted for accident investigations, disaster investigations, missing asset investigation, predictive modeling, neural network model building, and any other function or operation disclosed or illustrated herein related to interpretive analysis of non-real-time imagery.

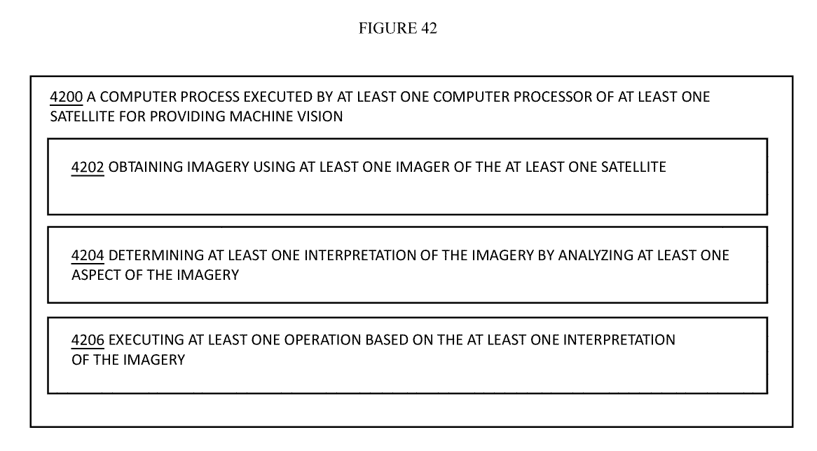

FIG. 42 is a flow diagram of a process executed by a satellite for providing machine vision, in accordance with an embodiment. In one embodiment, a computer process 4200 executed by at least one computer processor of at least one satellite for providing machine vision includes, but is not limited to, obtaining imagery using at least one imager of the at least one satellite at 4202; determining at least one interpretation of the imagery by analyzing at least one aspect of the imagery at 4204; and executing at least one operation based on the at least one interpretation of the imagery at 4206. The computer process can be executed by any of the image processors 504 and 504N, the hub processor 502, or any other computer processor on-board the satellite 500. Computer process 4200 can include any one or more of the operations or embodiments discussed and illustrated with respect to FIGS. 35-40.

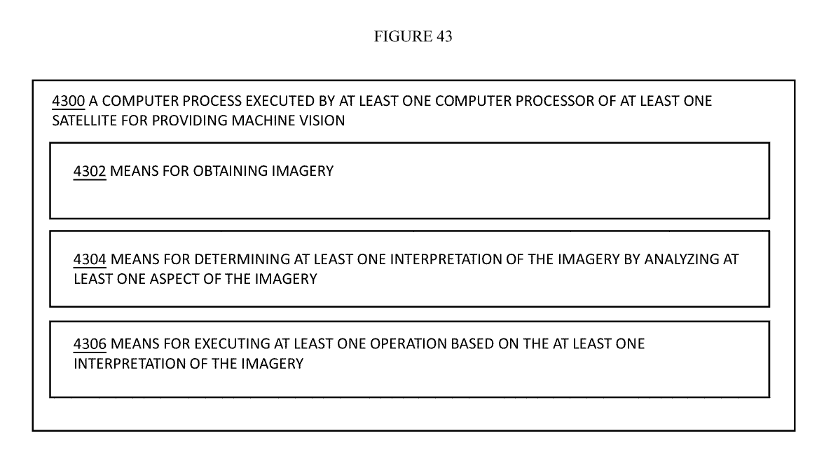

FIG. 43 is a component diagram of a satellite with machine vision, in accordance with an embodiment. In one embodiment, a satellite for providing machine vision 4300 includes, but is not limited to, means for obtaining imagery at 4302; means for determining at least one interpretation of the imagery by analyzing at least one aspect of the imagery 4304; and means for executing at least one operation based on the at least one interpretation of the imagery 4306. Satellite 4300 can include satellite 500. The means for obtaining imagery at 4302 can include the satellite imaging system 100. The means for determining at least one interpretation of the imagery by analyzing at least one aspect of the imagery 4304 can include the image processor 504, the image processor 504N, the hub processor 502, or any computer processor on-board the satellite 500. The means for executing at least one operation based on the at least one interpretation of the imagery 4306 can similarly include the image processor 504, the image processor 504N, the hub processor 502, or any computer processor on-board the satellite 500. Specific structures and algorithms are provided for satellite 4300 throughout the specification and drawings, including, for example, that related to FIGS. 1-5 and FIGS. 35-40.

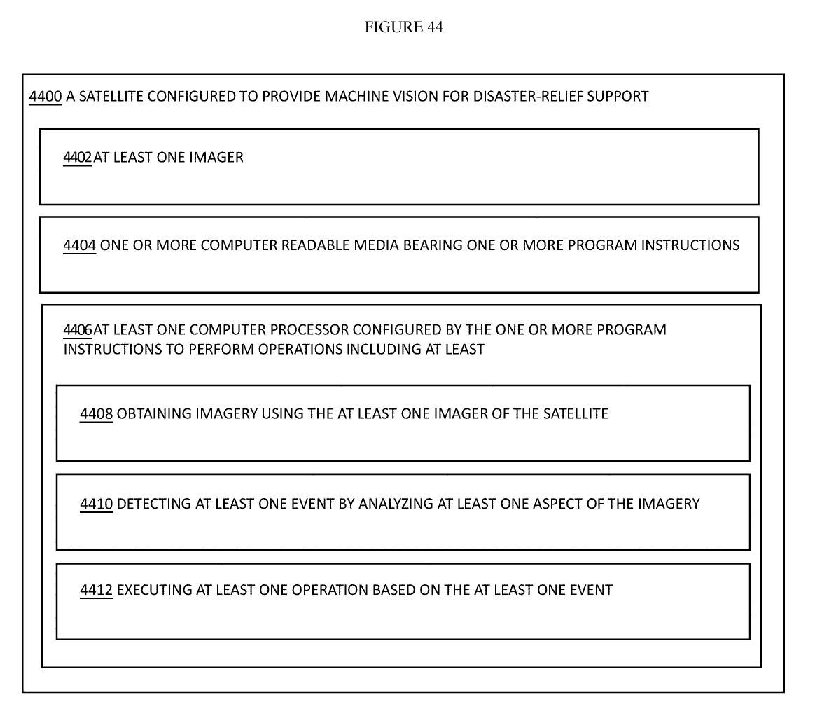

FIG. 44 is a component diagram of a satellite with machine vision for disaster relief support. In one embodiment, a satellite 4400 configured to provide machine vision for disaster-relief support, includes, at least one imager 4402; one or more computer readable media 4404 bearing one or more program instructions; and at least one computer processor 4406 configured by the one or more program instructions to perform operations including at least: obtaining imagery using the at least one imager of the satellite at 4408; detecting at least one event by analyzing at least one aspect of the imagery at 4410; and executing at least one operation based on the at least one event 4412. For example, satellite 4400 can comprise satellite 500 or 500N and the at least one imager 4402 can be any of the imagers of the satellite imaging system 100. The at least one computer processor 4406 can comprise image processor 504, image processor 504N, hub processor 502, or another computer processor on-board satellite 500. The satellite system 4400 can be used in the context of any of the following disaster relief scenarios: hurricane, typhoon, tornado, tsunami, windstorm, earthquake, flood, fire, or another damage causing event. Embodiments of the satellite system 4400 are further described and illustrated herein.

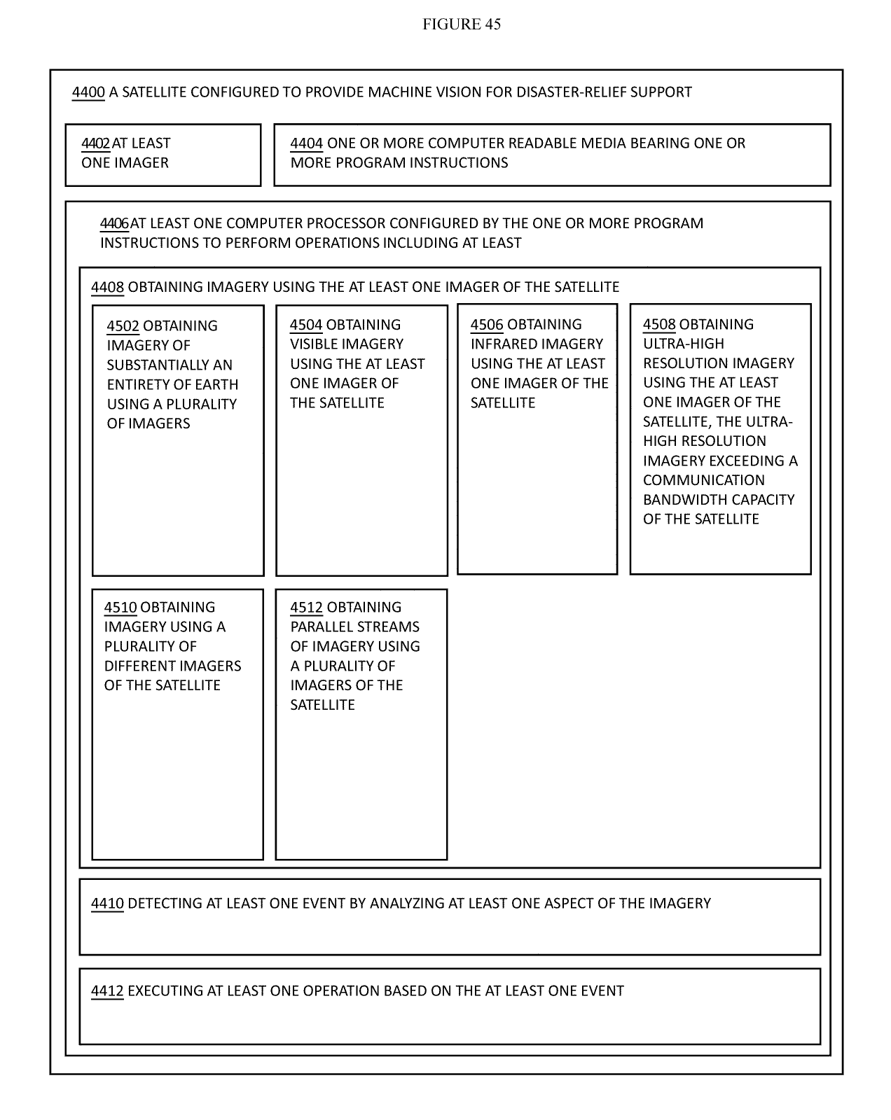

FIG. 45 is a component diagram of a satellite with machine vision for disaster relief support. In one embodiment, a satellite 4400 configured to provide machine vision for disaster-relief support, includes, at least one imager 4402; one or more computer readable media 4404 bearing one or more program instructions; and at least one computer processor 4406 configured by the one or more program instructions to perform operations including at least: obtaining imagery of substantially an entirety of Earth using a plurality of imagers at 4502; obtaining visible imagery using the at least one imager of the satellite at 4504; obtaining infrared imagery using the at least one imager of the satellite at 4506; obtaining ultra-high resolution imagery using the at least one imager of the satellite, the ultra-high resolution imagery exceeding a communication bandwidth capacity of the satellite at 4508; obtaining imagery using a plurality of different imagers of the satellite at 4510; and obtaining parallel streams of imagery using a plurality of imagers of the satellite at 4512.

In one embodiment, obtaining imagery of substantially an entirety of Earth using a plurality of imagers at 4502 includes the constellation of satellites 500 and 500N (FIG. 16) each obtaining imagery using respective imaging systems 100. For example, satellites 500 and 500N can each include a global imaging array 102 and a plurality of spot imagers 104. The global imaging array 102 can include inner imaging units 202, outer imaging units 204, and a fisheye imaging unit 210 to enable capture of imagery associated with field of view 400. Accordingly, each satellite 500 and 500N can capture real-time ultra high resolution video that in sum comprises video imagery of substantially all of Earth. The imagery can include content of ocean, ice, land, structures, or weather, for instance, which can be analyzed and interpreted on-board each satellite 500 and 500N.

In one embodiment, obtaining visible imagery using the at least one imager of the satellite at 4504 includes satellite 500 obtaining visible imagery using the global imaging array 102 or the spot imager 104. Any of the inner imagers 202, the outer imagers 204, the fisheye imagers 210, or the spot imagers 104 can be configured with a visible image sensor to enable capture of imagery associated with the visible light spectrum (e.g., 390 nm-700 nm light wavelength). The visible imagery can include real-time or near-real-time still imagery or video imagery, such as at approximately twenty frames per second or more. Visible imagery can include content such as a cloud formation, a fissure in Earth, a ice calving event, a tornado, water expanding over a river bank, a massive oceanic perturbance, smoke, or flames, for example.

In one embodiment, obtaining infrared imagery using the at least one imager of the satellite at 4506 includes satellite 500 obtaining infrared imagery using the global imaging array 102 or the spot imager 104. Any of the inner imagers 202, the outer imagers 204, the fisheye imagers 210, or the spot imagers 104 can be configured with an infrared image sensor to enable capture of imagery associated with the infrared light spectrum (e.g., 700 nm-1 mm light wavelength). Furthermore, any of the inner imagers 202, the outer imagers 204, the fisheye imagers 210, or the spot imagers 104 can include a beam splitter to enable simultaneous capture of infrared and visible imagery. The infrared imagery can include real-time or near-real-time still imagery or video imagery, such as at approximately twenty frames per second or more. Infrared imagery can include temperature gradations or heat sources, enabling visualization of cloud/weather obscured content such as a fire, animals, people, explosions, or the like.

In one embodiment, obtaining ultra-high resolution imagery using the at least one imager of the satellite, the ultra-high resolution imagery exceeding a communication bandwidth capacity of the satellite at 4508 includes the imaging system 500 collecting real-time or near-real-time ultra-high resolution imagery using a plurality of imagers, such as inner imagers 202, outer imagers 204, fisheye imagers 210, and spot imagers 104. Each imager can capture imagery on the order of approximately twenty or more megapixels at a rate of approximately twenty or more frames per second, resulting in approximately hundreds of Gbps in image data. The satellite 500 can include a communication link 506 that has a bandwidth capacity of approximately tens or hundreds of Mbps. Thus, satellite 500 can collect real-time ultra-high resolution imagery of a flooding event in a major city, including details as to the flood location and movement relative to roads, houses, and even vehicles or people. The image data amount collected of the flood event can and likely will exceed the capacity for transmission from the satellite 500 to a ground station, such as by at least an order of magnitude or more.

In one embodiment, obtaining imagery using a plurality of different imagers of the satellite at 4510 includes obtaining imagery using the satellite imaging system 100 that is associated with any of the inner cone field of view 406 or its subfield, the outer cone field of view 404 or its subfields, the fisheye field of view 402, or the spot cone fields of view 408 and 408N. An array of inner imagers 202, an array of outer imagers 204, at least one fisheye imager 210, or an array of spot imagers 104 can simultaneously and in parallel capture the ultra-high resolution video imagery associated with each of the respective fields of view. For example, an inner imager 202 can capture high resolution imagery associated with a drought over a first geographical area, at approximately twenty-five meters in spatial resolution. Simultaneously, an outer imager 204 can capture high resolution imagery associated with the drought over a second geographical area that circumscribes the first geographical area, at approximately fifty meters in spatial resolution. Additionally, and simultaneously, the spot imagers 104 and 104N can scan the first geographical area and the second geographical area associated with the drought, at approximately one-five meters in spatial resolution. The fisheye imager 210 can also simultaneously capture high resolution imagery associated with the drought over the first and second geographical areas and a third broader area, at approximately hundreds of meters in spatial resolution.

In one embodiment, obtaining parallel streams of imagery using a plurality of imagers of the satellite at 4512 includes an array of image processors 504 and 504N obtaining imagery in parallel from respective inner imagers 202, outer imagers 204, fisheye imager 210, and spot imagers 104. The image processors 504 and 504N are on-board satellite 500 and can obtain ultra-high resolution imagery in real-time or near-real-time as the imagery is captured. In certain cases, the image processors 504 and 504N are each dedicated to one of the inner imagers 202, the outer imagers 204, the fisheye imager 210, and the spot imagers 104. In another case, the image processors 504 and 504N are part of an image processor bank, where at least one of the image processors 504 and 504N can be dynamically assigned to any one of the inner imagers 202, the outer imagers 204, the fisheye imager 210, and the spot imagers 104. For example, the image processors 504 and 504N can obtain parallel ultra-high resolution imagery associated with an earthquake and associated damage. Image processor 504 can obtain video imagery of a downtown area of a city while image processor 504N can obtain video imagery of suburbs surrounding the downtown area of the city. Another image processor 504N can obtain video imagery of focused portions of the city where destruction has occurred (e.g., building collapse, road damage, flooding, etc.).

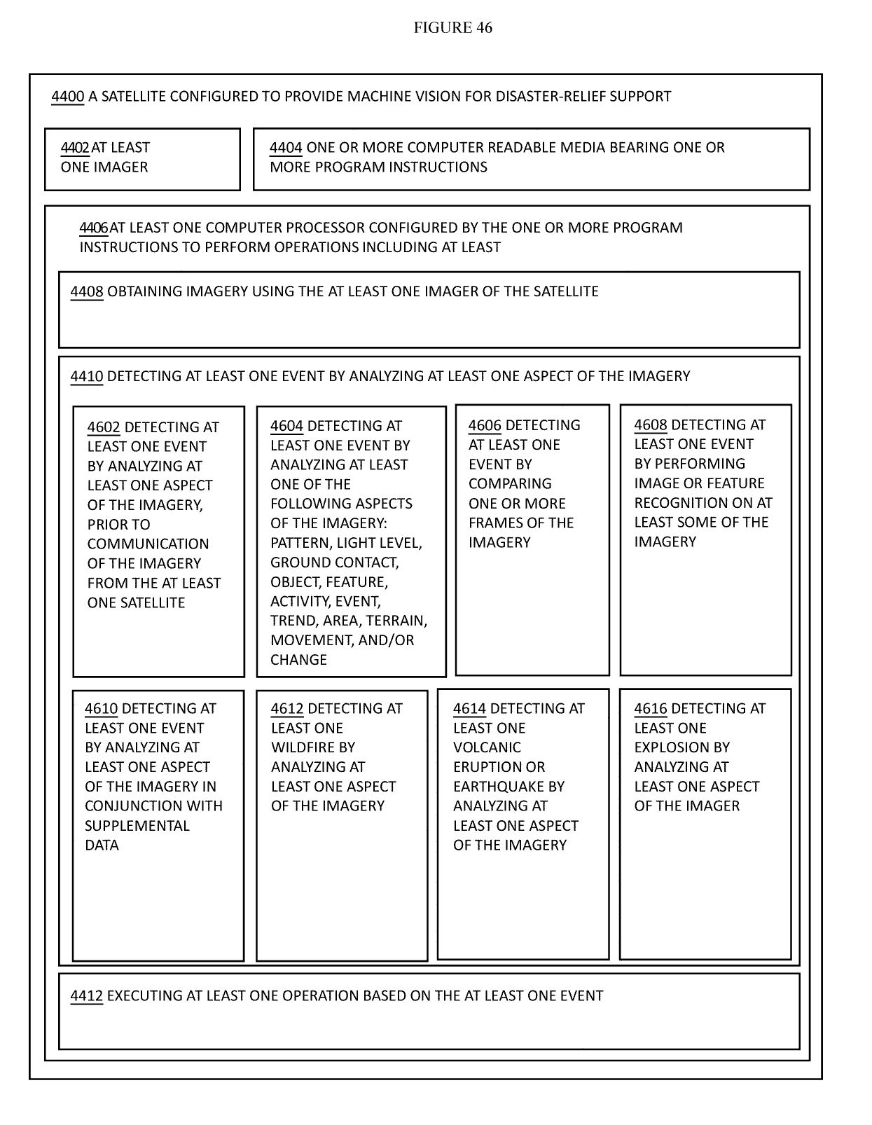

FIG. 46 is a component diagram of a satellite with machine vision for disaster relief support. In one embodiment, a satellite 4400 configured to provide machine vision for disaster-relief support, includes, at least one imager 4402; one or more computer readable media 4404 bearing one or more program instructions; and at least one computer processor 4406 configured by the one or more program instructions to perform operations including at least: detecting at least one event by analyzing at least one aspect of the imagery, prior to communication of the imagery from the at least one satellite at 4602, detecting at least one event by analyzing at least one of the following aspects of the imagery: pattern, light level, ground contact, object, feature, activity, event, trend, area, terrain, movement, and/or change at 4604, detecting at least one event by comparing one or more frames of the imagery at 4606, detecting at least one event by performing image or feature recognition on at least some of the imagery at 4608, detecting at least one event by analyzing at least one aspect of the imagery in conjunction with supplemental data at 4610, detecting at least one wildfire by analyzing at least one aspect of the imagery at 4612, detecting at least one volcanic eruption or earthquake by analyzing at least one aspect of the imagery at 4614, or detecting at least one explosion by analyzing at least one aspect of the imagery at 4616.

In one embodiment, the detecting at least one event by analyzing at least one aspect of the imagery, prior to communication of the imagery from the at least one satellite at 4602 includes the image processor 504 detecting a disaster event by analyzing imagery captured by the first imager 202. The image processor 504 can detect the disaster through object recognition, feature detection, event or activity recognition, change comparison, movement detection, neural network analysis, or by any other artificial intelligence or machine vision operation. The image processor 504 can make the detection prior to any communication of imagery using on-board edge processing at the satellite 500 without requiring any transmission of imagery from the satellite 500. The detection can be in real-time as the imagery is collected by the first imager 202, delayed by a specified period of time, periodic or at an interval, random, based on content within the imagery or other imagery captured by the satellite 500 or 500N, on-demand by a user or program request, or at other times. The image processor 504 can also detect the disaster using stored historical imagery from one or more previous times. For instance, the image processor 504 can obtain ultra-high resolution real-time video imagery associated with an area Southeast of Florida over the ocean. Prior to any communication of the imagery by the satellite 500, the image processor 504 can perform machine vision with respect to the imagery associated with the area Southeast of Florida over the ocean. Through change detection and neural network analysis, image processor 504 can determine that the ocean is obscured by cloud coverage and that the cloud coverage is likely associated with a hurricane formation.

In one embodiment, the detecting at least one event by analyzing at least one of the following aspects of the imagery: pattern, light level, ground contact, object, feature, activity, event, trend, area, terrain, movement, and/or change at 4604 includes the image processor 504N detecting a disaster-related event by analyzing one of the aspects with respect to imagery collected using the outer imager 204. For example, the image processor 504N can detect a tsunami based on a pattern of ocean waves or perturbances, can detect weather based on changes in light level and ground contact indicative of cloud obscuration, can detect a tornado based on vehicles and house objects being rapidly displaced in a radial arrangement, can detect a fire based on a smoke, flame, and heat features, can detect a windstorm based on aggregate movements of boats relative to water, can detect an earthquake based on people moving in-masse out of buildings and into the streets and/or structures breaking or falling, can detect drought based on a color change trend of crops, can detect a flood based on blue or brown colors associated with water being spread over a wide area, or can detect an explosion based on rapid pixel, heat, and obscuration changes, for example.

In one embodiment, detecting at least one event by comparing one or more frames of the imagery at 4606 includes the image processor 504 comparing two frames of imagery captured using the imaging system 100. The frames can be successive frames or frames separated by one or more intermediate frames over time. Additionally, the image processor 504 can sample frames from real-time imagery collected or using historical imagery stored at the satellite 500. Using the frame comparison, the image processor can identify changes or movements that can be directly interpreted as events or that can be used to focus analysis of imagery for detecting events. For instance, image processor 504 can compare every 100^{th} frame to determine a change in water level associated with a river bank, based on pixel coloration changes at an interface between water and dry land. Based on the changes in water level exceeding a specified threshold, the image processor 504 can detect a river flood event that will likely impact a community adjacent to the river.

In one embodiment, detecting at least one event by performing image or feature recognition on at least some of the imagery at 4608 includes hub processor 502 performing recognition on imagery collected using the imaging system 100. The recognition can include direct image-to-image comparisons to determine if image content matches any known objects. Alternatively, the recognition can include feature or feature vector extraction of objects from the imagery and comparison of the feature or feature vector with known features or feature vectors. Additionally, the recognition can include machine vision, artificial intelligence, neural network analysis, or the like where objects, features, or feature vectors are compared with machine-learned objects, features, or feature vectors. In this instance, the recognized objects, features, or feature vectors can be added to the machine-learned objects for future recognition and comparisons. For example, the hub processor 504 can extract feature vectors associated with real-time imagery, including feature vectors of people running, smoke clouds, heat and fire, and shrapnel radiating from a point. The feature vectors can be compared to machine learned feature vectors and the hub processor 504 can detect from the analysis an event of a bomb explosion.

In one embodiment, detecting at least one event by analyzing at least one aspect of the imagery in conjunction with supplemental data at 4610 includes the image processor 504N detecting a disaster event by analyzing imagery collected using the spot imager 104 in association with supplemental data. The supplemental data can include data stored, uplinked, streamed, or otherwise provided to the satellite 500. Alternatively, the supplemental data can be located at a ground-based system, such as in the cloud, and available on request. The image processor 504N can use the content of the imagery along with the supplemental data to refine or assist in the detection of disaster events. For example, the image processor 504N can receive real-time ultra-high resolution imagery from spot imager 104, which imagery is video tracking the flight of an aircraft. The image processor 504N can detect a flight path of the aircraft into terrain along with an explosion. Supplemental data including flight plan data can be accessed by the image processor 504 to identify the flight, such as LithX Airlines Flight 4367 enroute to Kaunas International Airport. The image processor 504 can therefore detect a plane crash of Flight 4367 based on the imagery collected and analyzed from spot imager 104 and based on the flight plan information used to identify the aircraft.

In one embodiment, detecting at least one wildfire by analyzing at least one aspect of the imagery at 4612 includes hub processor 502 detecting the wildfire using imagery collected from a plurality of imagers of the imaging system 100. For example, inner imagers 202, outer imagers 204, and spot imagers 104 can collect real-time video of a forest area in Northern Idaho as satellite 500 moves along its orbital path. Image processors 504 and 504N associated with the respective imagers can detect flames in an irregular line that are moving outwardly from a center area and can detect intense mountain obscuration focused near the flames. Hub processor 502 can collect the analysis outputs from the image processors 504 and 504N and analyze the outputs in their entirety to detect the overall geographic area and the precise boundaries associated with a forest fire event.

In one embodiment, detecting at least one volcanic eruption or earthquake by analyzing at least one aspect of the imagery at 4614 includes the image processor 504 detecting a volcanic eruption or earthquake by analyzing imagery collected using the inner imaging unit 202. For example, the inner imaging unit 202 can collect high resolution real-time video or still images of Mount Rainier in Washington. The image processor 504 can process the real-time feed of the video or still images and extract feature vector information from the imagery associated with intense ground obscuration. The image processor 504 can compare the feature vector information with machine-learned feature vector information indicative of volcanic explosions. Based on a match or similarity between the extracted feature vector information and the known volcanic eruption feature vectors, the image processor 504 can detect a volcanic eruption.

In one embodiment, detecting at least one explosion by analyzing at least one aspect of the imagery at 4616 includes the image processor 504N detecting an explosion by analyzing visible and infrared imagery captured using the outer imager 204. For example, the outer imager 204 can capture visible and infrared imagery associated with a train traveling along a train track. The image processor 504N can analyze the visible and the infrared imagery in real-time or near-real-time to identify an abrupt termination in travel of the train in conjunction with a combination of high temperature and obscuration. Based on the combination of the event of abrupt termination of movement and features of high temperature and obscuration, the image processor 504N can detect an instance of an explosion. The detection can be based on pre-programmed parameters likely associated with an explosion (e.g., heat, obscuration, abrupt changes in movement, radial object movement, red/yellow concentrated pixel coloration, etc.). Alternatively, the detection can be based on machine learning. For instance, the abrupt termination of movement may not have previously been a factor associated with an explosion, but due to this parameter being present in association with heat and obscuration the abrupt termination of movement can be added to the parameters of an explosion to enhance future recognition efforts.

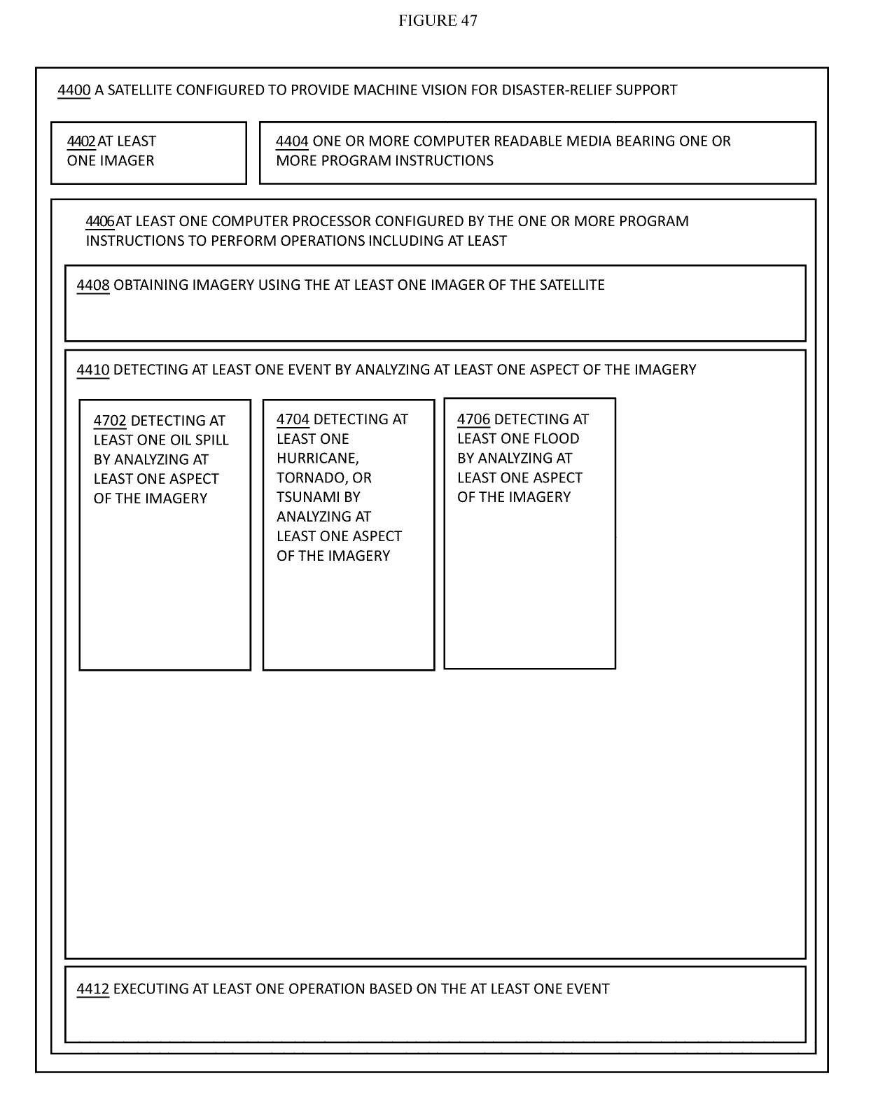

FIG. 47 is a component diagram of a satellite with machine vision for disaster relief support. In one embodiment, a satellite 4400 configured to provide machine vision for disaster-relief support, includes, at least one imager 4402; one or more computer readable media 4404 bearing one or more program instructions; and at least one computer processor 4406 configured by the one or more program instructions to perform operations including at least: detecting at least one oil spill by analyzing at least one aspect of the imagery at 4702; detecting at least one hurricane, tornado, or tsunami by analyzing at least one aspect of the imagery at 4704; detecting at least one flood by analyzing at least one aspect of the imagery at 4706.

In one embodiment, detecting at least one oil spill by analyzing at least one aspect of the imagery at 4702 includes the image processor 504 detecting an oil spill by analyzing imagery collected using the satellite imaging system 100. An oil spill can result from leakage at a pump site, from piping, or during transportation. Detection can be determined through analysis of temperature differences, discoloration and reflectivity, absence or avoidance by animals, or activity or events. For example, in the context of an oceanic oil spill, the image processor 504 can obtain imagery from an inner imager 202. The image processor 504 can detect an irregularity in the coloration of the ocean water and can recognize the irregularity as an oil spill through neural network analysis. Based on the recognition of an oil spill, the image processor 504 can initiate oil spill specific operations to further determine parameters such as the GPS boundaries of the irregularity, a density mapping of the oil within the GPS boundaries, a depth or thickness mapping the oil at various locations, and a trend mapping indicating the direction of movement or change of the oil spill over time. Additionally, the image processor 504 can direct the spot imager to capture and track any shipping vessels in the vicinity of the oil spill with ultra-high resolution imagery. The GPS, boundary, density, depth or thickness, and the trend information can be communicated from the satellite 500 to one or more ground stations for review by environmental groups, government agencies, news organizations, or other consumers without requiring transmission of any imagery. Additionally, the satellite 500 can transmit position and movement information associated with any vessels in the area of the oil spill, such as to Coast Guard navigational equipment for intercepting the vessels. This data can be transmitted in real-time or near-real-time with capture of the imagery to enable rapid response to a potential environmental disaster.

In one embodiment, detecting at least one hurricane, tornado, or tsunami by analyzing at least one aspect of the imagery at 4704 includes a processor on-board the satellite 500 detecting weather or an ocean feature using imagery captured with a fisheye imager 210. The processor can constantly monitor for weather or ocean features or can be initialized to begin monitoring for particular weather or ocean features, such as based on other image features or content, user requests or commands, or based on supplementary data. For instance, the processor can be initialized to begin hurricane specific monitoring based on imagery of cloud formations, temperature gradients observed, and high and low pressure gradient data uploaded to the satellite 500. As another example, the processor can be initialized to begin monitoring for a tsunami based on Richter scale data obtained by the satellite 500 indicating an Earthquake near or within an ocean surface. Various techniques are usable by the processor to detect a hurricane, tornado, or tsunami. Included in these are image recognition, feature vector recognition, neural network analysis, or other artificial intelligence type operation. For example, with respect to a hurricane or tornado, the processor can convert imagery into feature vectors indicative of size, shape, and movement. The feature vector information can be compared to feature vectors of previously detected hurricanes or tornados and upon recognition can initiate further operations. The additional operations can include the processor of the satellite 500 directing a spot imager 104 to align with the particular obscuration to sample higher spatial resolution imagery. Additionally, the processor can determine likely civilization impacts of the hurricane or tornado based on size, path, timing, or other parameters that are modeled. The processor further can initiate alerts via social media or to smartphones that are determined to relate in time or location to the hurricane or tornado. The alerts can include the feature vector information in lieu of imagery to enable a ground-based off-satellite visual recreation of the hurricane or tornado.

In one embodiment, the detecting at least one flood by analyzing at least one aspect of the imagery at 4706 includes the processor 504N detecting a flood by analyzing real-time imagery obtained using a fisheye imager 210. The processor 504N can constantly monitor for flooding or can have one or more flood specific recognition applications or processes initiated upon user command or request, content of other imagery, or supplemental data provided to or obtained by the satellite 500. The processor 504N can detect flooding by coloration, temperature gradients, presence of boats or other floating objects, submersion of vehicles or buildings or other structures, recent high density clouds over an area, previous snow pack analysis, feature vector or image recognition, or based on historical imagery comparisons. For example, the satellite 500 can obtain supplemental data including overnight rainfall amounts for a particular city that exceed a specified threshold. Based on this information, image processor 504N can begin analyzing imagery captured using the fisheye imager 210 for flooding by comparing pixel data for the particular city with historical pixel data. Visual changes in the pixel data, such as brown or blue areas that were previously white or gray surfaces can be flagged for potential flooding. Additional feature vector and neural network analysis performed can recognize boats and submerged cars on a highway or road to confirm the flooding. The image processor 504N can then map out geographic boundaries of the flooding and can determine trend information, such as direction and speed of movement of the flooding, through pixel analysis. Based on the foregoing, the image processor 504N can identify potential evacuation routes around and away from the flooding. The boundary, trend, and evacuation route information can be communicated in real-time or near-real-time to smartphones located within a specified proximity of the flooding, to emergency first responders, to news media outlets, to government agencies, or to navigational equipment, without requiring that any imagery be communicated.

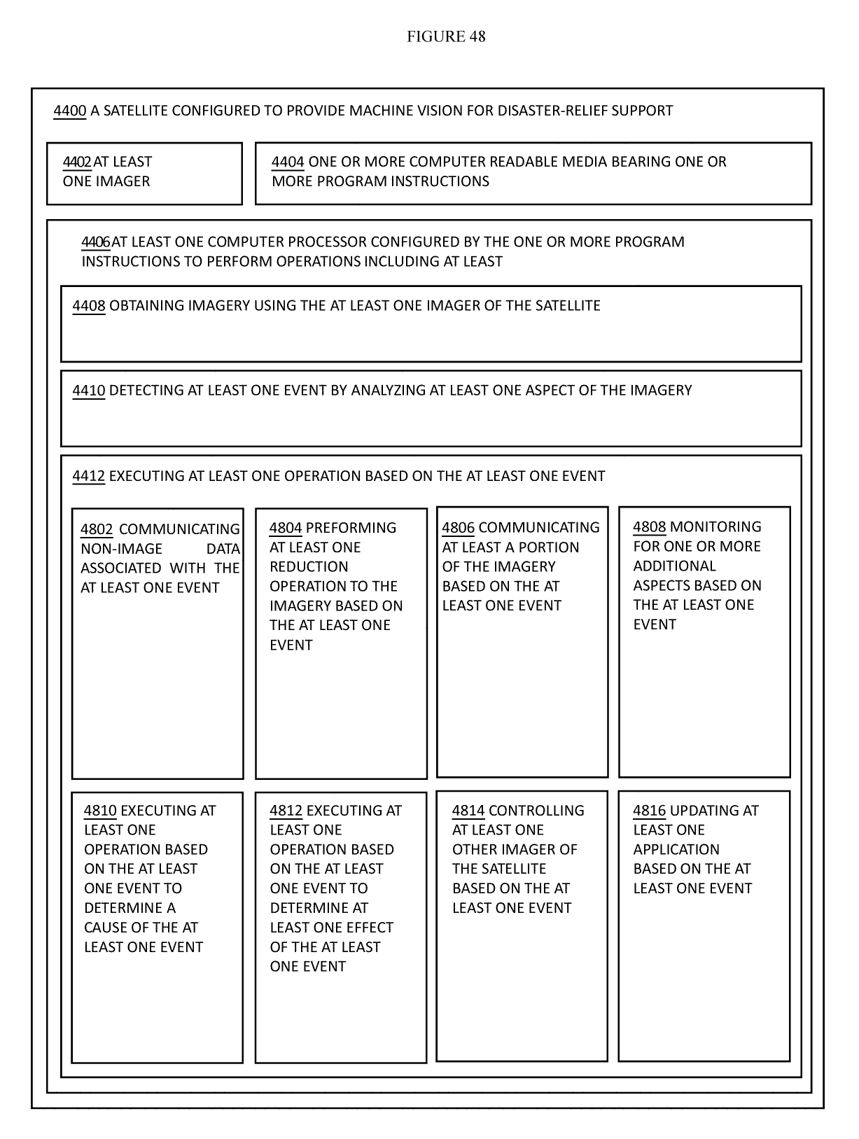

FIG. 48 is a component diagram of a satellite with machine vision for disaster relief support. In one embodiment, a satellite 4400 configured to provide machine vision for disaster-relief support, includes, at least one imager 4402; one or more computer readable media 4404 bearing one or more program instructions; and at least one computer processor 4406 configured by the one or more program instructions to perform operations including at least: communicating non-image data associated with the at least one event at 4802; preforming at least one reduction operation to the imagery based on the at least one event at 4804; communicating at least a portion of the imagery based on the at least one event at 4806; monitoring for one or more additional aspects based on the at least one event at 4808; executing at least one operation based on the at least one event to determine a cause of the at least one event at 4810; executing at least one operation based on the at least one event to determine at least one effect of the at least one event at 4812; controlling at least one other imager of the satellite based on the at least one event at 4814; or updating at least one application based on the at least one event at 4816.

In one embodiment, the communicating non-image data associated with the at least one event at 4802 includes, but is not limited to, the satellite 500 communicating non-image data via the wireless communication interface 506 non-image data to a ground station. The non-image data can include, for instance, a binary indication of detection of an event, a GPS coordinate of an event, an alphanumeric description of the event, a numerical value associated with the event, a feature vector associated with the event, a report or summary analysis associated with the event, a projection regarding the event, a checklist or action item associated with the event, or another non-image parameter associated with the event. For example, in the case of a wildfire disaster event, the image processor 504 can use artificial intelligence or machine vision to detect the wildfire using real-time or near-real-time access to ultra-high resolution imagery obtained using the inner imager 202. Upon detecting the wildfire, the image processor 504 can generate non-image data associated with the wildfire, such as a Boolean TRUE indication for a wildfire presence, GPS coordinates of the boundary of the fire, windspeed in the vicinity of the fire, access roads to and from the fire, an indication of a location of people in the vicinity of the fire and their contact information, a chart of the size and intensity of the fire over time, a predicted path or size of the fire, control operations for one or more manned or unmanned vehicles to surveil or drop fire-retardant on the fire, control operations for one or more navigation units of first responders or firefighters to assist in navigating to the fire, parameters for establishing a temporary flight restriction (TFR) by the FAA, or other related non-image data. The hub processor 502 can then transmit at least some of the image data via the wireless communication interface 506 to a first responder, fire fighter, government agency, affected homes or people, news organizations, supporting or interested companies, or other destinations, requiring only a low communication bandwidth.

In one embodiment, preforming at least one reduction operation to the imagery based on the at least one event at 4804 includes the image processor 504N performing a reduction operation to ultra-high resolution imagery obtained from the outer imager 204. For instance, image processor 504N can perform any one of the following types of operations of real-time or near-real-time imagery obtained from the outer imager 204: pixel decimation, pixel reduction, cropping, pixel selection, area removal, pixel extraction, resolution reduction, compression, background subtraction, previously transmitted pixel removal, unchanged pixel removal, pixel removal to maintain a constant resolution independent of zoom, static object removal, overlapping pixel removal, or other reduction operation. In the case of a hurricane event, image processor 504N can obtain full ultra-high resolution imagery from the outer imager 204 and can detect a hurricane based thereon using machine vision or artificial intelligence. Upon detecting the hurricane, the image processor 504N can perform image reduction on imagery associated with the hurricane to enable transmission using the low bandwidth constraint of the wireless communication interface 506. The image reduction can include removing non-hurricane and non-impact-associated land imagery and reduction of the remaining imagery to at least the screen resolution of the destination device (e.g., IPHONE 7 screen resolution). Additional pixels that have not changed since a previous transmission can be removed from the imagery due to the slow moving nature of the hurricane, wherein the previously transmitted pixel data is gap-filled prior to communication to a destination device. In this manner, imagery of the hurricane can be reduced to that which pertains to the hurricane at high resolutions that approximate the screen resolution of the destination device and without pixel data that has previously been transmitted and is unchanged. Additionally, compression can be applied to the reduced imagery to further reduce the bandwidth load on the wireless communication interface 506.

In one embodiment, the communicating at least a portion of the imagery based on the at least one event at 4806 includes the hub processor 502 communicating imagery via the wireless communication interface 506. The portion of the imagery can be a complete high-resolution image or video obtained using the global imaging array 102 and the steerable spot imagers 104; a select field of view of the high-resolution image or video obtained from one of the inner imagers 202, the outer imagers 204, the fisheye imager 210, or the spot imager 104; a select portion of the imagery or video from any of the inner imagers 202, the outer imagers 204, the fisheye imager 210, or the spot imager 104; historical imagery or video data; reduced imagery or video; augmented imagery or video; or other imagery or video. The imagery or video can be provided a variety of frames per second, such as a still image, approximately 20 frames per second, or approximately dozens, hundreds, or thousands of frames per second. The imagery or video can pertain directly to the event detected or can be tangential to the detected event. For example, the case of a detected flood event, the hub processor 502 can communicate imagery associated with the flood, such as imagery directly related to flood waters detected. However, the hub processor 502 can also be programmed to communicate imagery associated with any vehicle or persons that are moving within the flood waters or that are surrounded by the flood waters, which imagery can be obtained using the steerable spot imagers 104 and can be coupled with GPS coordinate locations of the people or vehicles depicted. This imagery can aid first responders and personnel in locating and assisting persons affected by the flood waters without relying entirely on slow and burdensome house-by-house searches or expensive helicopter searches.

In one embodiment, the monitoring for one or more additional aspects based on the at least one event at 4808 includes the image processor 504 signaling or controlling for monitoring another aspect based on an event detected in imagery obtained using the inner imager 202. The monitoring can include initiating machine vision on one or more other image processors 504N on the satellite 500 or satellite 500N to detect one or more specific features, objects, events, activities, or other occurrence. The monitoring can be real-time, periodic, non-periodic, or on a random basis. Additionally, the monitoring can be tied to a satellite location, satellite position, satellite imager alignment, captured imagery content, or global in nature. For example, in the context of an earthquake detected on-board the satellite 500 using imagery of the imaging system 100, imager processors 500 and 504N on satellites 500 and 500N can be triggered to begin machine vision operations to detect a tsunami. As another example, in the context of a wildfire detected using image processor 504, machine vision operations for tracking people or vehicle movement in and around the wildfire area can be initiated on each of the image processors 504 and 504N. As yet another example, detection of a flooding event by image processor 504 can call on machine vision operations to further monitor for infrared temperature patterns indicative of people within the flood affected area.

In one embodiment, the executing at least one operation based on the at least one event to determine a cause of the at least one event at 4810 includes the hub processor 502 initiating artificial intelligence operations to determine a cause of a natural disaster event detected by an image processor 504 using imagery obtained from the inner imager 202. Determining a cause can include the hub processor 502 analyzing real-time imagery and/or historical imagery of the satellite 500 or satellite 500N to detect one or more potential activities or occurrences within a time frame preceding a detected event. For example, in the case that image processor 504 detects an explosion within a field of view of inner core 406 associated with a freeway, the hub processor 502 can begin analyzing historical imagery stored on-board the satellite 500 in the moments preceding the explosion. The hub processor 502 can use machine vision or artificial intelligence with respect to the historical imagery to recognize a tanker truck traveling toward the point of explosion and identify the tanker truck changing lanes into a passenger vehicle just prior to the explosion. The hub processor 502 can output a cause of the explosion as a textual description of the events (e.g., “Tanker truck changing lanes into a passenger vehicle while traveling at 75 mph in a 60 mph zone”) along with video of the tanker truck at a relatively high resolution.

In one embodiment, the executing at least one operation based on the at least one event to determine at least one effect of the at least one event at 4812 includes the hub processor 502 executing a machine vision or artificial intelligence operation on imagery obtained using the global imaging array 102 or the spot imagers 104 to determine an effect of a detected event. The effect can be a real-time or a delayed result of a particular detected event and can be determined using one or more image processors 504 or 504N or hub processor 502 of satellite 500 or satellite 500N. The effect can be identified or described by a description, binary indication, parameter value, Boolean operator, or using imagery. For example, in the case of drought, the hub processor 502 can determine a drought event based on an absence of cloud obscuration for an extended period of time. Based on the drought event, satellites 500 and 500N can begin to analyze real-time imagery of croplands in the area of the drought to identify effects of the drought event on growth and harvesting. Effects can include discoloration, increased usage and movement of watering equipment, delayed presence of harvesting equipment, or other farming result of the drought event. The satellite 500 can then transmit a description of the effects along with imagery supporting the effects to a government agency, such as the USDA or EPA or local municipality.

In one embodiment, controlling at least one other imager of the satellite based on the at least one event at 4814 includes the hub processor 502 controlling a spot imager 104 based on an event detected by the image processor 504. Controlling can include aligning, focusing, dwelling, or otherwise moving one or more of the spot imagers 104. Controlling can also include directing one or more spot imagers 104 of another satellite 500N or multiple satellites 500N. For example, image processor 504 can detect a train derailment using machine vision techniques with respect to imagery obtained using the inner imager 202. Hub processor 502 can direct a spot imager 104 to the site of the train derailment to dwell on the train derailment as the satellite 500 progresses along its orbital path. Multiple frames of the high resolution imagery obtained using the spot imager 104 can be used by the imager processor 504N to interpolate super-resolution imagery of the train derailment. The hub processor 502 can perform additional machine vision operations on the super-resolution imagery, such as to identify objects or people in and around the train derailment site, track people or vehicles leaving the train derailment site, or identify access roads or pathways to assist first responders in reaching the train derailment site.

In one embodiment, updating at least one application based on the at least one event at 4816 includes the satellite 500 updating a ground-based, cloud-based, or internet-based application, such as a mobile phone application, with information using the wireless communication interface. The satellite 500 can transmit information to a central repository that is readable by one or more applications, transmit information directly to the one or more applications, or respond to requests for information by a central repository or the one or more applications. The information can include binary, Boolean, alphanumeric, parameter, vector, image, or other non-image data. The information can be directly or indirectly related to the event, a cause of the event, an effect or result of the event, or a prediction regarding the event. The at least one application can then further analyze, combine, summarize, present, or otherwise process the data in customized and specific ways. For example, the satellite 500 can update a mobile traffic application by transmitting congestion volumes along various stretches of highways in and around Phoenix, Ariz. This data can be transmitted as binary, parameter, or alphanumeric text without any imagery and the mobile traffic application can process the data to determine traffic travel times along stretches of highways and alternative travel routes. The application can then present this information as a real-time or near-real-time output via the mobile traffic application in a customized proprietary format using graphics and a layout that is uncontemplated by the satellite 500. Third party applications can be developed for various purposes using the data provided by the satellites 500 or 500N, such as consumer, educational, commercial, governmental, non-profit, or gaming type applications.

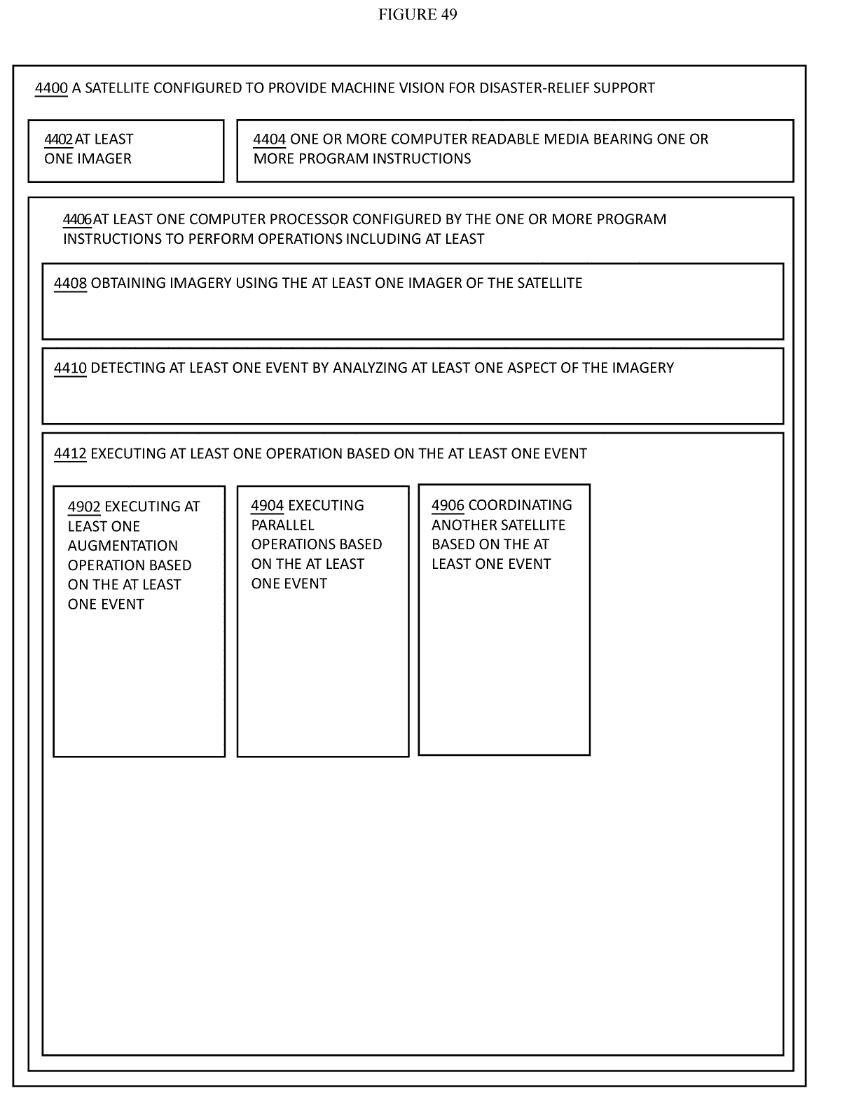

FIG. 49 is a component diagram of a satellite with machine vision for disaster relief support. In one embodiment, a satellite 4400 configured to provide machine vision for disaster-relief support, includes, at least one imager 4402; one or more computer readable media 4404 bearing one or more program instructions; and at least one computer processor 4406 configured by the one or more program instructions to perform operations including at least: executing at least one augmentation operation based on the at least one event at 4902; executing parallel operations based on the at least one event at 4904; and coordinating another satellite based on the at least one event at 4906.

In one embodiment, the executing at least one augmentation operation based on the at least one event at 4902 includes the hub processor 502 augmenting image or non-image data prior to communication via the wireless communication interface 506 or the satellite 500 transmitting image or non-image data via the wireless communication interface 506 for augmentation by an intermediate server prior to a destination. Augmentation can include adding news, historical data, research data, social media posts (e.g., TWITTER posts or FACEBOOK posts), timeline data, prediction data, location data, event or occurrence data, or other image or non-image data. For example, in the context of a riot detected by the image processor 504N, the hub processor 502 can obtain real-time news reporting and social media posts related to or referencing the riot and transmit real-time video of the riot along with the news reporting and social media posts via the wireless communication interface 506. In addition, the hub processor 502 can append data that is determined using machine vision performed on the imagery captured using the inner imagers 202, such as start time of the riot, GPS coordinates of the riot, intensity or number of participants in the riot, and other information for further understanding the scope, location, and duration of the riot.

In one embodiment, the executing parallel operations based on the at least one event includes the image processors 504 and 504N each executing operations in parallel to perform machine vision on imagery obtained via the global imaging array 102 and the steerable spot imagers 104. The parallel operations can include each of the image processors 504 and 504N performing the same machine vision operations for the same purpose on different imagery associated with different fields of view 402, 404, 406, and 408. Alternatively, the parallel operations can include each of the image processors 504 and 504N performing different machine vision operations for different purposes. Additionally, any particular image processor 504 or 504N can perform a plurality of machine vision specific applications in series or interleaved with one another or in parallel. For example, each of the image processors 504 and 504N can perform in parallel machine vision on imagery of their respective fields of view to detect any one of a flood, earthquake, hurricane, typhoon, tornado, tsunami, windstorm, fire, explosion, or other man-made or natural disaster event. Alternatively, image processors 504 and 504N can be programmed to modify their particular machine vision operations based on machine vision detected information, such as detect earthquakes only over land, detect hurricanes only in coastal areas, detect explosions only where people or objects are present, detect a tornado only over midwestern states, detect riots only within city centers, detect crashes only when cars or roads are present. Thus, the information in the field of view can be used to dynamically control the machine vision operations of a particular image processor 504 or 504N.

In one embodiment, the coordinating another satellite based on the at least one event at 4906 includes the hub processor 502 of satellite 500 controlling operations of another satellite 500N via the wireless communication interface 506. Coordinating can include repositioning the satellite 500N or its global imaging array or steerable spot imagers or can include programming or selecting one or more machine vision applications of the satellite 500N. For instance, satellite 500 can detect a large winter storm while passing over the Northeastern United States. The satellite 500 can communicate to the next satellite 500N in the orbital path that is on course to be positioned over the Northeastern United States to initiate machine vision applications to detect stranded vehicles or people after the cloud obscuration has disappeared. The various image processors of satellite 500N can perform machine vision on imagery obtained to detect instances of unmoving, stranded, or trapped vehicles or people along roads or highways after satellite 500 has progressed beyond visual contact with the area.

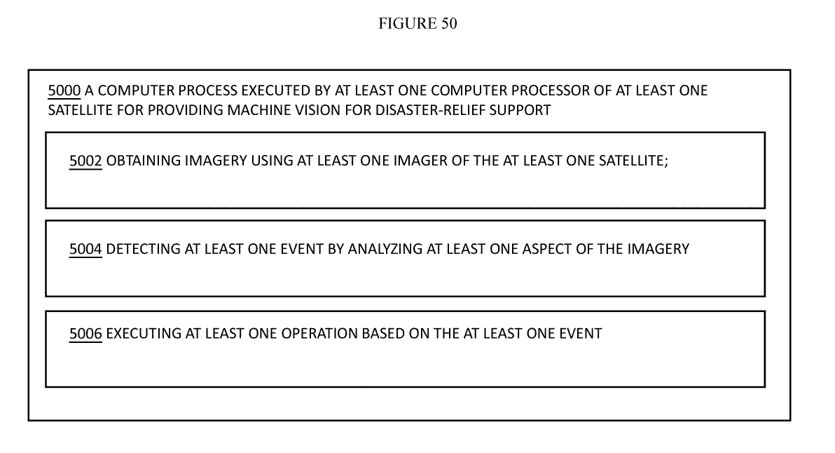

FIG. 50 is a flow diagram of a process executed by a satellite for providing machine vision for disaster relief support, in accordance with an embodiment. In one embodiment, the computer process 5000 executed by at least one computer processor of at least one satellite for providing machine vision for disaster-relief support includes, but is not limited to, obtaining imagery using at least one imager of the at least one satellite at 5002; detecting at least one event by analyzing at least one aspect of the imagery at 5004; and executing at least one operation based on the at least one event at 5006. The computer process 5000 can be executed by any of the image processors 504 and 504N, the hub processor 502, or any other computer processor on-board the satellite 500. Computer process 5000 can include any one or more of the operations or embodiments discussed and illustrated with respect to FIGS. 44-49.

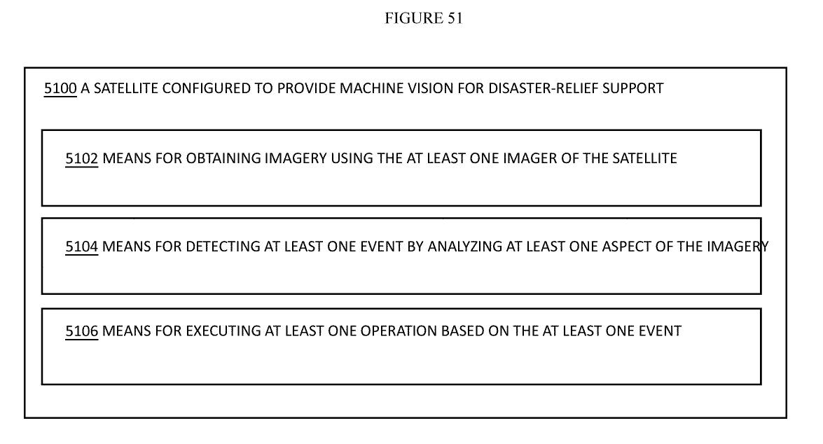

FIG. 51 is a component diagram of a satellite with machine vision for disaster relief support, in accordance with an embodiment. In one embodiment, a satellite 5100 configured to provide machine vision for disaster-relief support includes, but is not limited to, means for obtaining imagery using the at least one imager of the satellite at 5102; means for detecting at least one event by analyzing at least one aspect of the imagery at 5104; and means for executing at least one operation based on the at least one event at 5106. Satellite 5100 can include satellite 500. The means for obtaining imagery using the at least one imager of the satellite at 5102 can include the satellite imaging system 100. The means for detecting at least one event by analyzing at least one aspect of the imagery at 5104 can include the image processor 504, the image processor 504N, the hub processor 502, or any computer processor on-board the satellite 500. The means for executing at least one operation based on the at least one event at 5106 can similarly include the image processor 504, the image processor 504N, the hub processor 502, or any computer processor on-board the satellite 500. Specific structures and algorithms are provided for satellite 5100 throughout the specification and drawings, including, for example, that related to FIGS. 1-5 and FIGS. 44-49.

The present disclosure may have additional embodiments, may be practiced without one or more of the details described for any particular described embodiment, or may have any detail described for one particular embodiment practiced with any other detail described for another embodiment. Furthermore, while certain embodiments have been illustrated and described, as noted above, many changes can be made without departing from the spirit and scope of the disclosure.

Use of the term N in the numbering of elements means an additional one or more instances of the particular element, which one or more instances may be identical in form or can include one or more variations therebetween. Use of “one or more” or “at least one” or “a” is intended to include one or a plurality of the element referenced. Reference to an element in singular form is not intended to always mean only one of the element and does include instances where there are more than one of an element unless context dictates otherwise. Use of the term ‘and’ or ‘or’ is intended to mean ‘and/or’ or vice versa unless context dictates otherwise.

Reference has been made to image processor 504 or 504N or hub processor 502 with respect to various operations and embodiments. Image processor 504 or 504N can be associated with any of the imagers of the global imaging array 102, the spot imagers 104, or another imager on a dedicated or dynamic basis. Furthermore, the image processor 504 or 504N or the hub processor 502 can include any computer microprocessor or array of microprocessors that can be programmed to perform imaging processing, interpretive analysis, machine vision, computer vision, artificial intelligence, or other computer functionality. Furthermore, reference to image processor 504 or 504N or hub processor 502 can be substituted with any other image processor 504 or 504N or hub processor 502, or a computer processor or circuitry arrangement that may or may not be dedicated to image processing. Additional computer microprocessors or circuitry arrangements can be included on the satellites 500 or 500N to provide a bank of dynamically assignable or usable processing resources for use in operations disclosed and illustrated herein.

1-97. (canceled)

98. A computer process executed by at least one computer processor of at least one satellite for providing machine vision for disaster-relief support, the computer process comprising:
obtaining imagery using at least one imager of the at least one satellite;
detecting at least one event by analyzing at least one aspect of the imagery; and
executing at least one operation based on the at least one event.

99-126. (canceled)

127. A satellite configured to provide machine vision for disaster-relief support, the satellite comprising:
at least one imager;
one or more computer readable media bearing one or more program instructions; and
at least one computer processor configured by the one or more program instructions to perform operations including at least:
obtaining imagery using the at least one imager of the satellite;
detecting at least one event by analyzing at least one aspect of the imagery; and
executing at least one operation based on the at least one event.

128. The satellite of claim 127, wherein the obtaining imagery using the at least one imager of the satellite comprises:
obtaining imagery of substantially an entirety of Earth using a plurality of imagers.

129. The satellite of claim 127, wherein the obtaining imagery using the at least one imager of the satellite comprises:
obtaining visible imagery using the at least one imager of the satellite.

130. The satellite of claim 127, wherein the obtaining imagery using the at least one imager of the satellite comprises:
obtaining infrared imagery using the at least one imager of the satellite.

131. The satellite of claim 127, wherein the obtaining imagery using the at least one imager of the satellite comprises:
obtaining ultra-high resolution imagery using the at least one imager of the satellite, the ultra-high resolution imagery exceeding a communication bandwidth capacity of the satellite.

132. The satellite of claim 127, wherein the obtaining imagery using the at least one imager of the satellite comprises:
obtaining imagery using a plurality of different imagers of the satellite.

133. The satellite of claim 127, wherein the obtaining imagery using the at least one imager of the satellite comprises:
obtaining parallel streams of imagery using a plurality of imagers of the satellite.

134. The satellite of claim 127, wherein the detecting at least one event by analyzing at least one aspect of the imagery comprises:
detecting at least one event by analyzing at least one aspect of the imagery, prior to communication of the imagery from the at least one satellite.

135. The satellite of claim 127, wherein the detecting at least one event by analyzing at least one aspect of the imagery comprises:
detecting at least one event by analyzing at least one of the following aspects of the imagery: pattern, light level, ground contact, object, feature, activity, event, trend, area, terrain, movement, and/or change.

136. The satellite of claim 127, wherein the detecting at least one event by analyzing at least one aspect of the imagery comprises:
detecting at least one event by comparing one or more frames of the imagery.

137. The satellite of claim 127, wherein the detecting at least one event by analyzing at least one aspect of the imagery comprises:
detecting at least one event by performing image or feature recognition on at least some of the imagery.

138. The satellite of claim 127, wherein the detecting at least one event by analyzing at least one aspect of the imagery comprises:
detecting at least one event by analyzing at least one aspect of the imagery in conjunction with supplemental data.

139. The satellite of claim 127, wherein the detecting at least one event by analyzing at least one aspect of the imagery comprises:
detecting at least one wildfire by analyzing at least one aspect of the imagery.

140. The satellite of claim 127, wherein the detecting at least one event by analyzing at least one aspect of the imagery comprises:
detecting at least one volcanic eruption or earthquake by analyzing at least one aspect of the imagery.

141. The satellite of claim 127, wherein the detecting at least one event by analyzing at least one aspect of the imagery comprises:
detecting at least one explosion by analyzing at least one aspect of the imagery.

142. The satellite of claim 127, wherein the detecting at least one event by analyzing at least one aspect of the imagery comprises:
detecting at least one oil spill by analyzing at least one aspect of the imagery.

143. The satellite of claim 127, wherein the detecting at least one event by analyzing at least one aspect of the imagery comprises:
detecting at least one hurricane, tornado, or tsunami by analyzing at least one aspect of the imagery.

144. The satellite of claim 127, wherein the detecting at least one event by analyzing at least one aspect of the imagery comprises:
detecting at least one flood by analyzing at least one aspect of the imagery.

145. The satellite of claim 127, wherein the executing at least one operation based on the at least one event comprises:
communicating non-image data associated with the at least one event.

146. The satellite of claim 127, wherein the executing at least one operation based on the at least one event comprises:
preforming at least one reduction operation to the imagery based on the at least one event.

147. The satellite of claim 127, wherein the executing at least one operation based on the at least one event comprises:
communicating at least a portion of the imagery based on the at least one event.

148. The satellite of claim 127, wherein the executing at least one operation based on the at least one event comprises:
monitoring for one or more additional aspects based on the at least one event.

149. The satellite of claim 127, wherein the executing at least one operation based on the at least one event comprises:
executing at least one operation based on the at least one event to determine a cause of the at least one event.

150. The satellite of claim 127, wherein the executing at least one operation based on the at least one event comprises:
executing at least one operation based on the at least one event to determine at least one effect of the at least one event.

151. The satellite of claim 127, wherein the executing at least one operation based on the at least one event comprises:
controlling at least one other imager of the satellite based on the at least one event.

152. The satellite of claim 127, wherein the executing at least one operation based on the at least one event comprises:
updating at least one application based on the at least one event.

153. The satellite of claim 127, wherein the executing at least one operation based on the at least one event comprises:
executing at least one augmentation operation based on the at least one event.

154. The satellite of claim 127, wherein the executing at least one operation based on the at least one event comprises:
executing parallel operations based on the at least one event.

155. The satellite of claim 127, wherein the executing at least one operation based on the at least one event comprises:
coordinating another satellite based on the at least one event.

156. A satellite configured to provide machine vision for disaster-relief support, the satellite comprising:
means for obtaining imagery using the at least one imager of the satellite;
means for detecting at least one event by analyzing at least one aspect of the imagery; and
means for executing at least one operation based on the at least one event.
